(19) United States
(12) Patent Application Publication
(10) Pub. No.: US 2006/0073360 A1
(43) Pub. Date: Apr. 6, 2006

(54) Organic electroluminescent device

(75) Inventors: Toshihiro Ise, Kanagawa (JP); Hisashi Okada, Kanagawa (JP); Takeshi Murakami, Kanagawa (JP); Seiji Ichijima, Kanagawa (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-Ashigara-shi (JP)

(21) Appl. No.: 11/235,372

(22) Filed: Sep. 27, 2005

(30) Foreign Application Priority Data
Sep. 28, 2004 (JP) 2004-282163

(51) Int. Cl. B32B 19/00

(52) U.S. Cl. 428/690

(57) ABSTRACT

Disclosed is an organic electroluminescent device including at least one organic layer containing a luminescent layer between a pair of electrodes, wherein the organic layer contains at least one metal complex having a ligand with five or more coordination atoms.

### CROSS-REFERENCE TO RELATED APPLICATION

This application claims priority under 35 USC 119 from Japanese Patent Application Nos. 2004-282163, the disclosure of which is incorporated by reference herein.

### BACKGROUND OF THE INVENTION

1. Field of the Invention

The present invention relates to a luminescent device and particularly, to an organic electroluminescent device (EL device).

2. Description of the Related Art

Active research is ongoing to develop various display devices, among which organic electroluminescent (EL) devices attract remarkable attention as promising display devices because high luminance emission is obtained from these devices at a low voltage. Durability is among the important characteristics of organic EL devices, and trials are being made to improve the durability of these organic EL devices. As measures to improve the durability, luminescent devices using CuPc (copper phthalocyanine) in a hole injecting layer are known (see, for example, Japanese Patent Application Laid-Open (JP-A) No. 57-51781 and “Applied Physics Letters”, 15, 69, (1996)). All patents, patent publications and non-patent literature recited in the specification are expressly incorporated by reference herein. These devices, however, have low quantum efficiencies and therefore are in need of further improvement.

In the meantime, various studies have been made to improve external quantum efficiency in the recent development of organic EL devices. Particularly, devices containing phosphorescent materials including a tris(phenylpyridine) iridium complex (see, for example, WO 00/070655) or a platinum complex such as an octaethylporphyrin platinum complex (see, for example, U.S. Pat. No. 6,303,238 B1 and U.S. Pat. No. 6,653,564 B1) attain high efficiency and therefore attract remarkable attention. The disclosures of these documents are incorporated by reference herein.

However, these devices having phosphorescent materials are unsatisfactory in durability and therefore are in need of further improvement. Also, conventional platinum complexes have the problem that the luminescent color of these platinum complexes is limited to a range from orange to red and emission of short-wavelength light of a range from blue to green which is required in applications such as a full-color or multicolor display cannot be obtained.

Phosphorescent materials including a metal complex having a tridentate ligand are reported (see, WO 04/039781, WO 04/039914, “Journal of the American Chemical Society, 126, 4958-4971 (2004)”, and “Journal of the Chemical Society, Dalton Transactions, 2002, 3234-3240”). However, these materials are unsatisfactory in durability. The disclosures of these documents are incorporated by reference herein.

Recently, a phosphorescent material including an iridium complex having a hexadentate ligand, and a host material including an aluminum complex having a hexadentate ligand was disclosed (see, WO 04/081017). The disclosure of this document is incorporated by reference herein. However, the devices using these materials are still unsatisfactory in durability.

### SUMMARY OF THE INVENTION

The above objects can be attained by the following measures.

<1> An organic electroluminescent device comprising a pair of electrodes and at least one organic layer including a luminescent layer, between the pair of electrodes, wherein at least one metal complex having a ligand with five or more coordination atoms is contained in the organic layer.

<2> The organic electroluminescent device according to the above <1>, wherein the metal complex contains a metal ion selected from the group consisting of a platinum ion, a gold ion, an iridium ion, a rhenium ion, a palladium ion, a rhodium ion, a ruthenium ion, a tungsten ion or a copper ion.

<3> The organic electroluminescent device according to the above <1>, wherein said metal complex contains a metal ion selected from the group consisting of an aluminum ion and a gallium ion.

<4> The organic electroluminescent device according to the above <1>or <2>, wherein the metal complex is a metal complex emits phosphorescent light and is contained in the luminescent layer.

<5> The organic electroluminescent device according to the above <1>, wherein the metal complex is a compound represented by the following formula (1): 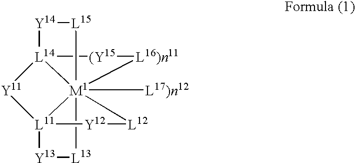
wherein M¹ represents a metal ion; L¹¹, L¹², L¹³, L¹⁴, L¹⁵, L¹⁶ and L¹⁷ each independently represent a coordination group coordinated to M¹; Y¹¹, Y¹², Y¹³, Y¹⁴ and Y¹⁵ each independently represent a single bond or a connecting group; n¹¹ denotes 0 or 1; and n¹² denotes an integer from 0 to 4.

<6> The organic electroluminescent device according to the above <1> to <4>, wherein the metal complex is a compound represented by the following formula (3): 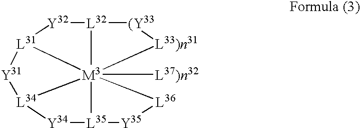
wherein represents a metal ion; L³¹, L³², L³³, L³⁴, L³⁵, L³⁶ and L³⁷ each independently represent a coordination group coordinated to M³; Y³¹, Y³², Y³³, Y³⁴ and Y³⁵ each independently represent a single bond or a connecting group; n³¹ denotes 0 or 1; and n³² denotes an integer from 0 to 4.

<7> The organic electroluminescent device according to the above <1> to <4>, wherein said metal complex is a compound represented by the following formula (4):

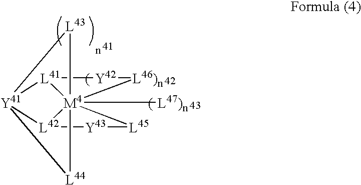

wherein M⁴ represents a metal ion; L⁴¹, L⁴², L⁴³, L⁴⁴, L⁴⁵, L⁴⁶ and L⁴⁷ each independently represent a coordination group coordinated to M⁴; Y⁴¹, Y⁴², Y⁴³ and Y⁴⁴ each independently represent a single bond or a connecting group; n⁴¹ and n⁴² denote 0 or 1, and at least one of n⁴¹ and n⁴² denotes 1; and n⁴³ denotes an integer from 0 to 4.

<8> The organic electroluminescent device according to the above <1> to <4>, wherein said metal complex is a compound represented by the following formula (5): 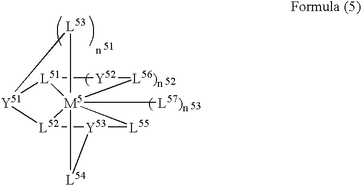
wherein M represents a metal ion; L⁵¹, L⁵², L⁵³, L⁵⁴, L⁵⁵, L⁵⁶ and L⁵⁷ each independently represent a coordination group coordinated to M⁵; Y⁵¹, Y⁵² and Y⁵³ each independently represent a single bond or a connecting group; n⁵¹ and n⁵² denote 0 or 1, and at least one of n⁵¹ and n⁵² denotes 1; and n⁵³ denotes an integer from 0 to 4.

<9> The organic electroluminescent device according to the above <1> to <4>, wherein said metal complex is a compound represented by the following formula (6): 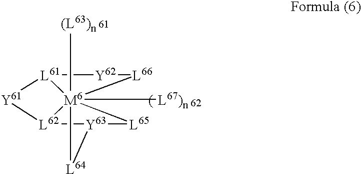
wherein M⁶ represents a metal ion; L⁶¹, L⁶², L⁶³, L⁶⁴, L⁶⁵, L⁶⁶ and L⁶⁷ each independently represent a coordination group coordinated to M⁶; Y⁶¹, Y⁶² and Y⁶³ each independently represent a single bond or a connecting group; n⁶¹ denotes 0 or 1; and n⁶² denotes an integer from 0 to 4.

<10> The organic electroluminescent device according to the above <I> to <4>, wherein said metal complex is a compound represented by the following formula (7): 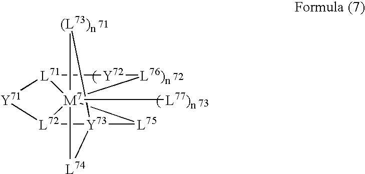
wherein M⁷ represents a metal ion; L⁷¹, L⁷², L⁷³, L⁷⁴, L⁷⁵, L⁷⁶ and L⁷⁷ each independently represent a coordination group coordinated to M⁷; Y⁷¹, Y⁷² and Y⁷³ each independently represent a single bond or a connecting group; n⁷¹ and n⁷² denote 0 or 1, and at least one of n⁷¹ and n⁷² denotes 1; and n⁷³ denotes an integer from 0 to 4.

<11> The organic electroluminescent device according to the above <1> to <4>, wherein the metal complex is a compound represented by the following formula (2): 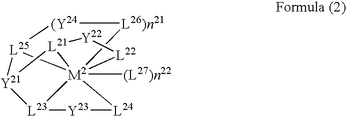
wherein M² represents a metal ion; L²¹, L²², L²³, L²⁴, L²⁵, L²⁶ and L²⁷ each independently represent a coordination group coordinated to M²; Y²¹, Y²², Y²³ and Y²⁴ each independently represent a single bond or a connecting group; n²¹ denotes 0 or 1; and n²² denotes an integer from 0 to 4.

<12> The organic electroluminescent device according to the above <11>, wherein, in formula (2), n²¹ denotes 1, and n²² denotes an integer from 1 to 4.

<13> The organic electroluminescent device according to the above <11>, wherein, in formula (2), at least one of Y²² and Y²³ represent a connecting group other than a single bond.

<14> The organic electroluminescent device according to the above <11>, wherein the compound represented by the formula (2) is selected from the group consisting of the groups represented by the formulae (2-1) to (2-13): 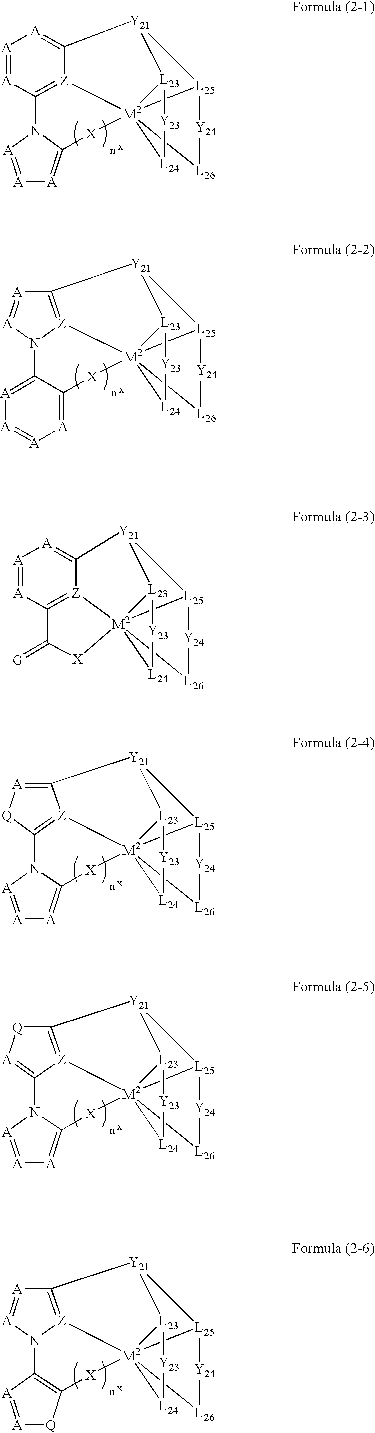 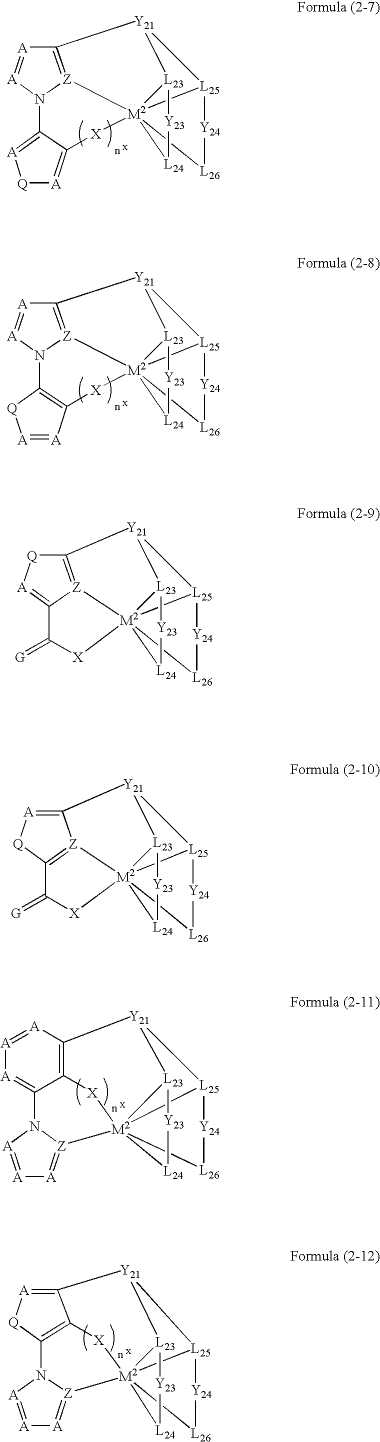 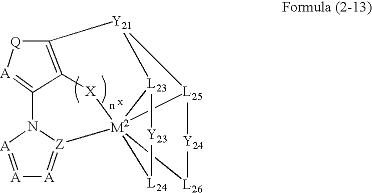
wherein M² represents a metal ion; L₂₃, L₂₄, L₂₅ and L₂₆ each independently represent a coordination group coordinated to M²; Y₂₁, Y₂₃ and Y₂₄ each independently represent a single bond or a connecting group; A represents CR^{A}, N or P; R^{A} represents hydrogen, alkyl group, alkenyl group or alkynyl group; Z represents N or P; X represents O, S or NR^{N1}; R^{N1} represents hydrogen or alkyl group; n^{x} denotes 0 or 1; Q represents O, S, Se, NR^{N2}, CR^{C1} or CR^{C2}; R^{N2} represents hydrogen, alkyl group, aryl group or hetero ring group; and G represents O or S.

<15> The organic electroluminescent device according to the above <1> to <14>, wherein said one organic layer has a hole injecting layer and/or a hole transport layer, and said metal complex is contained in a hole injecting layer and/or a hole transport layer.

<16> The organic electroluminescent device according to the above <1> to <14>, wherein said one organic layer has an electron injecting layer and/or an electron transport layer, and said metal complex is contained in an electron injecting layer and/or an electron transport layer.

<17> The organic electroluminescent device according to the above <1> to <14>, wherein the luminescent layer contains a host material and this host material is a complex.

<18> The organic electroluminescent device according to the above <17>, wherein the host material a platinum complex having a tetradentate ligand.

<19> The organic electroluminescent device according to the above <1> to <14>, wherein the luminescent layer contains two or more host materials.

<20> The organic electroluminescent device according to the above <1> to <14>, wherein the luminescent layer contains at least one metal complex and other luminescent compound.

<21> The organic electroluminescent device according to the above <1> to <14>, wherein the luminescent layer contains two or more of the metal complexes.

<22> The organic electroluminescent device according to the above <1> to <21>, wherein the metal complex has a lowest excited triplet energy level of 65 to 95 kcal/mol.

<23> The organic electroluminescent device according to the above <1> to <22>, wherein the device has a luminescent spectrum with a maximum wavelength of 450 nm or shorter.

### DETAILED DESCRIPTION OF THE INVENTION

The invention can provide a luminescent device, which can emit light highly efficiently and has high durability.

The organic electroluminescent device of the invention comprises at least one organic layer containing a luminescent layer between a pair of electrodes, wherein the organic layer contains at least one metal complex having a ligand with five or more coordination atoms.

The inclusion of the metal complex polydentated with five or more coordination atoms in the organic layer disposed between the pair of electrodes produces the effect of improving stability against charges and improving driving durability more significantly than in the case of conventional compounds. Also, the metal complex improves the quantum efficiency of luminescence and also stability in an excited state. When it is used as a luminescent material, it can produce the effect of improving luminous efficiency and durability.

The metal complex having a ligand with five or more coordination atoms in the invention (hereinafter, referred to as “the metal complex of the invention”) will be explained in detail as to its structure and the like.

The metal ion of the metal complex of the invention is preferably a monovalent to tetravalent metal ion, more preferably a monovalent to trivalent metal ion, and still more preferably a divalent or trivalent metal ion, though it is not limited to these metal ions.

Specific examples of the metal ions include an aluminum ion, cobalt ion, nickel ion, copper ion, gallium ion, ruthenium ion, rhodium ion, palladium ion, silver ion, cerium ion, europium ion, tungsten ion, rhenium ion, osmium ion, iridium ion, platinum ion, gold ion, lead ion and zinc ion.

When the complex of the invention is used as a material for a charge injection layer (hole injection layer and electron injection layer), a material for electron blocking layer (hole blocking layer and electron blocking layer), a material for exciton blocking layer and a host material for a luminescent layer, the metal ion is preferably an aluminum ion, cobalt ion, nickel ion, copper ion, gallium ion, ruthenium ion, rhodium ion, palladium ion, iridium ion, platinum ion, gold ion and lead ion, more preferably an aluminum ion, gallium ion, rhodium ion, palladium ion, iridium ion, platinum ion and gold ion and still more preferably an iridium ion, aluminum ion and gallium ion.

In the case of using the complex of the invention as a luminescent material, the metal ion is preferably a platinum ion, gold ion, iridium ion, rhenium ion, palladium ion, rhodium ion, ruthenium ion, tungsten ion and copper ion, more preferably a platinum ion, iridium ion and rhenium ion, still more preferably a platinum ion and iridium ion and particularly preferably an iridium ion.

Although no particular limitation is imposed on the atom at the part where the atom is coordinated to the above metal ion, the atom is preferably an oxygen atom, nitrogen atom, carbon atom, sulfur atom, phosphorous atom or halogen atom, more preferably an oxygen atom, nitrogen atom, carbon atom, sulfur atom, phosphorous atom or chlorine atom, still more preferably an oxygen atom, nitrogen atom, carbon atom or phosphorous atom and particularly preferably an oxygen atom, nitrogen atom or carbon atom.

Examples of the structure of the coordination group of the above ligand include, though not limited to, aromatic hydrocarbon cyclic ligands (those having preferably 6 to 30 carbon atoms, more preferably 6 to 20 carbon atoms and still more preferably 6 to 16 carbon atoms, for example, a benzene ligand, naphthalene ligand, anthracene ligand and phenanthracene ligand), heterocyclic ligands (those having preferably 1 to 20 carbon atoms, more preferably 1 to 16 carbon atoms and still more preferably 1 to 12 carbons and particularly preferably aromatic heterocyclic ligands. Preferable and specific examples of the heterocyclic ligand include a furan ligand, thiophene ligand, pyridine ligand, pyrazine ligand, pyrimidine ligand, thiazole ligand, oxazole ligand, pyrrole ligand, imidazole ligand, pyrazole ligand, triazole ligand, oxadiazole ligand, thiadiazole ligand, and condensed cyclic bodies containing these ligands (e.g., an indole ligand, quinoline ligand, isoquinoline ligand, quinoxaline ligand, purine ligand, carbazole ligand, phenanthroline ligand, benzothiazole ligand and benzimidazole ligand) and tautomers of these ligands). These heterocyclic ligands may be coordinated with the metal ion by any of a heteroatom or carbon atom in the hetero-ring), alkoxy ligands (those having preferably 1 to 30 carbon atoms, more preferably 1 to 20 carbon atoms and particularly preferably 1 to 10 carbons, for example, methoxy, ethoxy, butoxy and 2-ethylhexyloxy), aryloxy ligands (those having preferably 6 to 30 carbon atoms, more preferably 6 to 20 carbon atoms and particularly preferably 6 to 12 carbons, for example, phenyloxy, 1-naphthyloxy and 2-naphthyloxy), heterocyclic oxy ligands (those having preferably 1 to 30 carbon atoms, more preferably 1 to 20 carbon atoms and particularly preferably 1 to 12 carbons, for example, pyridyloxy, pyrazyloxy, pyrimidyloxy and quinolyloxy), silyloxy ligands (those having preferably 3 to 40 carbon atoms, more preferably 3 to 30 carbon atoms and particularly preferably 3 to 24 carbons, for example, trimethylsilyloxy and triphenylsilyloxy), carboxylate ligands (those having preferably 1 to 30 carbon atoms, more preferably 1 to 20 carbon atoms and particularly preferably 1 to 12 carbons, for example, carboxylate, methyl carboxylate, phenyl carboxylate, naphthyl carboxylate, pyridine carboxylate and quinoline carboxylate), ether ligands (those having preferably 2 to 30 carbon atoms, more preferably 2 to 20 carbon atoms and particularly preferably 2 to 12 carbons, for example, dialkyl ether ligands (e.g., dimethyl ether and diethyl ether), diaryl ether ligands (e.g., diphenyl ether) and furyl ligands), amino ligands (alkylamino ligands (those having preferably 1 to 30 carbon atoms, more preferably 1 to 20 carbon atoms and particularly preferably 1 to 10 carbons, for example, methylamino, dimethylamino and diethylamino), arylamino ligands (those having preferably 6 to 30 carbon atoms, more preferably 6 to 20 carbon atoms and particularly preferably 6 to 10 carbons, for example, phenylamino), heterocyclic amino ligands (those having preferably 1 to 30 carbon atoms, more preferably 1 to 20 carbon atoms and particularly preferably 1 to 12 carbons, for example, pyridylamino, pyrazylamino, pyrimidylamino, quinolylamino, isoquinolylamino, quinoxalylamino, carbazolylamino, thienylamino, furylamino, thiazolylamino, oxazolylamino, pyrazolylamino and triazolylamino), acylamino ligands (those having preferably 2 to 30 carbon atoms, more preferably 2 to 20 carbon atoms and particularly preferably 2 to 10 carbons, for example, acetylamino and benzoylamino), alkoxycarbonylamino ligands (those having preferably 2 to 30 carbon atoms, more preferably 2 to 20 carbon atoms and particularly preferably 2 to 12 carbons, for example, methoxycarbonylamino), aryloxycarbonylamino ligands (those having preferably 7 to 30 carbon atoms, more preferably 7 to 20 carbon atoms and particularly preferably 7 to 12 carbons, for example, phenyloxycarbonylamino), sulfonylamino ligands (those having preferably 1 to 30 carbon atoms, more preferably 1 to 20 carbon atoms and particularly preferably 1 to 12 carbons, for example, methanesulfonylamino, trifluoromethanesulfonylamino, benzenesulfonylamino and pentafluorobenzenesulfonylamino)), carbonyl ligands (e.g., ketone ligands, ester ligands and amide ligands), alkylthio ligands (those having preferably 1 to 30 carbon atoms, more preferably 1 to 20 carbon atoms and particularly preferably 1 to 12 carbons, for example, methylthio and ethylthio), arylthio ligands (those having preferably 6 to 30 carbon atoms, more preferably 6 to 20 carbon atoms and particularly preferably 6 to 12 carbons, for example, phenylthio), heterocyclic thio ligands (those having preferably 1 to 30 carbon atoms, more preferably 1 to 20 carbon atoms and particularly preferably 1 to 12 carbons, for example, 2-pyridylthio, 2-benzimizolylthio, 2-benzoxazolylthio and 2-benzthiazolylthio), thiocarbonyl ligands (thioketone ligands and thioester ligands are exemplified), thioether ligands (dialkylthioether ligands, diarylthioeher ligands and thiofuryl ligands are exemplified) and groups comprising combinations of the above ligands.

The coordination groups are preferably aromatic hydrocarbon cyclic ligands, aromatic heterocyclic ligands (e.g., furan ligands, thiophene ligands, pyridine ligands, pyrazine ligands, pyrimidine ligands, pyridazine ligands, triazine ligands, thiazole ligands, oxazole ligands, pyrrole ligands, imidazole ligands, pyrazole ligands, triazole ligands, oxadiazole ligands, thiadiazole ligands, and condensed cyclic ligands containing these ligands (e.g., quinoline ligands, isoquinoline ligands, phenantlioline ligands, benzoxazole ligands and benzimidazole ligands), and tautomers of these ligands), alkyloxy ligands, aryloxy ligands, ether ligands, alkylthio ligauds, arylthio ligands, alkylamino ligands, arylamino ligands, acylamino ligands, carboxylate ligands, and combinations of these ligands, more preferably aromatic hydrocarbon ligands, pyridine ligands, pyrazine ligands, pyrimidine ligands, pyridazine ligands, thiophene ligands, thiazole ligands, oxazole ligands, pyrrole ligands, imidazole ligands, pyrazole ligands, triazole ligands, quinoline ligands, isoquinoline ligands, benzimidazole ligands, alkyloxy ligands, aryloxy ligands, ether ligands, alkylthio ligands, arylthio ligands, alkylamino ligands, arylamino ligands, acylamino ligands, carboxylate ligands, and combinations of these ligands and still more preferably aromatic hydrocarbon ligands, pyridine ligands, pyrazine ligands, pyrimidine ligands, pyridazine ligands, thiazole ligands, oxazole ligands, pyrrole ligands, imidazole ligands, pyrazole ligands, triazole ligands, quinoline ligands, isoquinoline ligands, benzimidazole ligands, alkyloxy ligands, aryloxy ligands, alkylamino ligands, arylamino ligands, acylamino ligands, carboxylate ligands, and combinations of these ligands.

The above ligands may respectively have a substituent if possible. Examples of the substituent include a substituent group-A listed below.

<Substituent Group-A>

Alkyl groups (those having preferably 1 to 30 carbon atoms, more preferably 1 to 20 carbon atoms and particularly preferably 1 to 10 carbon atoms, for example, methyl, ethyl, isopropyl, tert-butyl, n-octyl, n-decyl, n-hexadecyl, cyclopropyl, cyclopentyl and cyclohexyl), alkenyl groups (those having preferably 2 to 30 carbon atoms, more preferably 2 to 20 carbon atoms and particularly preferably 2 to 10 carbon atoms, for example, vinyl, allyl, 2-butenyl and 3-pentenyl), alkynyl groups (those having preferably 2 to 30 carbon atoms, more preferably 2 to 20 carbon atoms and particularly preferably 2 to 10 carbon atoms, for example, propalgyl and 3-pentynyl), aryl groups (those having preferably 6 to 30 carbon atoms, more preferably 6 to 20 carbon atoms and particularly preferably 6 to 12 carbon atoms, for example, phenyl, p-methylphenyl, naphthyl and anthranyl), amino groups (those having preferably 0 to 30 carbon atoms, more preferably 0 to 20 carbon atoms and particularly preferably 0 to 10 carbon atoms, for example, amino, methylamino, dimethylamino, diethylamino, dibenzylamino, diphenylamino and ditolylamino), alkoxy groups (those having preferably 1 to 30 carbon atoms, more preferably 1 to 20 carbon atoms and particularly preferably 1 to 10 carbon atoms, for example, methoxy, ethoxy, butoxy and 2-ethylhexyloxy), aryloxy groups (those having preferably 6 to 30 carbon atoms, more preferably 6 to 20 carbon atoms and particularly preferably 6 to 12 carbon atoms, for example, phenyloxy, 1-naphthyloxy and 2-naphthyloxy), heterocyclic oxy groups (those having preferably 1 to 30 carbon atoms, more preferably 1 to 20 carbon atoms and particularly preferably 1 to 12 carbon atoms, for example, pyridyloxy, pyrazyloxy, pyrimidyloxy and quinolyloxy), acyl groups (those having preferably 1 to 30 carbon atoms, more preferably 1 to 20 carbon atoms and particularly preferably 1 to 12 carbon atoms, for example, acetyl, benzoyl, formyl and pivaloyl), alkoxycarbonyl groups (those having preferably 2 to 30 carbon atoms, more preferably 2 to 20 carbon atoms and particularly preferably 2 to 12 carbon atoms, for example, methoxycarbonyl and ethoxycarbonyl), aryloxycarbonyl groups (those having preferably 7 to 30 carbon atoms, more preferably 7 to 20 carbon atoms and particularly preferably 7 to 12 carbon atoms, for example, phenyloxycarbonyl), acyloxy groups (those having preferably 2 to 30 carbon atoms, more preferably 2 to 20 carbon atoms and particularly preferably 2 to 10 carbon atoms, for example, acetoxy and benzoyloxy), acylamino groups (those having preferably 2 to 30 carbon atoms, more preferably 2 to 20 carbon atoms and particularly preferably 2 to 10 carbon atoms, for example, acetylamino and benzoylamino), alkoxycarbonylamino groups (those having preferably 2 to 30 carbon atoms, more preferably 2 to 20 carbon atoms and particularly preferably 2 to 12 carbon atoms, for example, methoxycarbonylamino), aryloxycarbonylamino groups (those having preferably 7 to 30 carbon atoms, more preferably 7 to 20 carbon atoms and particularly preferably 7 to 12 carbon atoms, for example, phenyloxycarbonylamino), sulfonylamino groups (those having preferably 1 to 30 carbon atoms, more preferably 1 to 20 carbon atoms and particularly preferably 1 to 12 carbon atoms, for example, methansulfonylamino and benzenesulfonylamino), sulfamoyl groups (those having preferably 0 to 30 carbon atoms, more preferably 0 to 20 carbon atoms and particularly preferably 0 to 12 carbon atoms, for example, sulfamoyl, methylsulfamoyl, dimethylsulfamoyl and phenylsulfamoyl), carbamoyl groups (those having preferably 1 to 30 carbon atoms, more preferably 1 to 20 carbon atoms and particularly preferably 1 to 12 carbon atoms, for example, carbamoyl, methylcarbamoyl, diethylcarbamoyl and phenylcarbamoyl), alkylthio groups (those having preferably 1 to 30 carbon atoms, more preferably 1 to 20 carbon atoms and particularly preferably 1 to 12 carbon atoms, for example, methylthio and ethylthio), arylthio groups (those having preferably 6 to 30 carbon atoms, more preferably 6 to 20 carbon atoms and particularly preferably 6 to 12 carbon atoms, for example, phenylthio), heterocyclic thio groups (those having preferably 1 to 30 carbon atoms, more preferably 1 to 20 carbon atoms and particularly preferably 1 to 12 carbon atoms, for example, pyridylthio, 2-benzimizolylthio, 2-benzoxazolylthio and 2-benzthiazolylthio), sulfonyl groups (those having preferably 1 to 30 carbon atoms, more preferably 1 to 20 carbon atoms and particularly preferably 1 to 12 carbon atoms, for example, mesyl and tosyl), sulfinyl groups (those having preferably 1 to 30 carbon atoms, more preferably to 20 carbon atoms and particularly preferably 1 to 12 carbon atoms, for example, methanesulfinyl and benzenesulfinyl), ureide groups (those having preferably 1 to 30 carbon atoms, more preferably 1 to 20 carbon atoms and particularly preferably 1 to 12 carbon atoms, for example, ureide, methylureide and phenylureide), phosphoric acid amide groups (those having preferably 1 to 30 carbon atoms, more preferably 1 to 20 carbon atoms and particularly preferably 1 to 12 carbon atoms, for example, diethylphosphoric acid amide and phenylphosphoric acid amide), hydroxy groups, mercapto groups, halogen atoms (e.g., a fluorine atom, chlorine atom, bromine atom and iodine atom), cyano groups, sulfo groups, carboxyl groups, nitro groups, hydroxam acid groups, sulfino groups, hydrazino groups, imino groups, heterocyclic groups (those having preferably 1 to 30 carbon atoms and more preferably 1 to 12 carbon atoms, examples of the heteroatom include a nitrogen atom, oxygen atom, sulfur atom, and specific examples of the heterocyclic groups include imidazolyl, pyridyl, quinolyl, furyl, thienyl, piperidyl, morpholino, benzoxazolyl, benzimidazolyl, benzthiazolyl, carbazolyl groups and azepinyl groups), silyl groups (those having preferably 3 to 40 carbon atoms, more preferably 3 to 30 carbon atoms and particularly preferably 3 to 24 carbon atoms, for example, trimethylsilyl and triphenylsilyl) and silyloxy groups (those having preferably 3 to 40 carbon atoms, more preferably 3 to 30 carbon atoms and particularly preferably 3 to 24 carbon atoms, for example, trimethylsilyloxy and triphenylsilyloxy). These substituents may be further substituted. Also, these substituents may be combined with each other to form a ring.

The complex of the invention is a compound represented by the formula (1), (2), (3), (4), (5), (6) or (7).

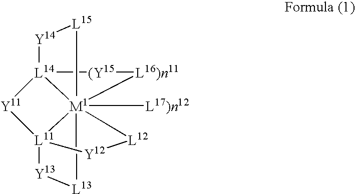

In the formula (1), M¹ represents a metal ion; L¹¹, L¹², L¹³, L¹⁴, L¹⁵, L¹⁶ and L¹⁷ each independently represent a coordination group coordinated to M¹; Y¹¹, Y¹², Y¹³, Y¹⁴ and Y¹⁵ each independently represent a single bond or a connecting group; n¹¹ denotes 0 or 1; and n¹² denotes an integer from 0 to 4.

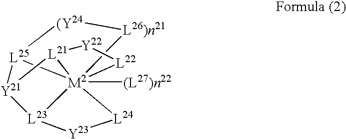

In the formula (2), M² represents a metal ion; L²¹, L²², L²³, L²⁴, L²⁵, L²⁶ and L²⁷ each independently represent a coordination group coordinated to M²; Y², Y²², Y²³ and Y²⁴ each independently represent a single bond or a connecting group; n²¹ denotes 0 or 1; and n²² denotes an integer from 0 to 4.

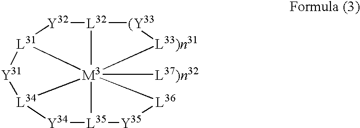

In the formula (3), M³ represents a metal ion; L³¹, L³², L³³, L³⁴, L³⁵, L³⁶ and L³⁷ each independently represent a coordination group coordinated to M³; Y³¹, Y³², Y³³, Y³⁴ and Y³⁵ each independently represent a single bond or a connecting group; n³¹ denotes 0 or 1; and n³² denotes an integer from 0 to 4.

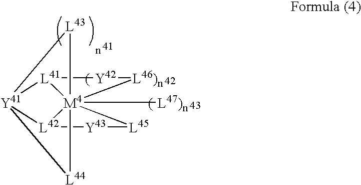

In the formula (4), M⁴ represents a metal ion; L⁴¹, L⁴², L⁴³, L⁴⁴, L⁴⁵, L⁴⁶ and L⁴⁷ each independently represent a coordination group coordinated to M⁴; Y⁴¹, Y⁴², Y⁴³ and Y⁴⁴ each independently represent a single bond or a connecting group; n⁴¹ and n⁴² denote 0 or 1, and at least one of n⁴¹ and n⁴² denotes 1; and n⁴³ denotes an integer from 0 to 4.

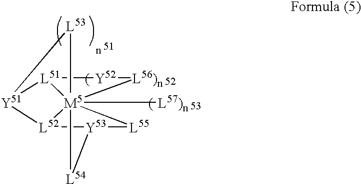

In the formula (5), M⁵ represents a metal ion; L⁵¹, L⁵², L⁵³, L⁵⁴, L⁵⁵, L⁵⁶ and L⁵⁷ each independently represent a coordination group coordinated to M⁵; Y⁵¹, Y⁵² and Y⁵³ each independently represent a single bond or a connecting group; n⁵¹ and n⁵² denote 0 or 1, and at least one of n⁵¹ and n⁵² denotes 1; and n⁵³ denotes an integer from 0 to 4.

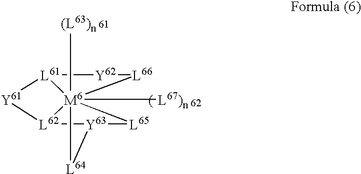

In the formula (6), M⁶ represents a metal ion; L⁶¹, L⁶², L⁶³, L⁶⁴, L⁶⁵, L⁶⁶ and L⁶⁷ each independently represent a coordination group coordinated to M⁶; Y⁶¹, Y⁶² and Y⁶³ each independently represent a single bond or a connecting group; n⁶¹ denotes 0 or 1; and n⁶² denotes an integer from 0 to 4.

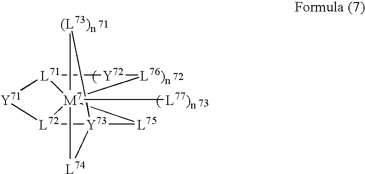

In the formula (7), M⁷ represents a metal ion; L⁷¹, L⁷², L⁷³, L⁷⁴, L⁷⁵, L⁷⁶ and L⁷⁷ each independently represents a coordination group coordinated to M⁷; Y⁷¹, Y⁷² and Y⁷³

each independently represent a single bond or a connecting group; n⁷¹ and n⁷² denote 0 or 1, and at least one of n⁷¹ and n⁷² denotes 1; and n⁷³ denotes an integer from 0 to 4.

Next, the compound represented by the formula (1) will be explained in detail.

The metal ion represented by Ml has the same meaning as the metal ion of the aforementioned complex of the invention and the preferable range is also the same.

The coordination group represented by L¹¹, L¹², L¹³, L¹⁴, L¹⁵, L¹⁶ and L¹⁷ has the same meaning as the coordination group of the aforementioned complex of the invention. L¹¹, L¹², L¹³, L¹⁴, L¹⁵, L¹⁶ and L¹⁷ may be respectively combined with any other one of L¹¹, L¹², L¹³, L¹⁴, L¹⁵, L¹⁶, L¹⁷, Y¹¹, Y¹², Y¹³, Y¹⁴, or Y¹⁵.

Examples of the connecting group represented by Y¹¹, Y¹², Y¹³, Y¹⁴ or Y¹⁵ include, though not limited to, an alkylene group, alkenylene group, arylene group, heterocyclic connecting group, oxygen atom connecting group, sulfur atom connecting group, silicone atom connecting group, imino connecting group, carbonyl connecting group and connecting groups comprising combinations of these groups.

Y¹¹, Y¹², Y¹³, Y¹⁴ and Y¹⁵ are respectively preferably a single bond, an alkylene group, an alkenylene group, an arylene group, a heterocyclic connecting group, an imino connecting group, an oxygen atom connecting group, a sulfur atom connecting group and connecting groups comprising combinations of these groups and more preferably a single bond, an alkylene group, a nitrogen-containing heterocyclic connecting group, an imino connecting group, an oxygen atom connecting group and connecting groups comprising combinations of these groups.

Specific examples of the connecting group represented by Y¹¹, Y¹², Y¹³, Y¹⁴ or Y¹⁵ will be shown below.

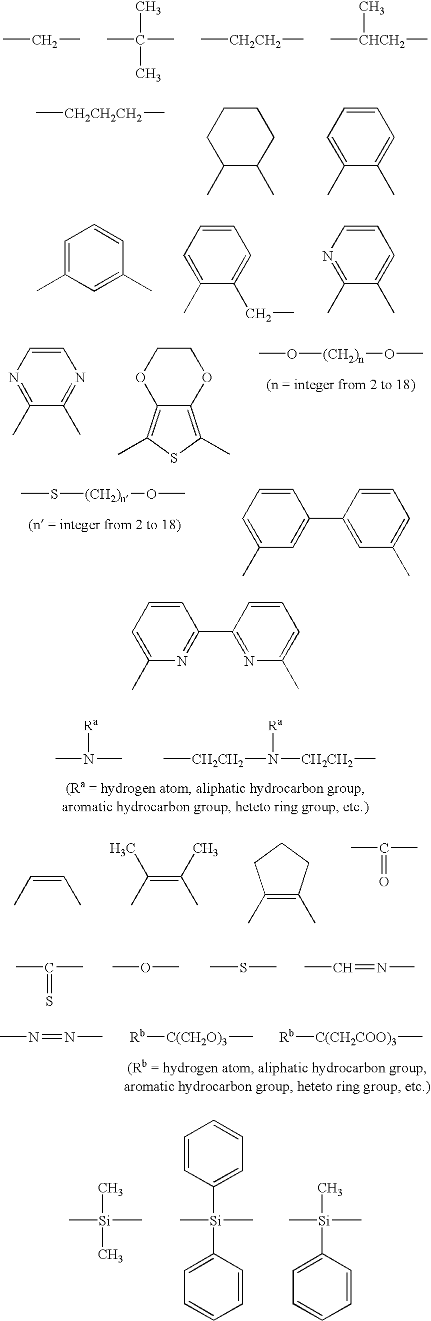

n¹¹ denotes 0 or 1 and preferably 1. n¹² denotes an integer from 0 to 4, preferably 0 or 1 and more preferably 0. When n¹² is an integer from 2 to 4, plural L¹⁷s may be the same or different. Plural L¹⁷s may be combined with each other and become a polydentated ligand with two or more coordination atoms.

Among the compounds represented by the formula (1), compounds represented by the following formula (1-A) are preferable and compounds represented by the following formula (1-B) are more preferable.

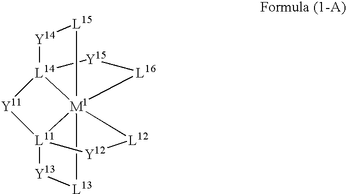

In the formula (1-A), M¹, L¹¹, L¹², L¹³, L¹⁴, L¹⁵, L¹⁶, Y¹¹, Y¹², Y¹³, Y¹⁴ and Y¹⁵ have the same meanings as those in the formula (1) and each preferable range is also the same.

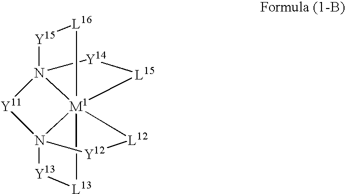

In the formula (1-B), M¹, L¹², L¹³, L¹⁴, L¹⁵, L¹⁶, Y¹¹, Y¹², Y¹³, Y¹⁴ and Y¹⁵ have the same meanings as those in the formula (1) and each preferable range is also the same.

Next, the compound represented by the formula (3) will be explained in detail.

The metal ion represented by M³ has the same meaning as the aforementioned metal ions of the complex of the invention and the preferable range is also the same.

The coordination group represented by L³¹, L³², L³³, L³⁴, L³⁵, L³⁶, or L³⁷ has the same meaning as the aforementioned coordination group of the complex of the invention. L³¹, L³², L³³, L³⁴, L³⁵, L³⁶ or L³⁷ may be respectively combined with any other one of L³¹, L³², L³³, L³⁴, L³⁵, L³⁶, L³⁷, Y³¹, Y³², Y³³, Y³⁴ and Y³⁵.

As the connecting group represented by Y³¹, Y³², Y³³, Y³⁴ and Y³⁵, those represented by Y¹¹ to Y¹⁵ may be applied, though the connecting group is not limited to these groups.

n³¹ represents 0 or 1 and preferably 1. n³² represents an integer from 0 to 4, preferably 0 or 1 and more preferably 0. When n³² is an integer from 2 to 4, plural L³⁷s may be the same or different. Plural L³⁷s may be combined with each other and become a polydentated ligand with two or more coordination atoms.

Among the compounds represented by the formula (3), compounds represented by the following formula (3-A) are preferable.

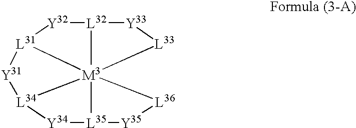

In the formula (3-A), M³, L³¹, L³², L³³, L³⁴, L³⁵, L³⁶, Y³¹, Y³², Y³³, Y⁴³ and Y³⁵ have the same meanings as those in the formula (3) and each preferable range is also the same.

Next, the compound represented by the formula (4) will be explained in detail.

The metal ion represented by M⁴ has the same meaning as the aforementioned metal ions of the complex of the invention and the preferable range is also the same.

The coordination group represented by L⁴¹, L⁴², L⁴³, L⁴⁴, L⁴⁵, L⁴⁶ or L⁴⁷ has the same meaning as the aforementioned coordination group of the complex of the invention. L⁴¹, L⁴², L⁴³, L⁴⁴, L⁴⁵, L⁴⁶ or L⁴⁷ may be respectively combined with any other one of L⁴¹, L⁴², L⁴³, L⁴⁴, L⁴⁵, L⁴⁶, L⁴⁷, Y⁴¹, Y⁴² and Y⁴³.

n⁴¹ and n⁴² denote 0 or 1, and at least one of n⁴¹ and n⁴² denote 1. n⁴¹ preferably denotes 1, and n⁴² preferably denotes 1. n⁴³ denotes an integer from 0 to 4, preferably 0 or 1 and more preferably 0. When n⁴³ is an integer from 2 to 4, plural L⁴⁷s may be the same or different. Plural L⁴⁷s may be combined with each other and become a polydentated ligand with two or more coordination atoms.

Next, the compound represented by the formula (5) will be explained in detail.

The metal ion represented by M⁵ has the same meaning as the aforementioned metal ions of the complex of the invention and the preferable range is also the same.

The coordination group represented by L⁵¹, L⁵², L⁵³, L⁵⁴, L⁵⁵, L⁵⁶ or L⁵⁷ has the same meaning as the aforementioned coordination group of the complex of the invention. L⁵¹, L⁵², L⁵³, L⁵⁴, L⁵⁵, L⁵⁶ or L⁵⁷ may be respectively combined with any other one of L⁵¹, L⁵², L⁵³, L⁵⁴, L⁵⁵, L⁵⁶, L⁵⁷, Y⁵¹, Y⁵² and Y⁵³.

n⁵¹ and n⁵² denote 0 or 1, and at least one of n⁵¹ and n⁵² denote 1. n⁵¹ preferably denotes 1, and n⁵² preferably denotes 1. n⁵³ denotes an integer from 0 to 4, preferably 0 or 1 and more preferably 0. When n⁵³ is an integer from 2 to 4, plural L⁵⁷s may be the same or different. Plural L⁵⁷s may be combined with each other and become a polydentated ligand with two or more coordination atoms.

Next, the compound represented by the formula (6) will be explained in detail.

The metal ion represented by M⁶ has the same meaning as the aforementioned metal ions of the complex of the invention and the preferable range is also the same.

The coordination group represented by L⁶¹, L⁶², L⁶³, L⁶⁴, L⁶⁵, L⁶⁶ or L⁶⁷ has the same meaning as the aforementioned coordination group of the complex of the invention. L⁶¹, L⁶², L⁶³, L⁶⁴, L⁶⁵, L⁶⁶ or L⁶⁷ may be respectively combined with any other one of L⁶¹, L⁶², L⁶³, L⁶⁴, L⁶⁵, L⁶⁶, L⁶⁷, Y⁶¹, Y⁶² and Y⁶³.

n⁶¹ denotes 0 or 1, and prefarably 1. n⁶² denotes an integer from 0 to 4, preferably 0 or 1 and more preferably 0. When n⁶² is an integer from 2 to 4, plural L⁶⁷s may be the same or different. Plural L⁶⁷S may be combined with each other and become a polydentated ligand with two or more coordination atoms.

Next, the compound represented by the formula (7) will be explained in detail.

The metal ion represented by M⁷ has the same meaning as the aforementioned metal ions of the complex of the invention and the preferable range is also the same.

The coordination group represented by L⁷¹, L⁷², L⁷³, L⁷⁴, L⁷⁵, L⁷⁶ or L⁷⁷ has the same meaning as the aforementioned coordination group of the complex of the invention. L⁷¹, L⁷², L⁷³, L⁷⁴, L⁷⁵, L⁷⁶ or L⁷⁷ may be respectively combined with any other one of L⁷¹, L⁷², L⁷³, L⁷⁴, L⁷⁵, L⁷⁶, L⁷⁷, Y⁷¹, Y⁷² and Y⁷³.

n⁷¹ and n⁷² denote 0 or 1, and at least one of n⁷¹ and n⁷² denote 1. n⁷¹ prefarably denotes 1, and n⁷² prefarably denotes 1. n⁷³ denotes an integer from 0 to 4, preferably 0 or 1 and more preferably 0. When n⁷³ is an integer from 2 to 4, plural L⁷⁷s may be the same or different. Plural L⁷⁷s may be combined with each other and become a polydentated ligand with two or more coordination atoms.

Next, the compound represented by the formula (2) will be explained in detail.

The metal ion represented by M² has the same meaning as the aforementioned metal ions of the complex of the invention and the preferable range is also the same.

The coordination group represented by L²¹, L²², L²³, L²⁴, L²⁵, L²⁶ or L²⁷ has the same meaning as the aforementioned coordination group of the complex of the invention. L²¹, L²², L²³, L²⁴, L²⁵, L²⁶ or L²⁷ may be respectively combined with any other one of L²¹, L²², L²³, L²⁴, L²⁵, L²⁶, L²⁷, Y²¹, Y²², Y²³ or Y²⁴.

As the connecting group represented by Y²¹, Y²², Y²³ and Y²⁴, those represented by Y¹¹ to Y¹⁵ may be applied, though the connecting group is not limited to these groups.

n²¹ represents 0 or 1 and preferably 1. n²² represents an integer from 0 to 4, preferably 0 or 1 and more preferably 0. When n²² is an integer from 2 to 4, plural L²⁷s may be the same or different. Plural L²⁷s may be combined with each other and become a polydentated ligand with two or more coordination atoms.

Among the compounds represented by the formula (2), compounds represented by the following formula (2-A) are preferable.

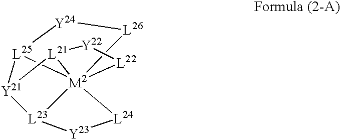

In the formula (2-A), M², L²¹, L²², L²³, L²⁴, L²⁵, L²⁶, Y²¹, Y²², Y²³ and Y²⁴ have the same meanings as those in the formula (2) and each preferable range is also the same.

Among the compounds represented by the formula (2-A), compounds represented by the following formulae (2-1) to (2-13) are preferable.

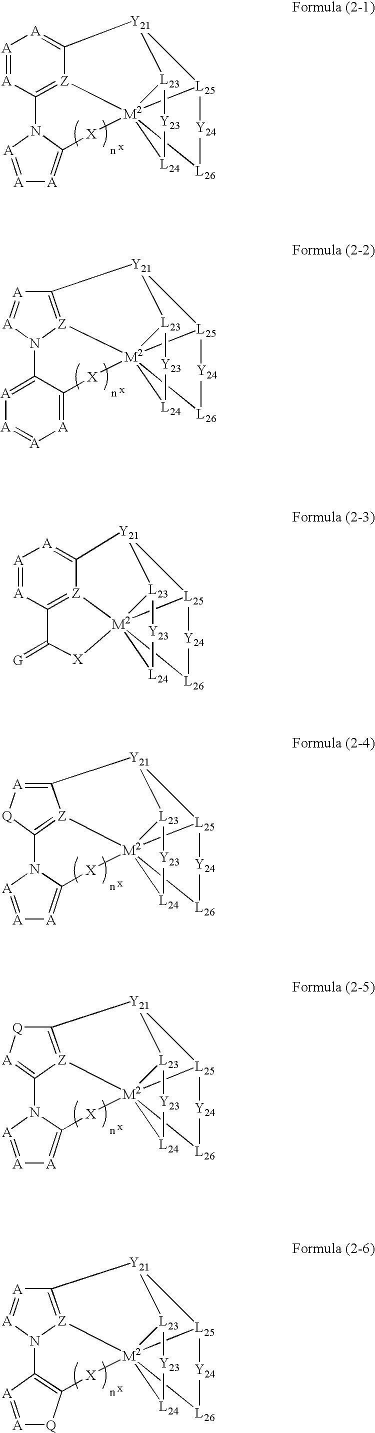

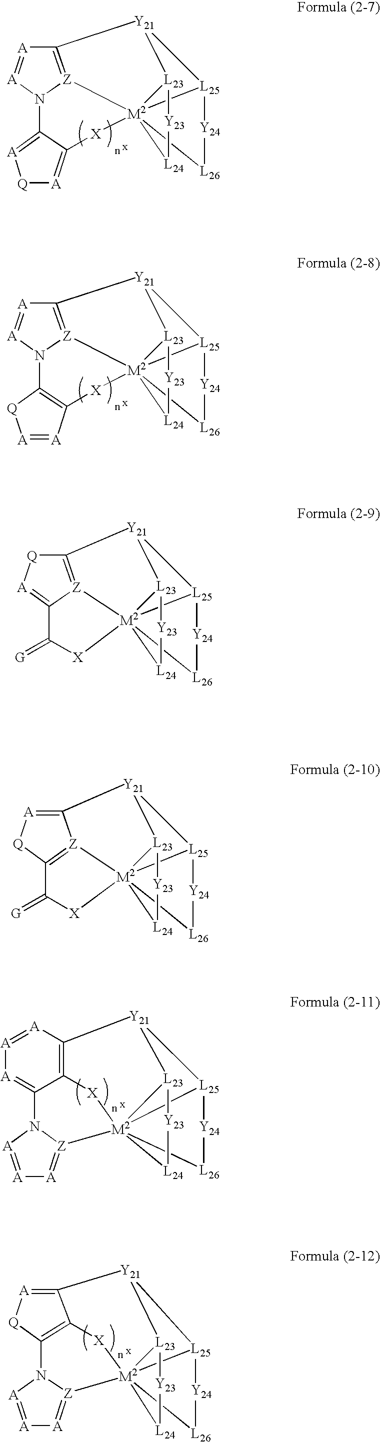

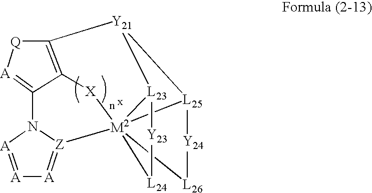

In the formulae (2-1) to (2-13), M² represents a metal ion; L₂₃, L₂₄, L₂₅ and L₂₆ each independently represent a coordination group coordinated to M²; Y₂₁, Y₂₃ and Y₂₄ each independently represent a single bond or a connecting group; A represents CR^{A}, N or P; R^{A} represents hydrogen, alkyl group, alkenyl group or alkynyl group; Z represents N or P; X represents O, S or NR^{N1}; R^{N1} represents hydrogen or alkyl group; n^{x} denotes 0 or 1; Q represents O, S, Se, NR^{N2}, CR^{Cl} or CR^{C2}; R^{N2} represents hydrogen, alkyl group, aryl group or hetero ring group; and G represents O or S.

Next, the compounds represented by the formulae (2-1) to (2-13) will be explained in detail.

M², Y²¹, Y²³, Y²⁴, L²³, L²⁴, L²⁵ and L²⁶ have the same meaning as in the formula (2) and the preferable range is also the same.

A represents CR^{A}, N or P; R^{A} represents a hydrogen atom or a subsituent group and a substituent group includes an aforementioned substituent group-A; Preferable substituent group is alkyl group, aryl group, fluorine atom,alkoxy group, amino group or cyano group; A preferably represents CR^{A} or N, and more preferably CR^{A}; Z represents N or P, and preferably N; X represents O, S or NR^{N1}, and R^{N1} represents a hydrogen atom or a subsituent group; A substituent group as R^{N1} includes a substituent group-B listed below;

<Substituent Group-B>

Alkyl groups (those having preferably 1 to 30 carbon atoms, more preferably 1 to 20 carbon atoms and particularly preferably 1 to 10 carbon atoms, for example, methyl, ethyl, isopropyl, tert-butyl, n-octyl, n-decyl, n-hexadecyl, cyclopropyl, cyclopentyl and cyclohexyl), aryl groups (those having preferably 6 to 30 carbon atoms, more preferably 6 to 20 carbon atoms and particularly preferably 6 to 12 carbon atoms, for example, phenyl, p-methylphenyl, naphthyl and anthranyl), amino groups (those having preferably 0 to 30 carbon atoms, more preferably 0 to 20 carbon atoms and particularly preferably 0 to 10 carbon atoms, for example, amino, methylamino, dimethylamino, diethylamino, dibenzylamino, diphenylamino and ditolylamino), acyl groups (those having preferably 1 to 30 carbon atoms, more preferably 1 to 20 carbon atoms and particularly preferably 1 to 12 carbon atoms, for example, acetyl, benzoyl, formyl and pivaloyl), sulfonyl groups (those having preferably 1 to 30 carbon atoms, more preferably 1 to 20 carbon atoms and particularly preferably 1 to 12 carbon atoms, for example, mesyl and tosyl), heterocyclic groups (those having preferably 1 to 30 carbon atoms and more preferably 1 to 12 carbon atoms, examples of the heteroatom include a nitrogen atom, oxygen atom sulfur atom, and specific examples of the heterocyclic groups include imidazolyl, pyridyl, quinolyl, furyl, thienyl, piperidyl, morpholino, benzoxazolyl, benzimidazolyl, benzthiazolyl, carbazolyl groups and azepinyl groups), silyl groups (those having preferably 3 to 40 carbon atoms, more preferably 3 to 30 carbon atoms and particularly preferably 3 to 24 carbon atoms, for example, trimethylsilyl and triphenylsilyl) and silyloxy groups (those having preferably 3 to 40 carbon atoms, more preferably 3 to 30 carbon atoms and particularly preferably 3 to 24 carbon atoms, for example, trimethylsilyloxy and triphenylsilyloxy).

A substituent represented as R^{N1} is preferably alkyl group or sulfonyl group. X is preferably oxygen atom or sulfur atom. n^{x} denotes 0 or 1. When M² represents platinum ion, gold ion, iridium ion, rhenium ion, palladium ion or rhodium ion, n^{x} preferably denotes 0. When M represents aluminum ion or gallium ion, n^{x} preferably denotes 1. G represents O or S, and preferably O. Q represents O, S, Se, NR^{N2}, CR^{C1} or CR^{C2}. Examples of R^{N2} include aforementioned substituent group-B, and are preferably alkyl group, aryl group or heterocyclic group. Examples of R^{C1} or R^{C2} include aforementioned substituent group-A, and are preferably alkyl group, aryl group or heterocyclic group. Q is preferably O, S, NR^{N2}, CR^{C1} or CR^{C2}, and more preferably O, S or NR^{N2}, and further preferably NR^{N2}.

The complex of the invention has a ligand with 5 or more coordination atoms, preferably 5 to 10 coordination atoms, more preferably 5 to 8 coordination atoms, still more preferably 5 or 6 coordination atoms and particularly preferably 6 coordination atoms. When the complex is made to have a ligand with 5 to 10 coordination atoms, the stability of the complex is improved, thereby bettering driving durability and preserving stability with time. Also, the quantum efficiency of phosphorescence is increased, resulting in increased luminous efficiency. Moreover, complexes having a ligand with 5 or more coordination atoms tend to be reduced in the lifetime of phosphorescence, which brings about high luminance and efficiency when the device is driven under high current. Also, the shortened lifetime of phosphorescence shortens the time during which the complex is put in an unstable exciting state and therefore durability is also improved.

The complex of the invention may be a low-molecular compound, and may be an oligomer compound or polymer compound (weight average molecular weight (based on polystyrene) of preferably 1,000 to 5,000,000, more preferably 2,000 to 1,000,000 and still more preferably 3,000 to 100,000). When the complex is a polymer compound, the complex part may be contained in either the polymer primary chain or the polymer side chain. Also, when the complex is a polymer compound, the compound may be either a homopolymer compound or a copolymer. The complex of the invention may be a low-molecular compound.

Then, compound examples of the complex of the invention will be shown below; however, these examples are not intended to limit the scope of the invention.

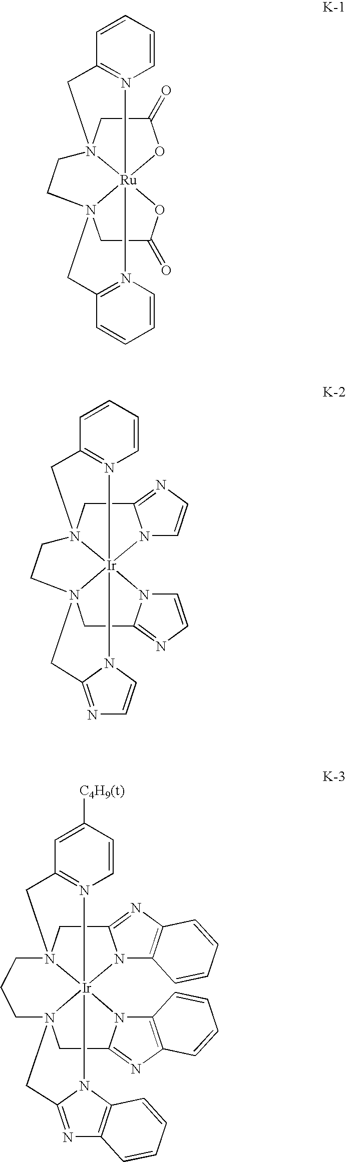

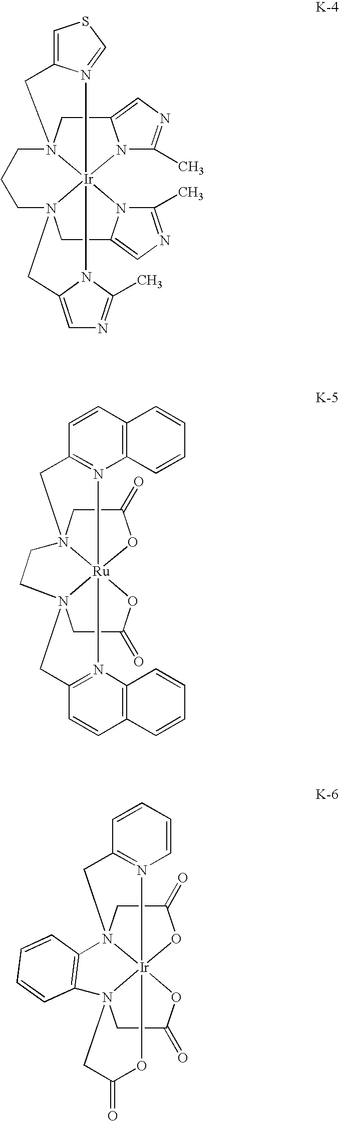

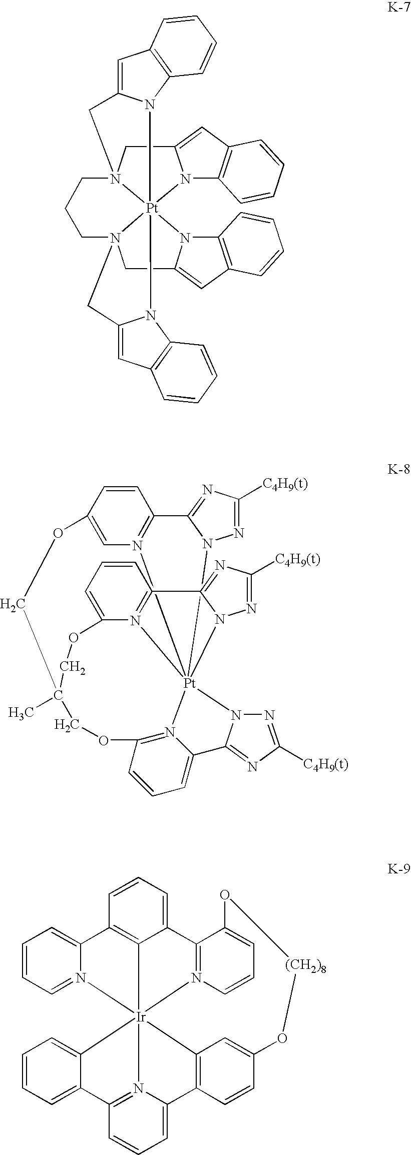

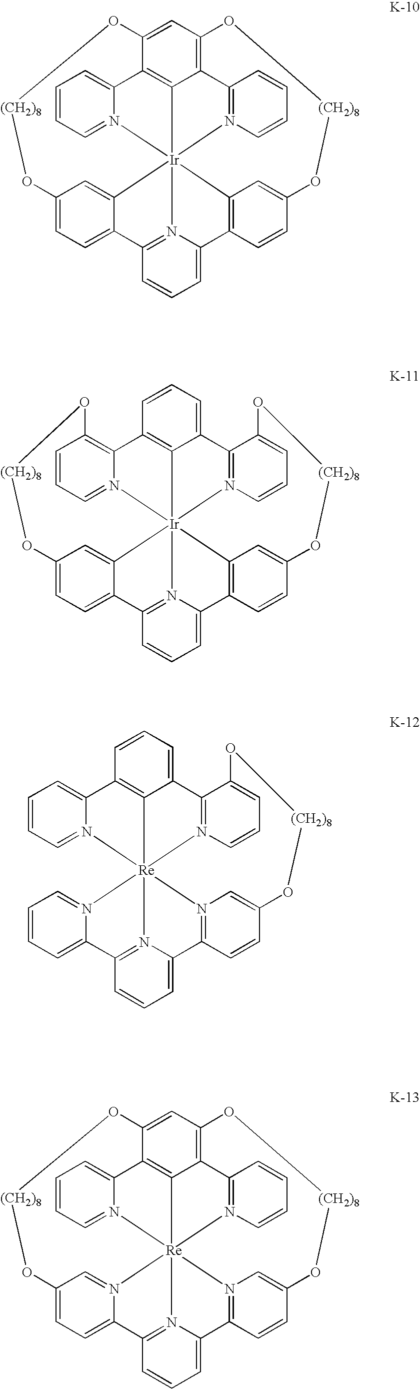

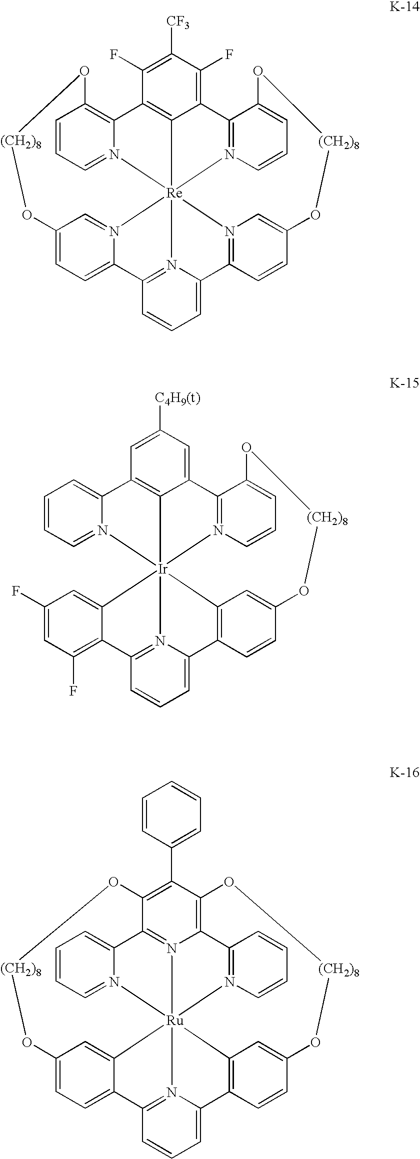

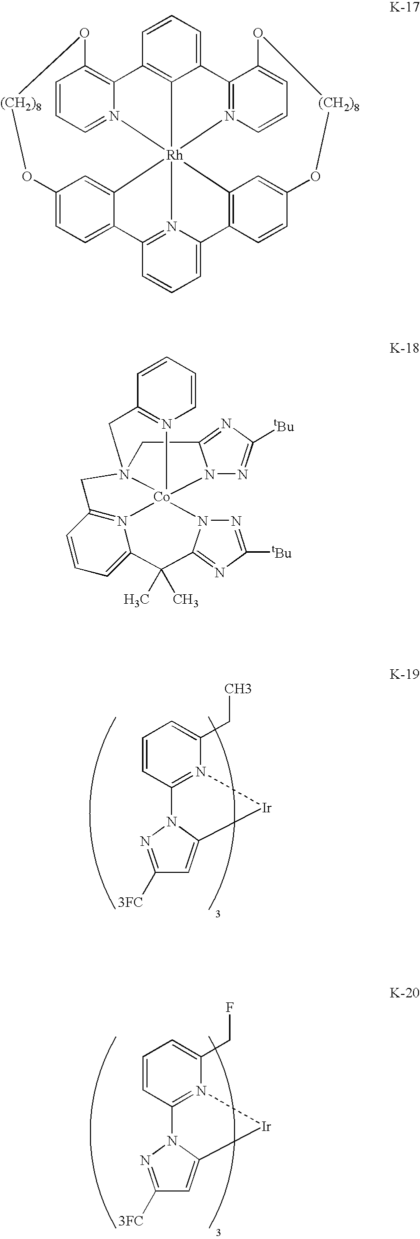

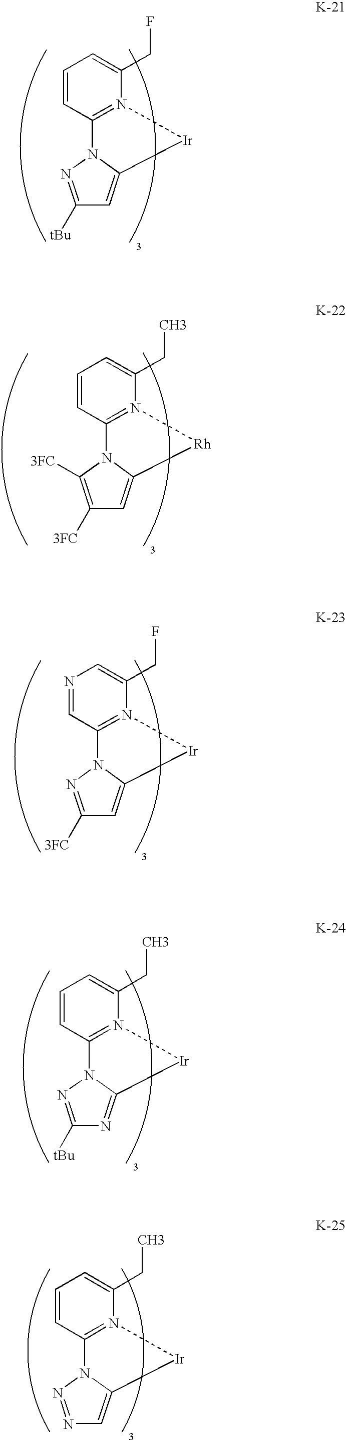

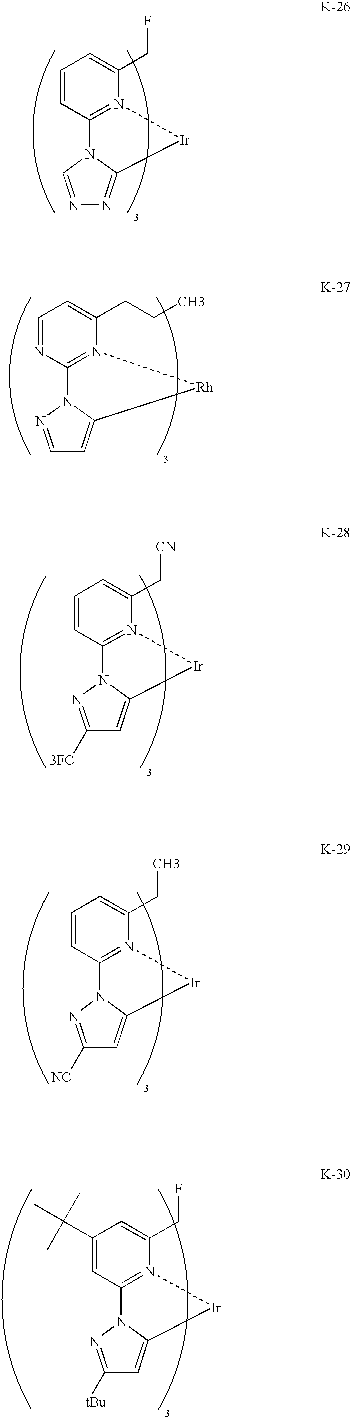

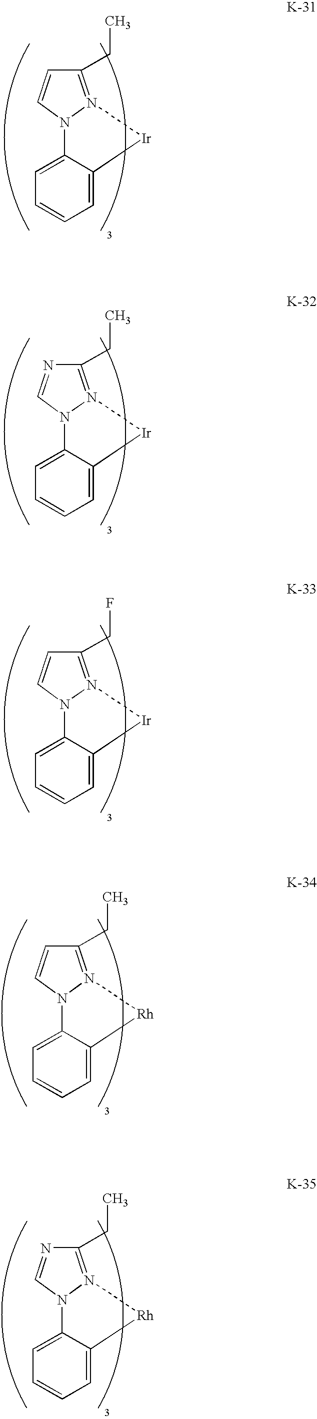

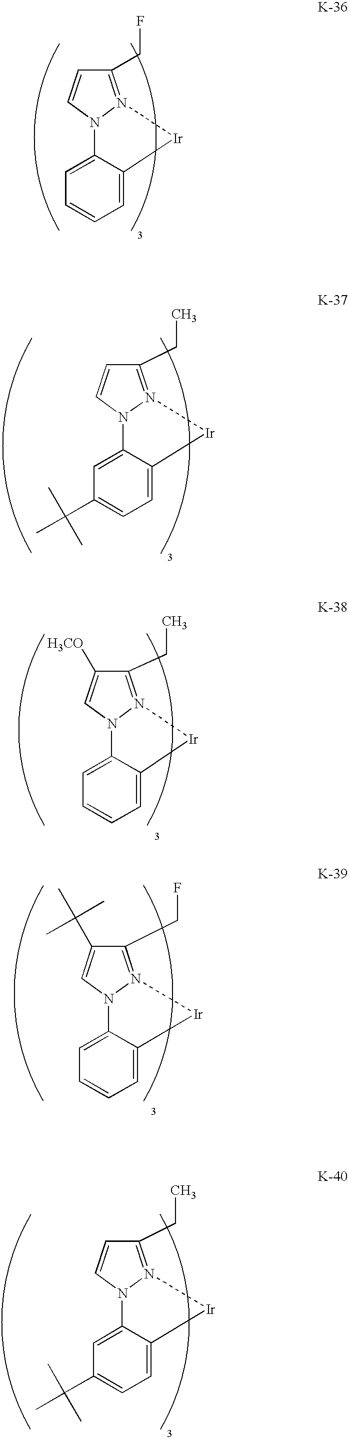

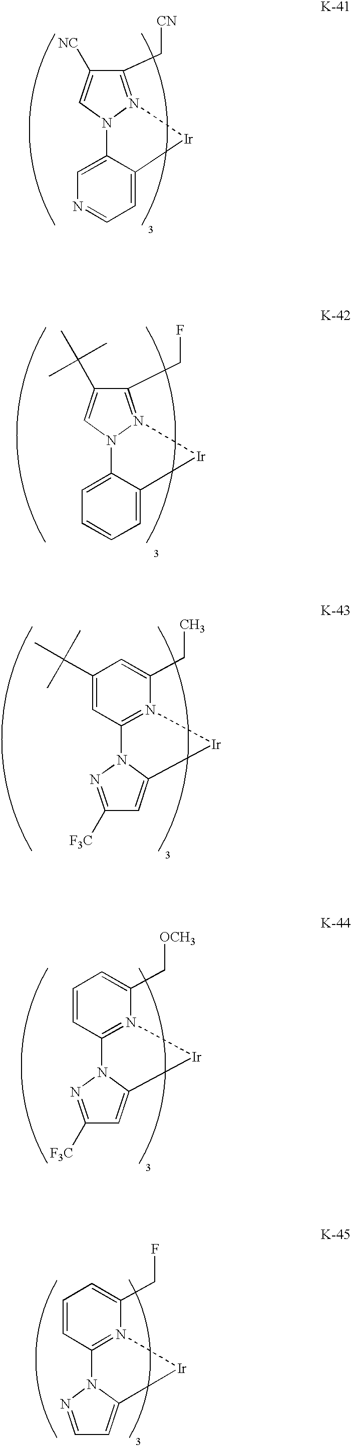

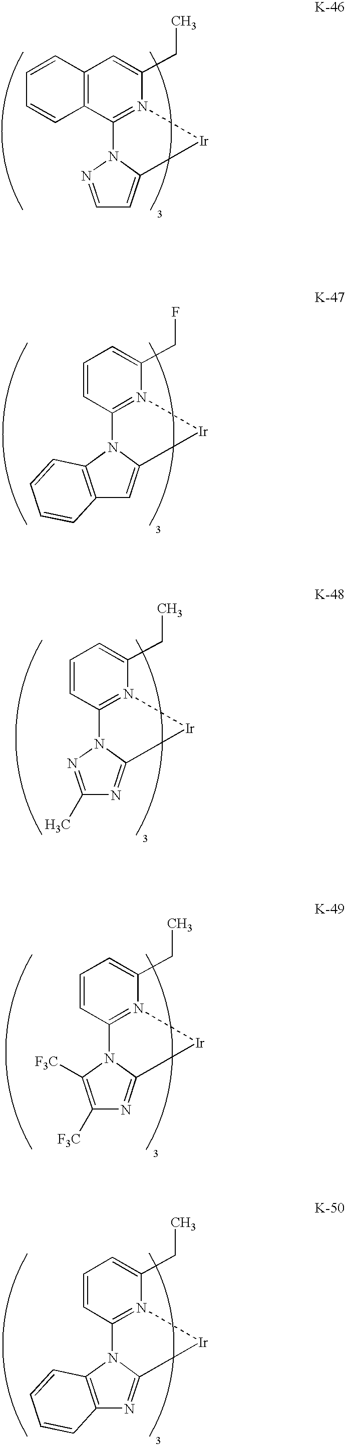

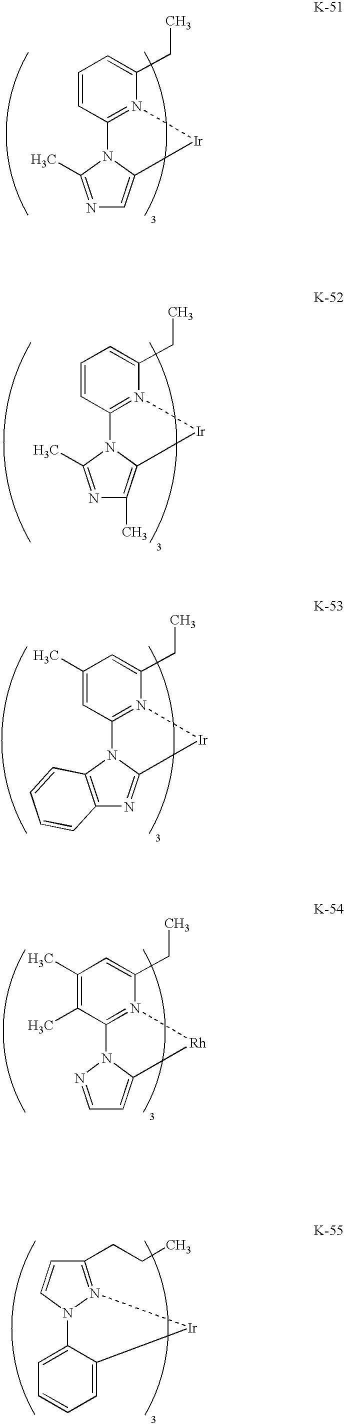

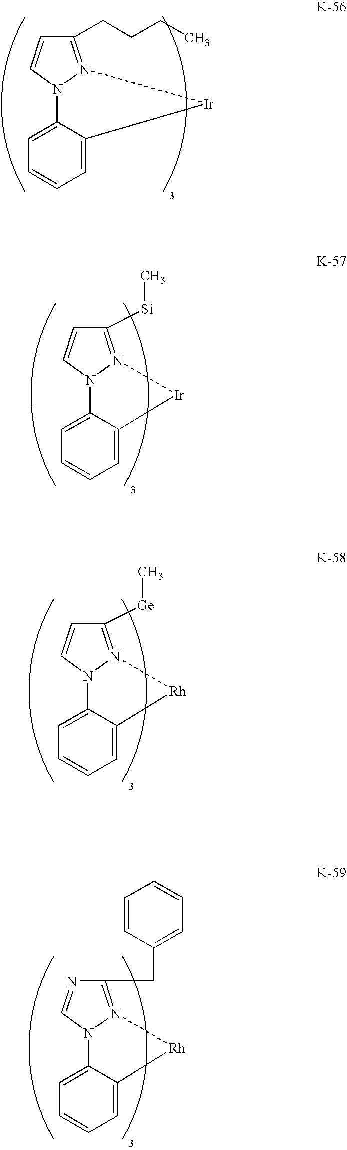

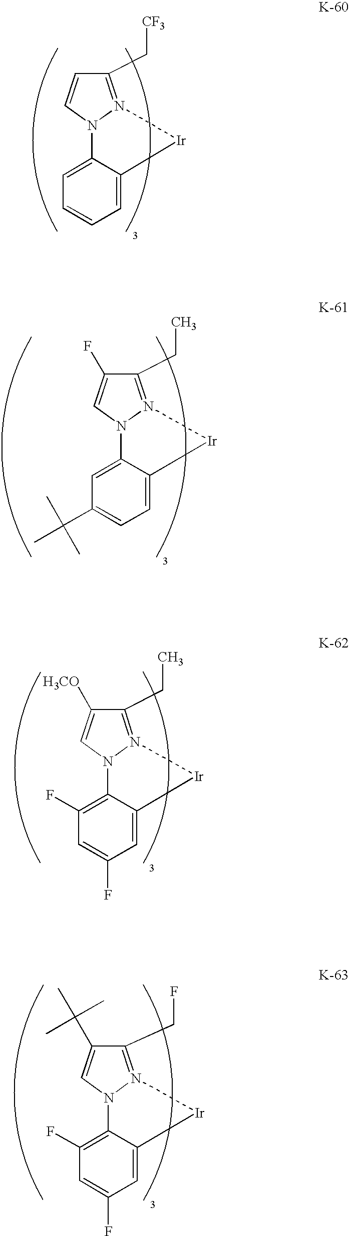

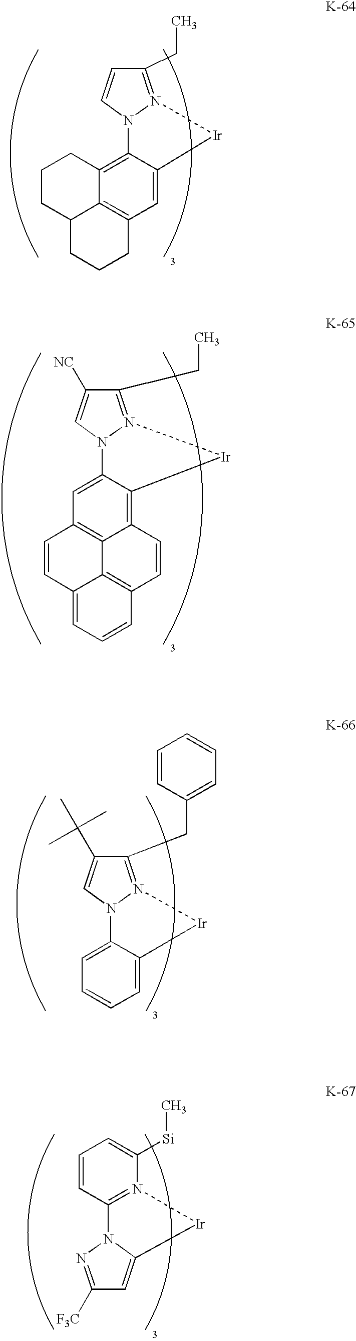

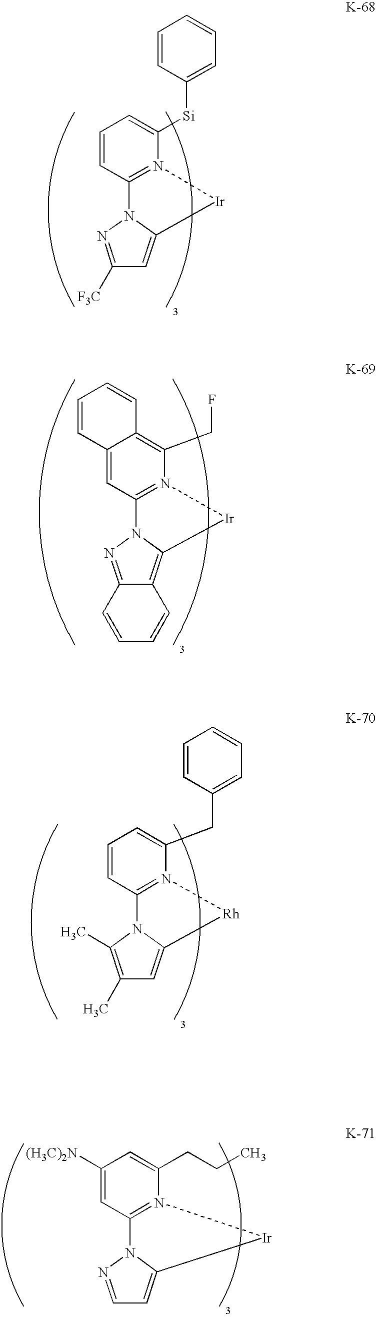

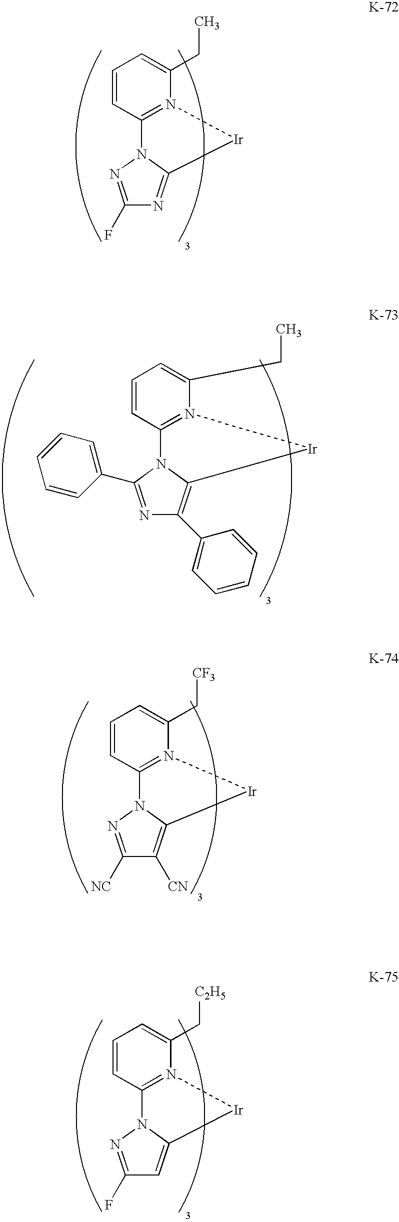

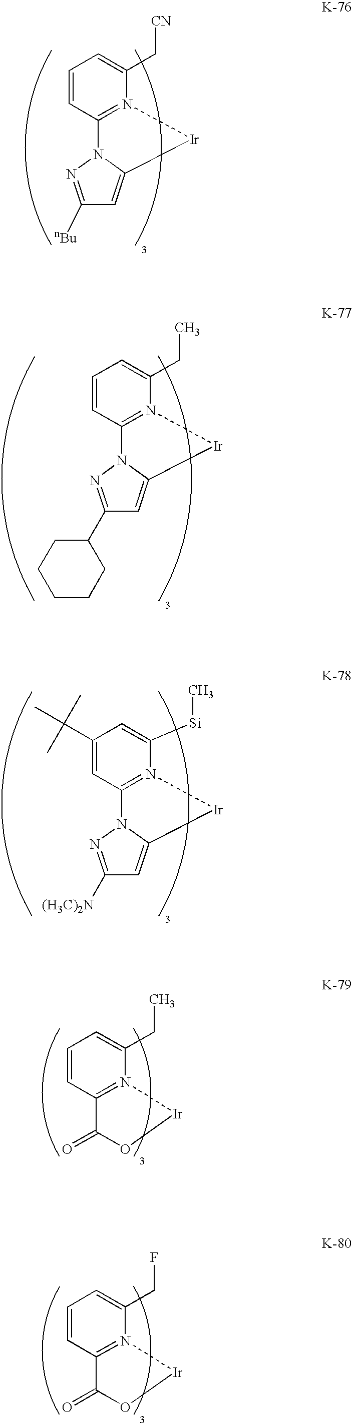

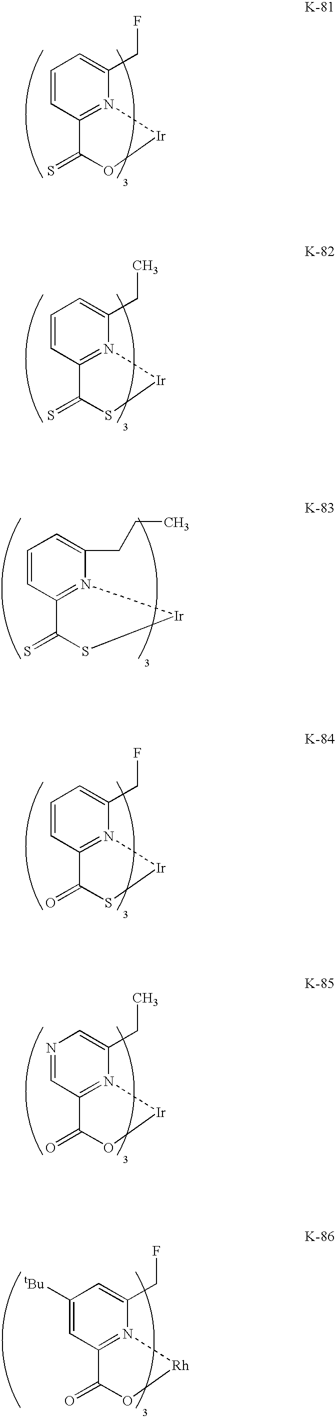

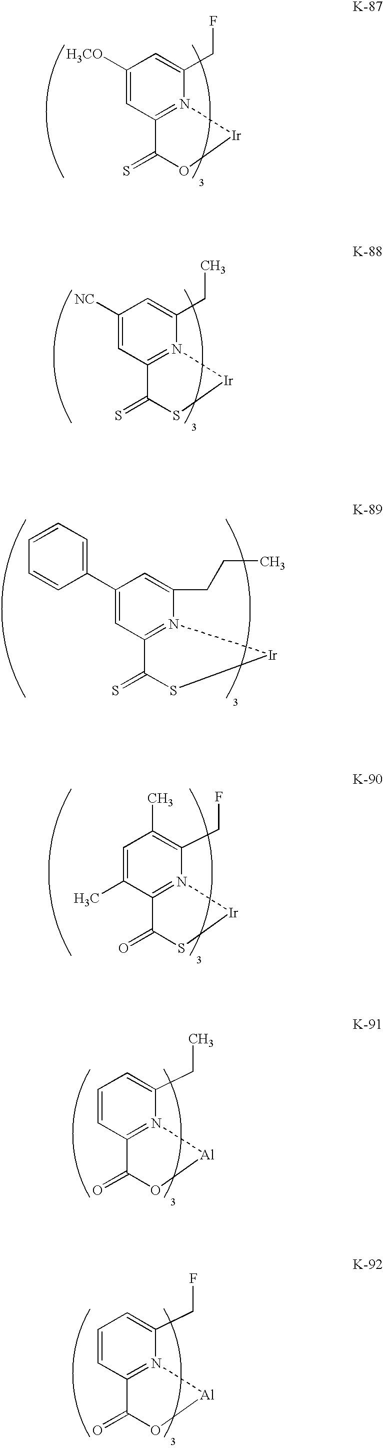

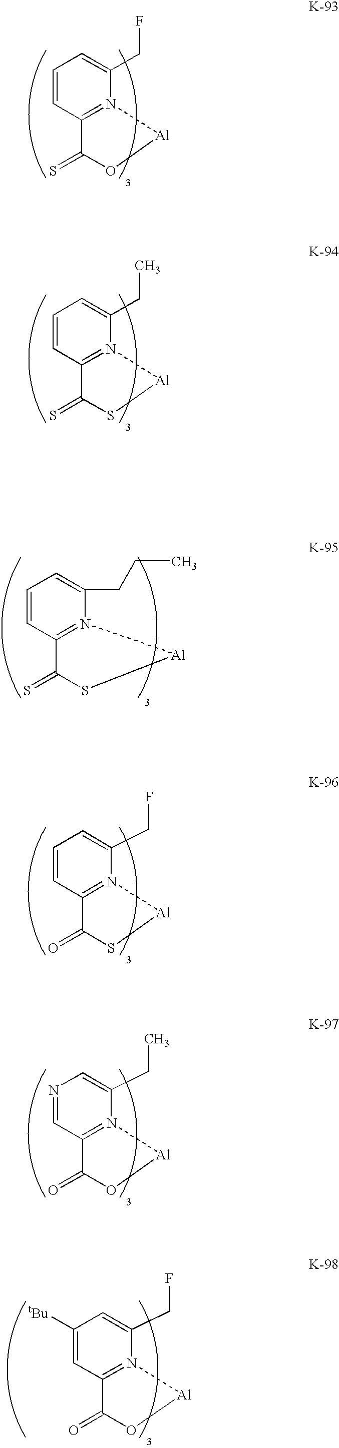

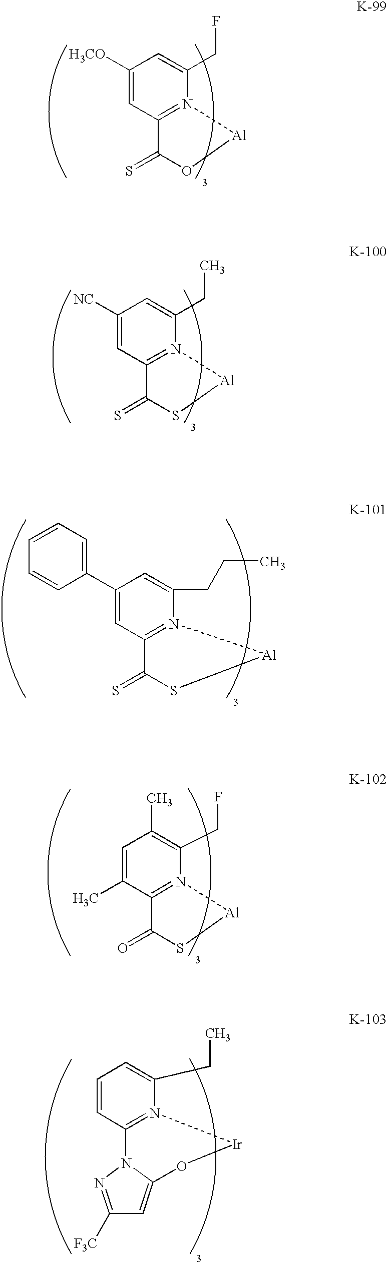

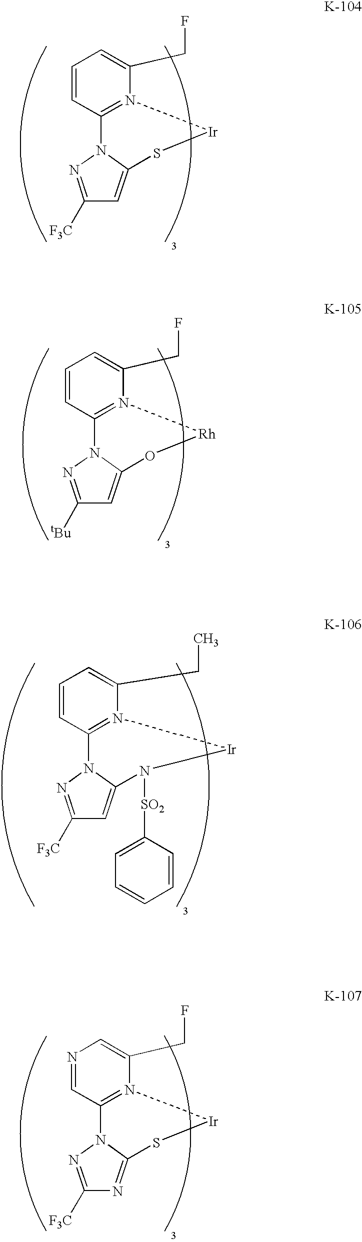

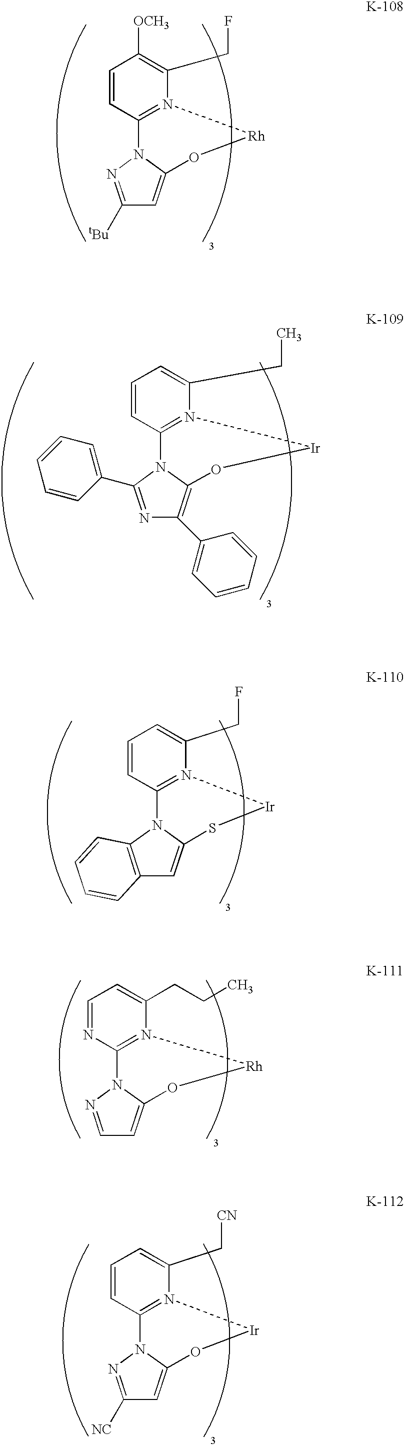

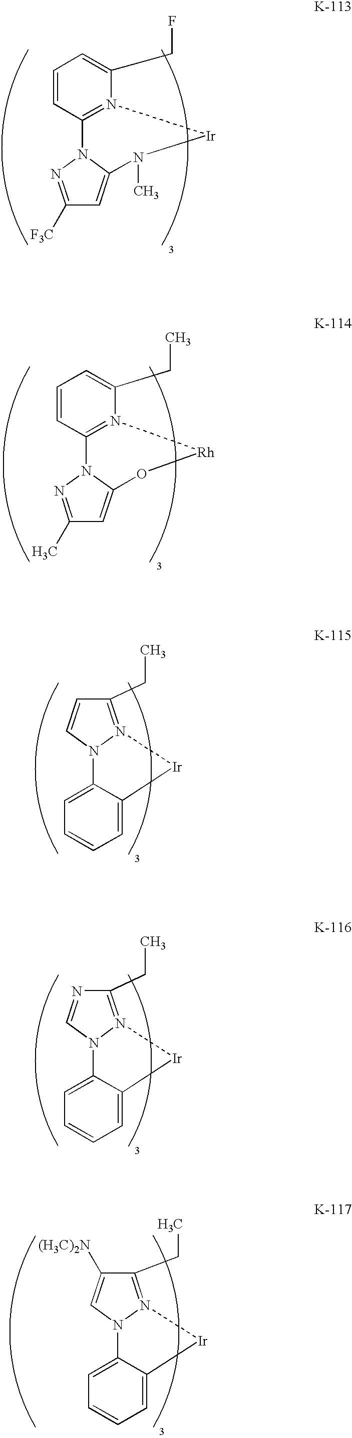

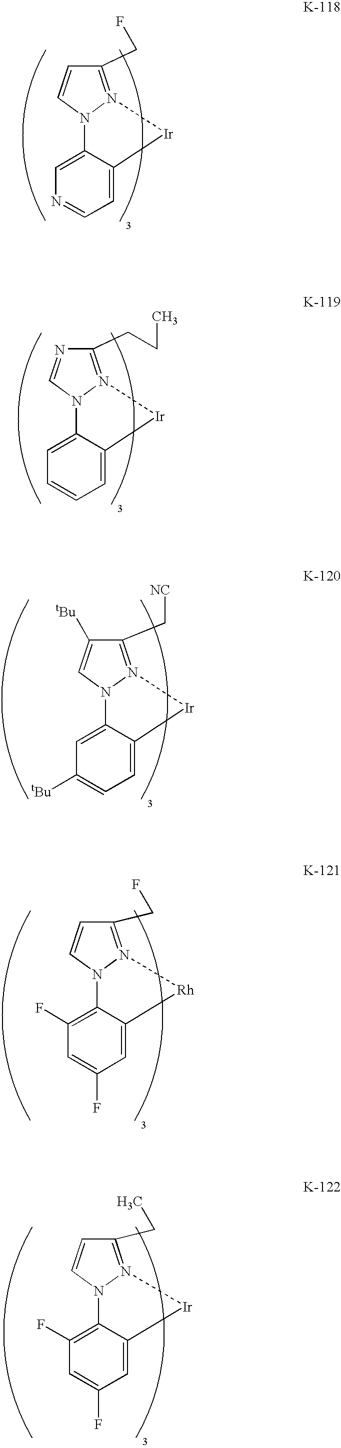

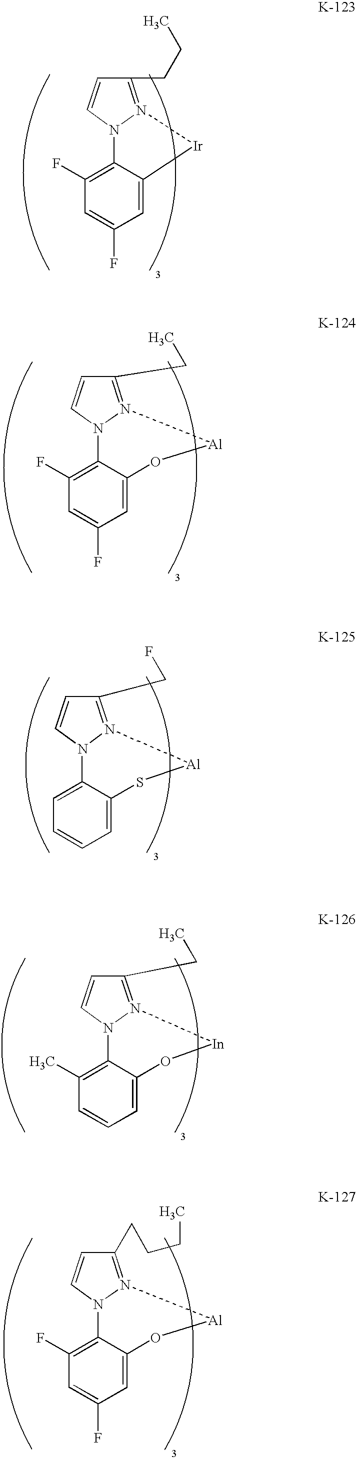

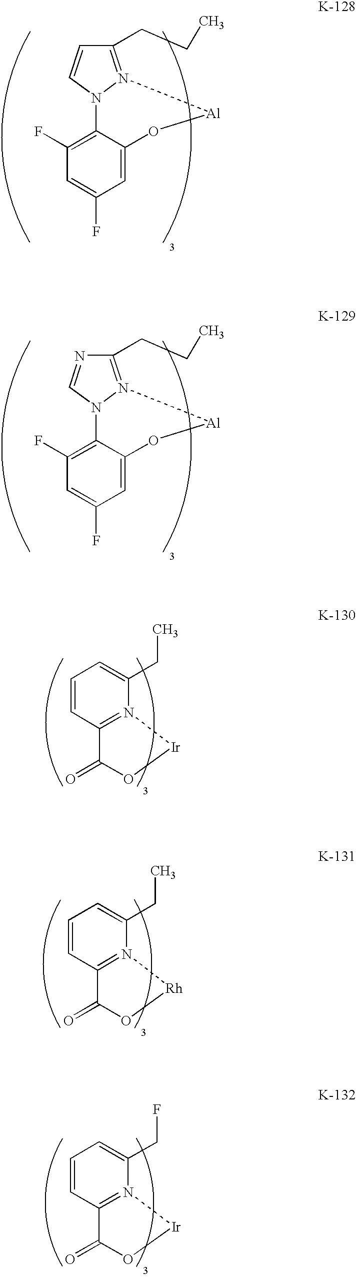

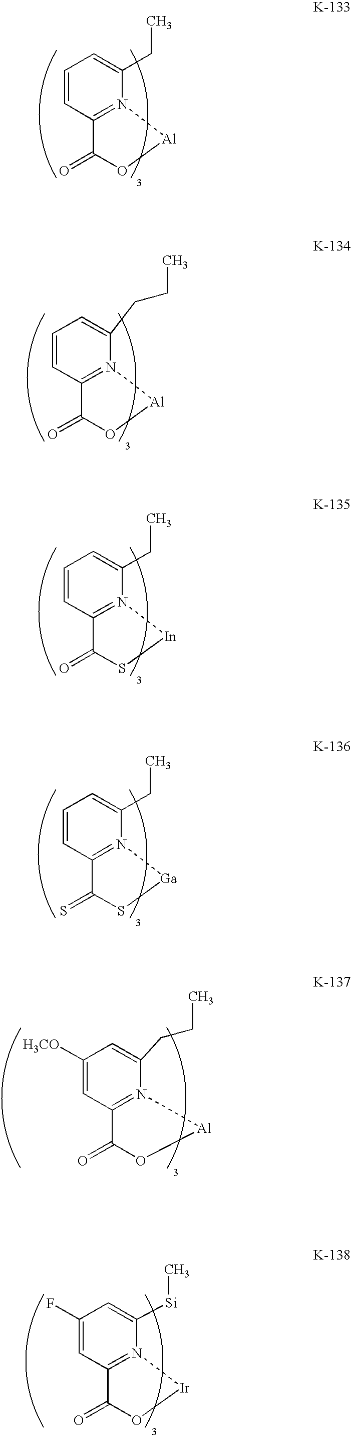

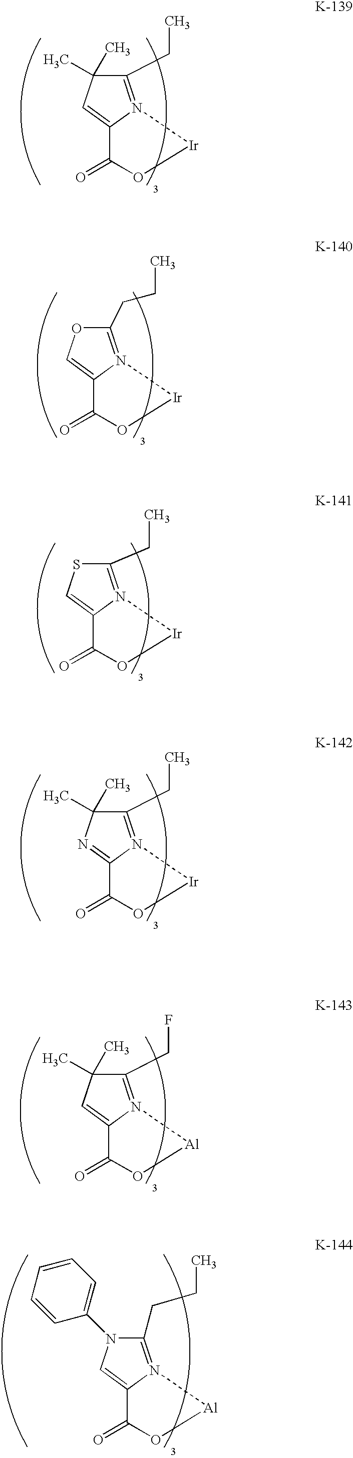

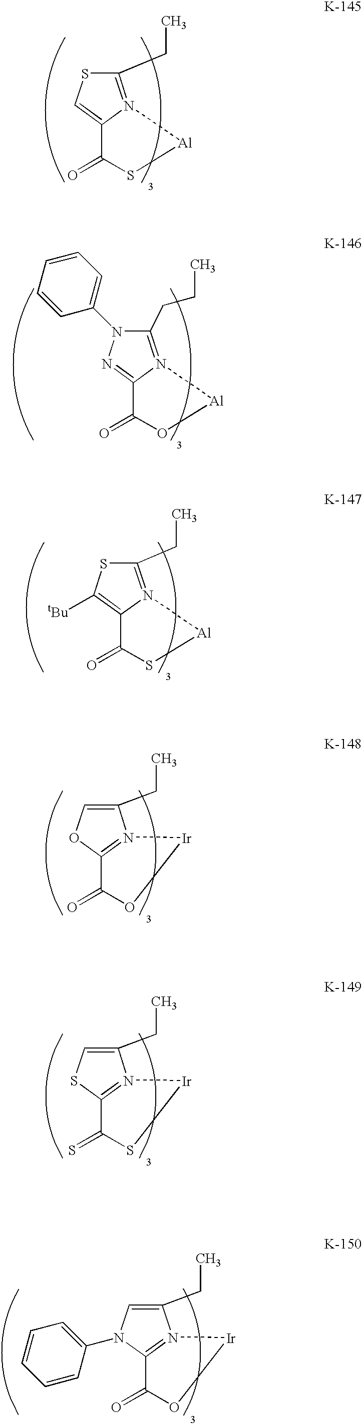

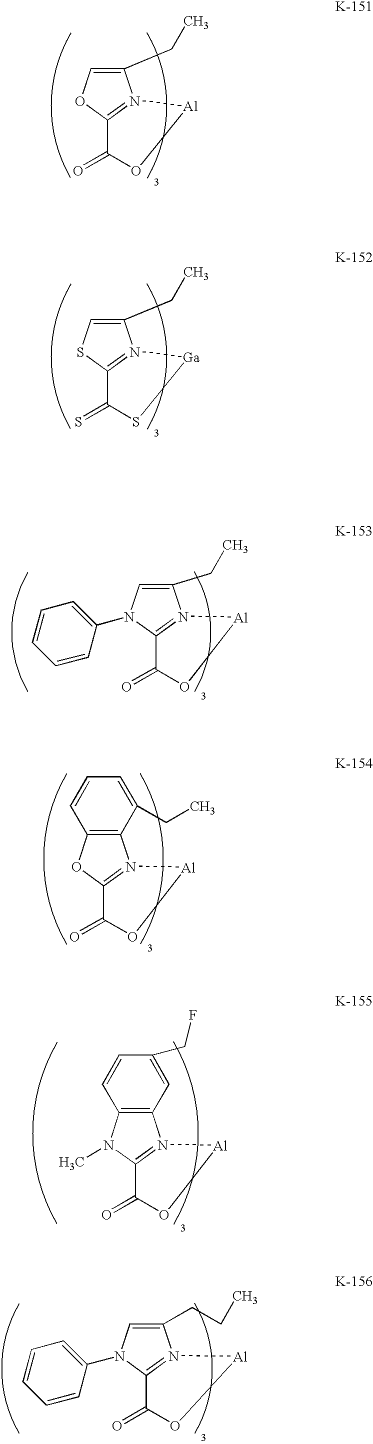

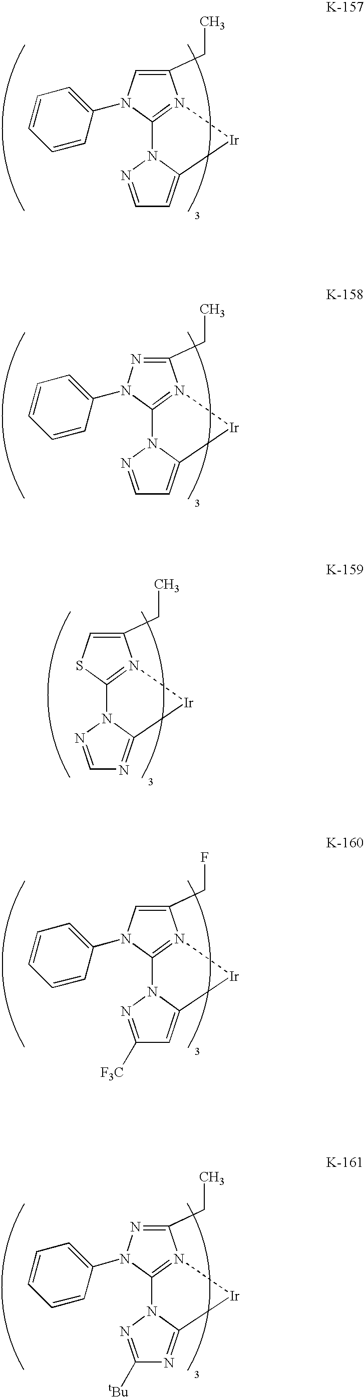

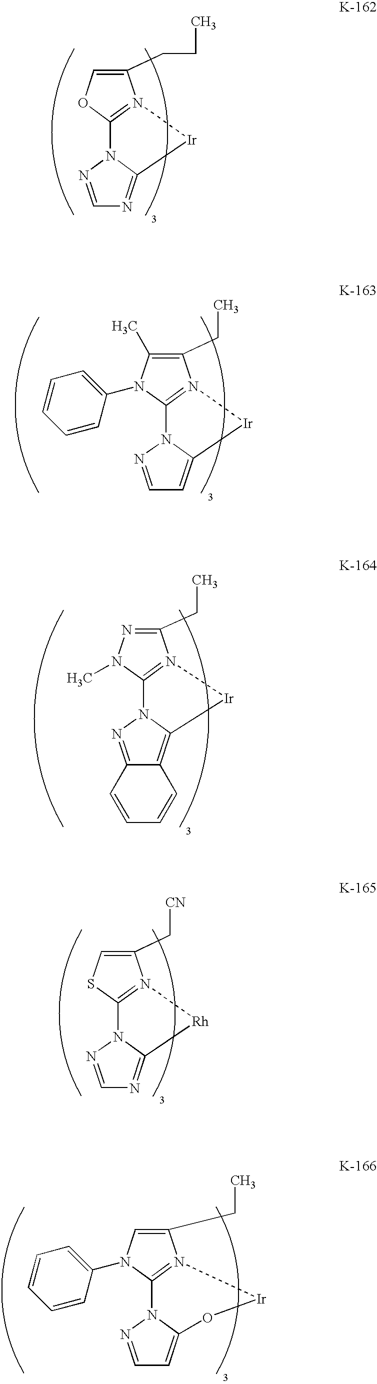

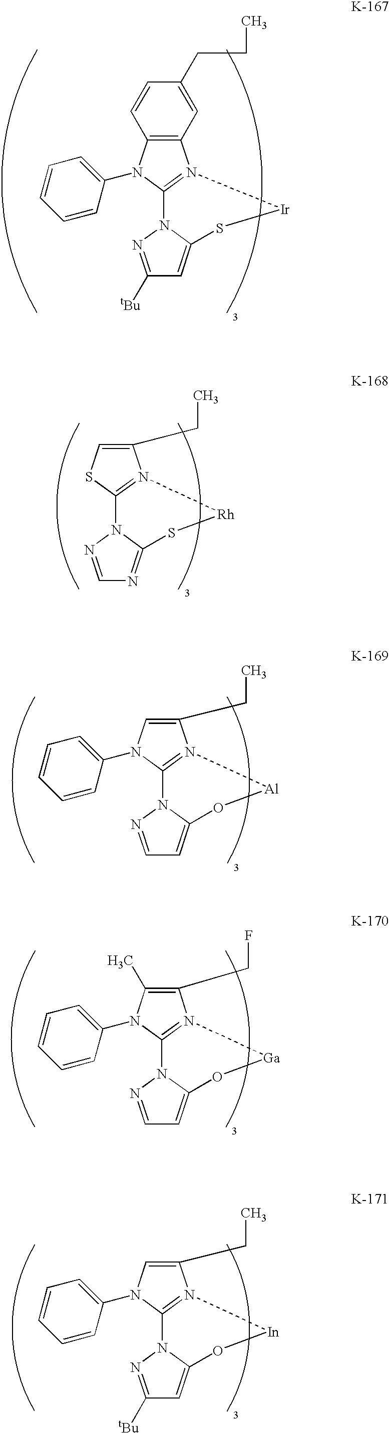

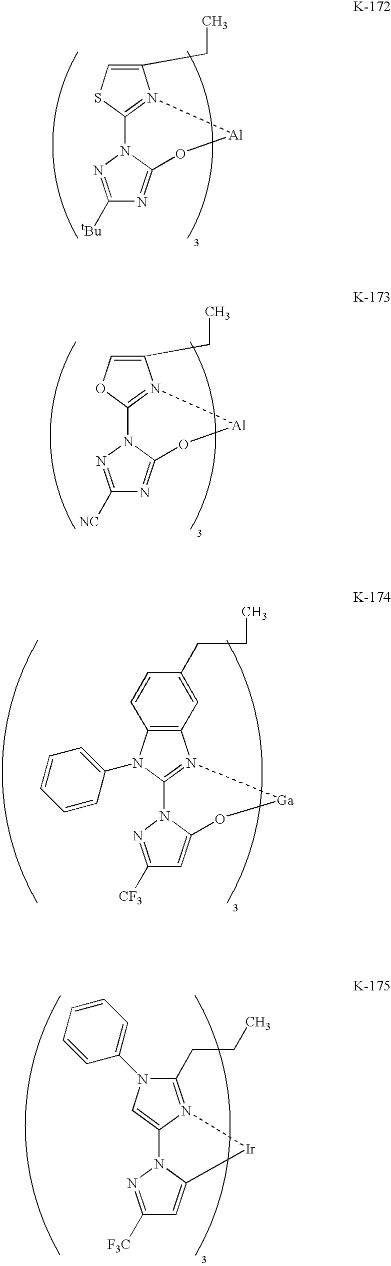

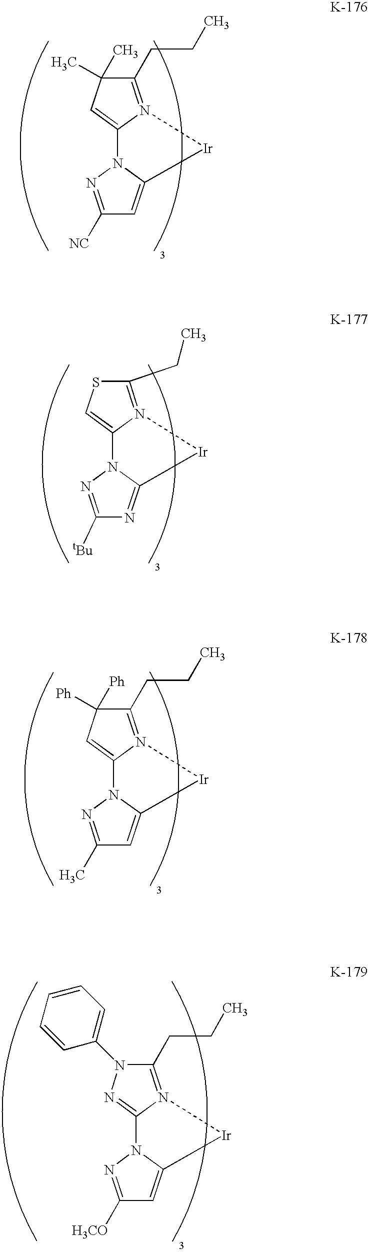

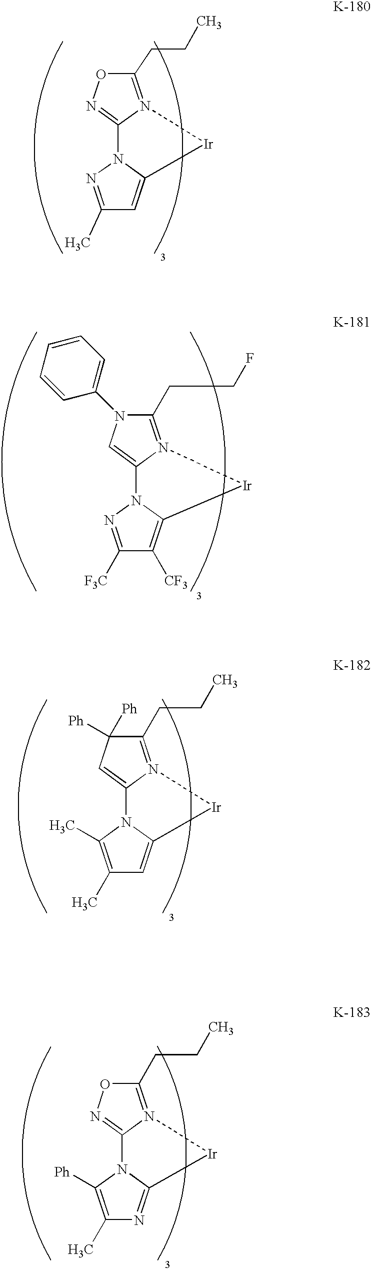

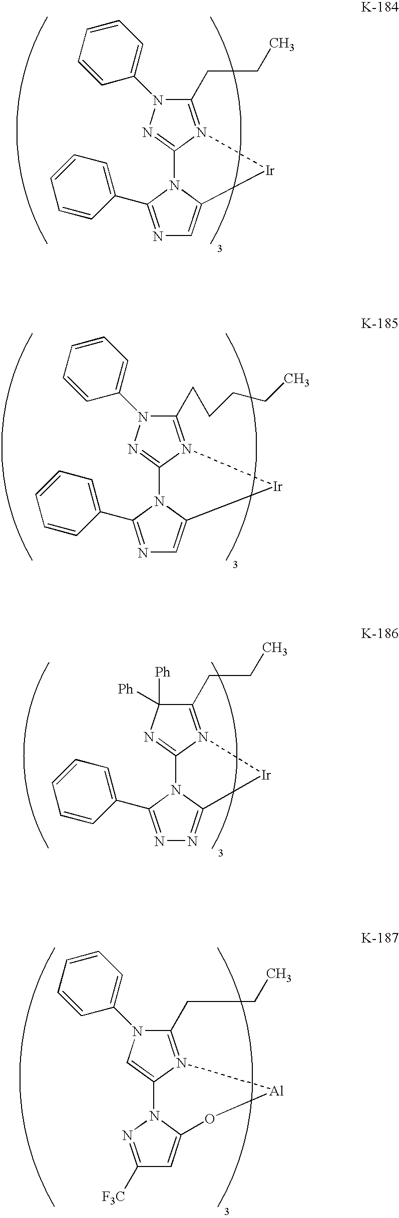

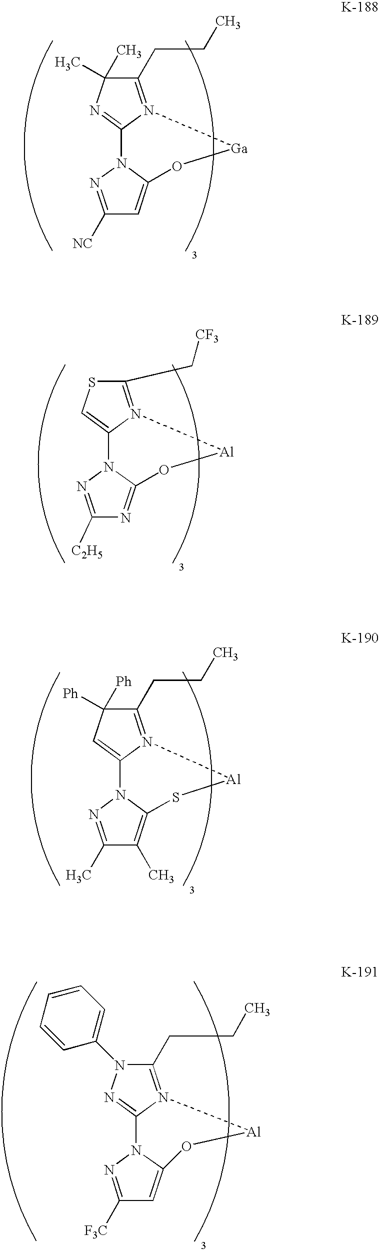

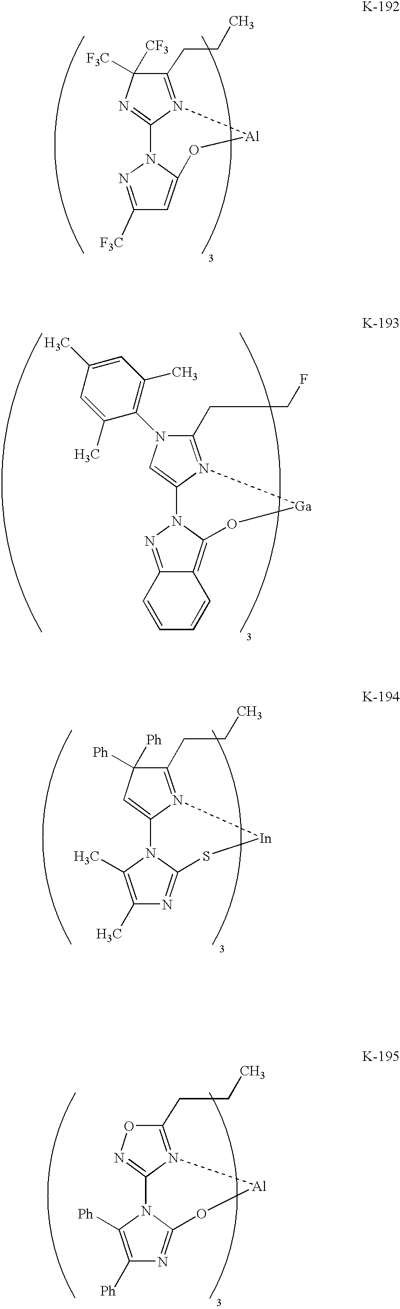

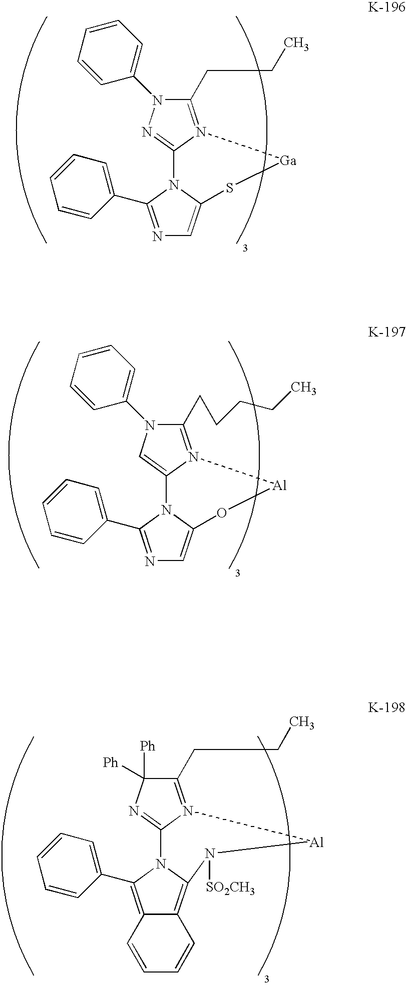

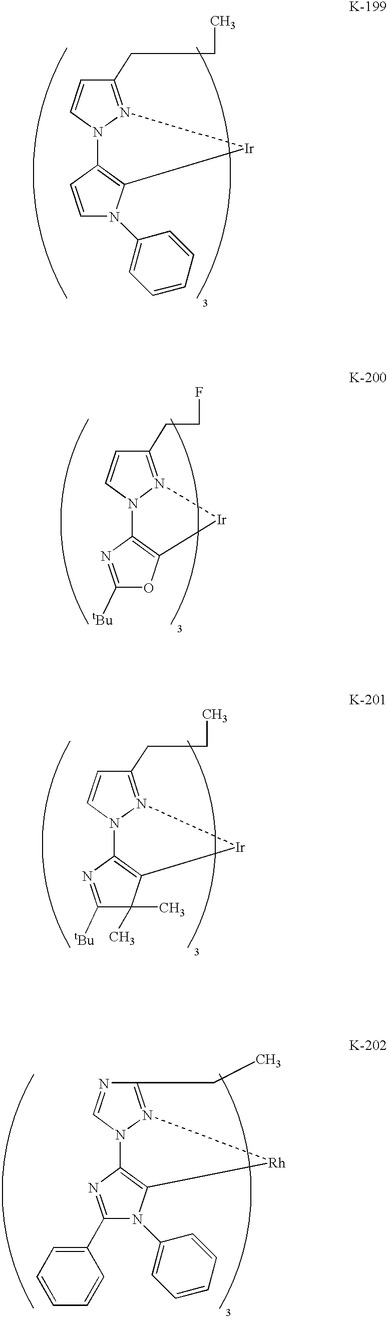

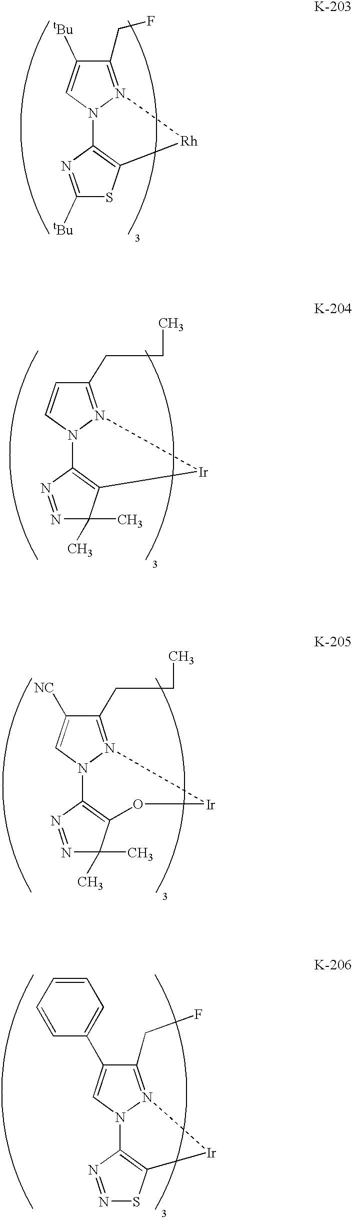

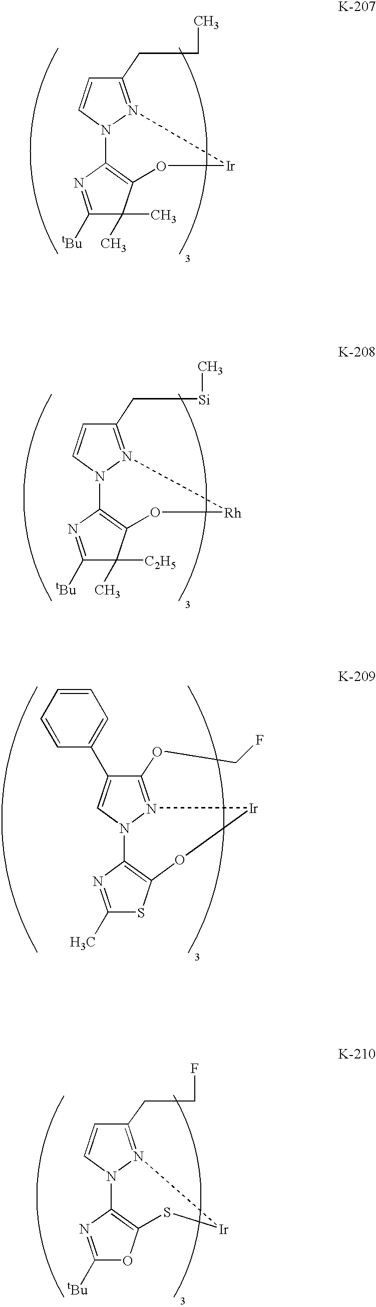

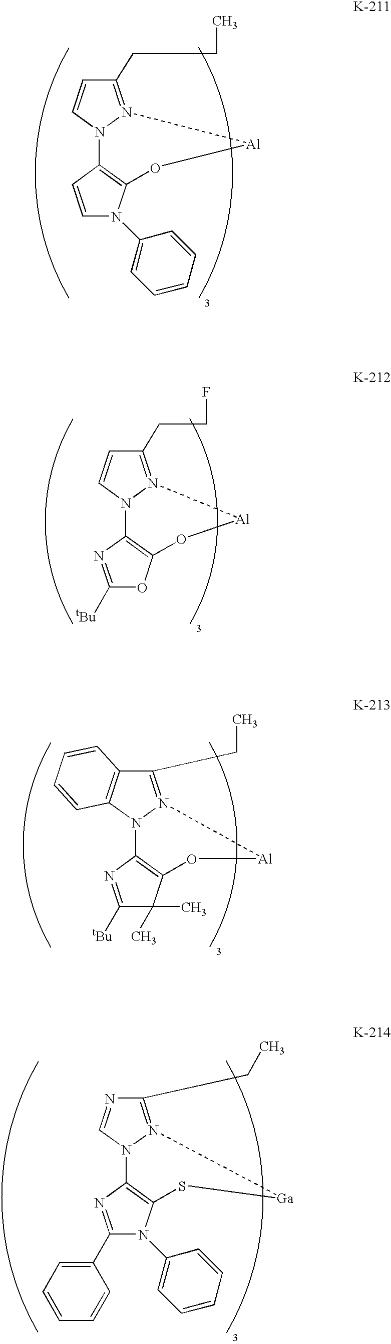

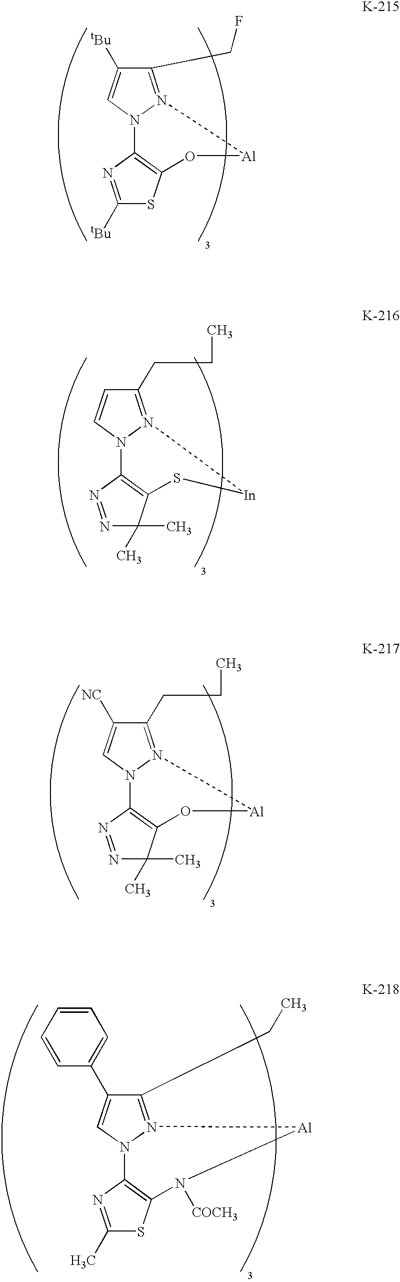

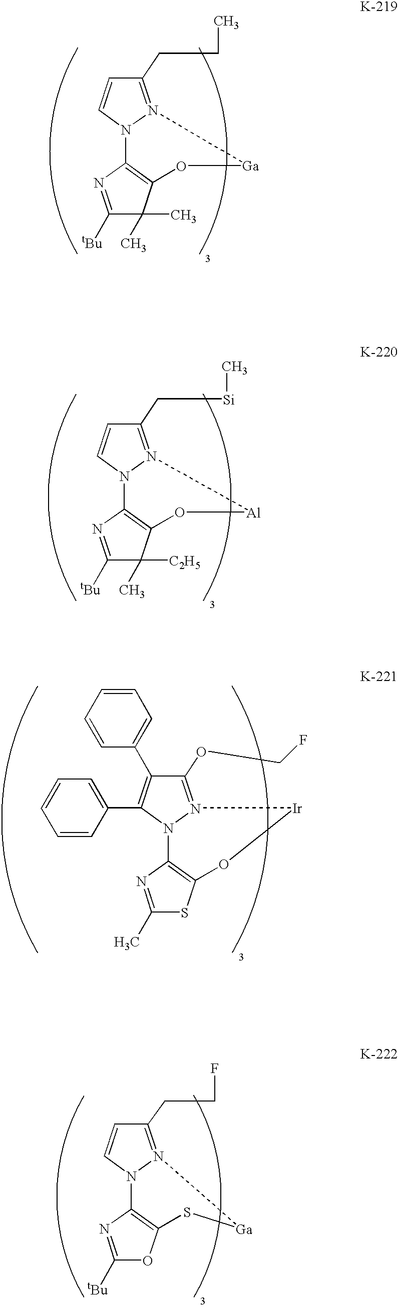

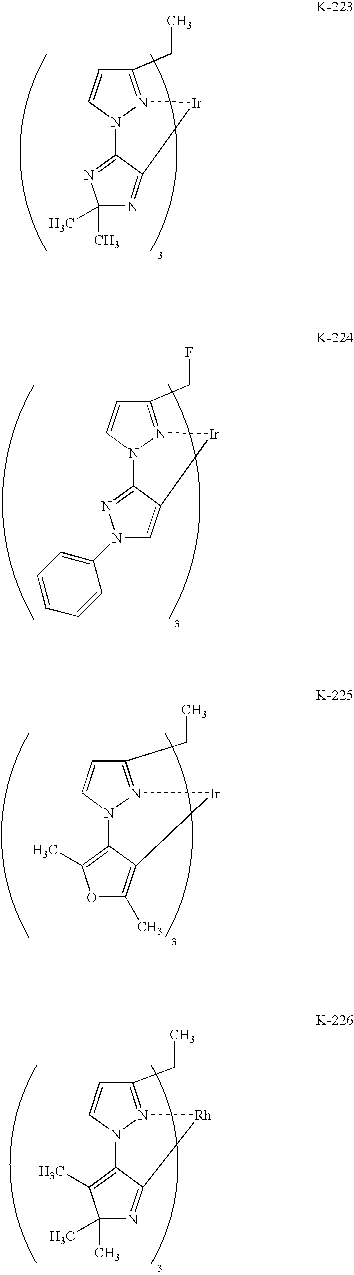

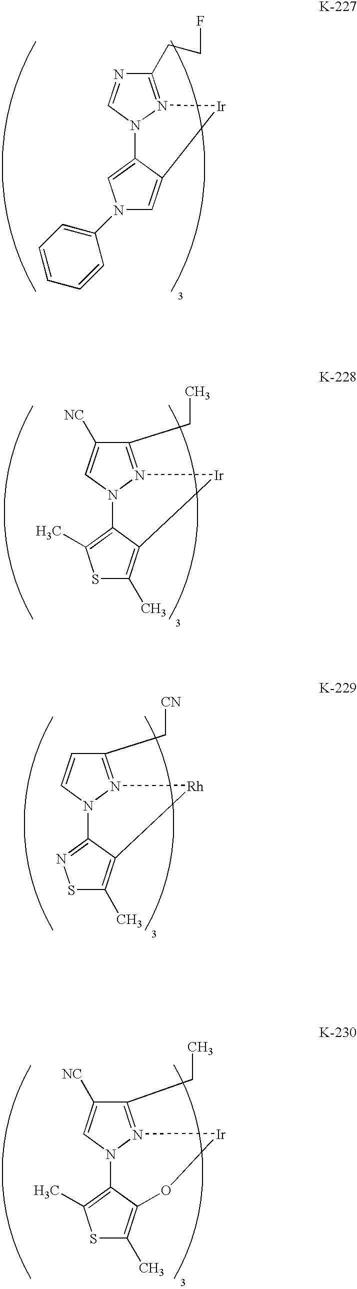

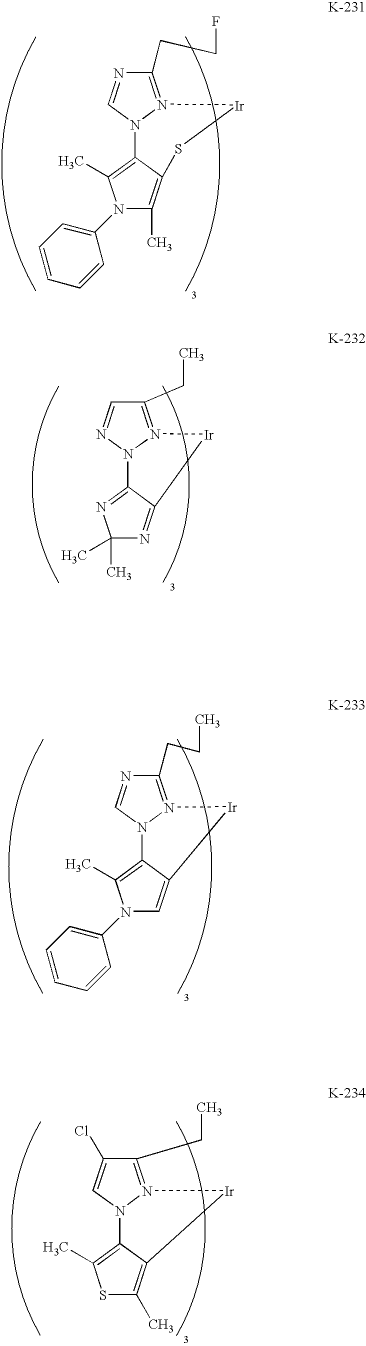

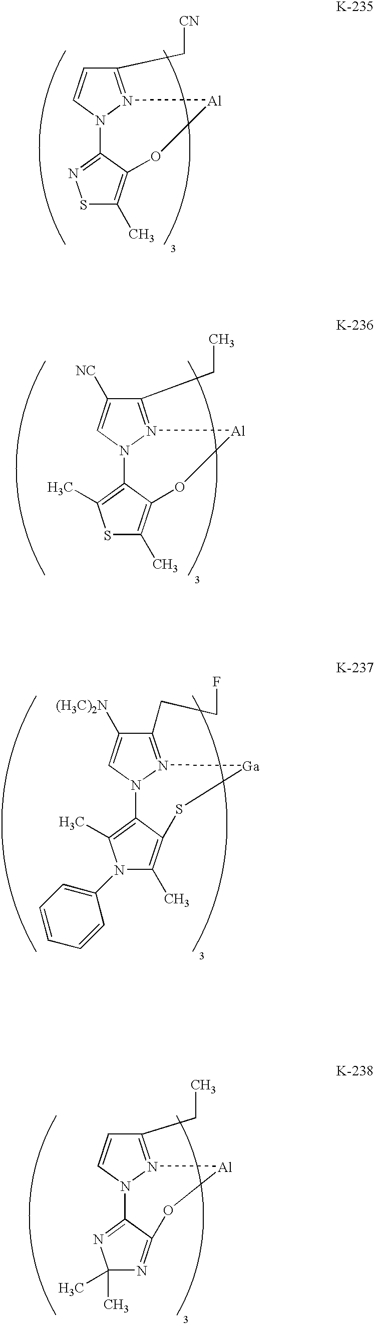

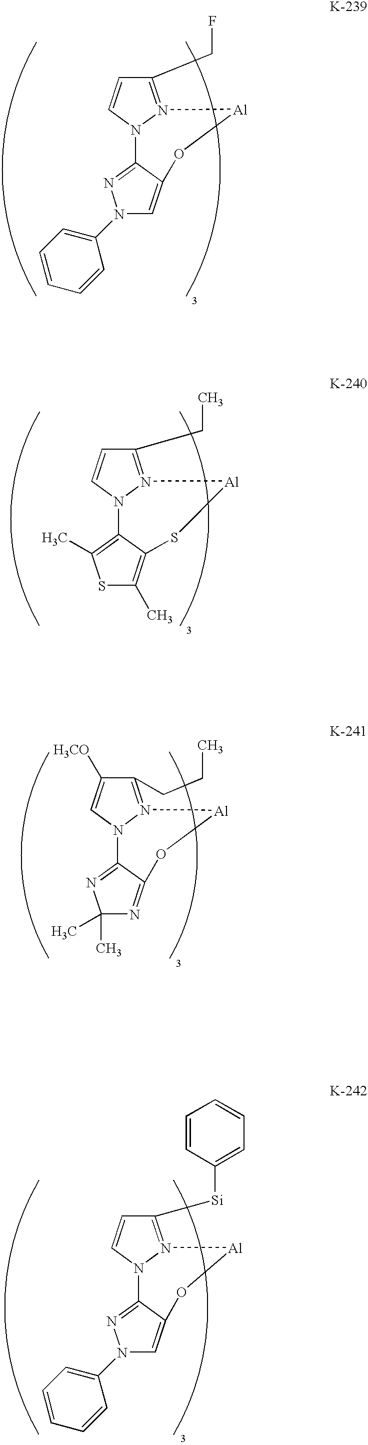

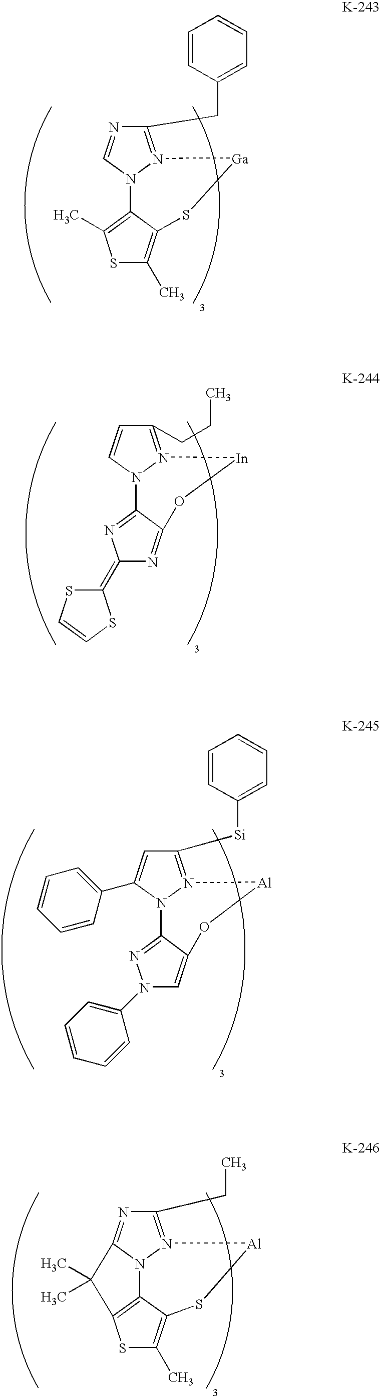

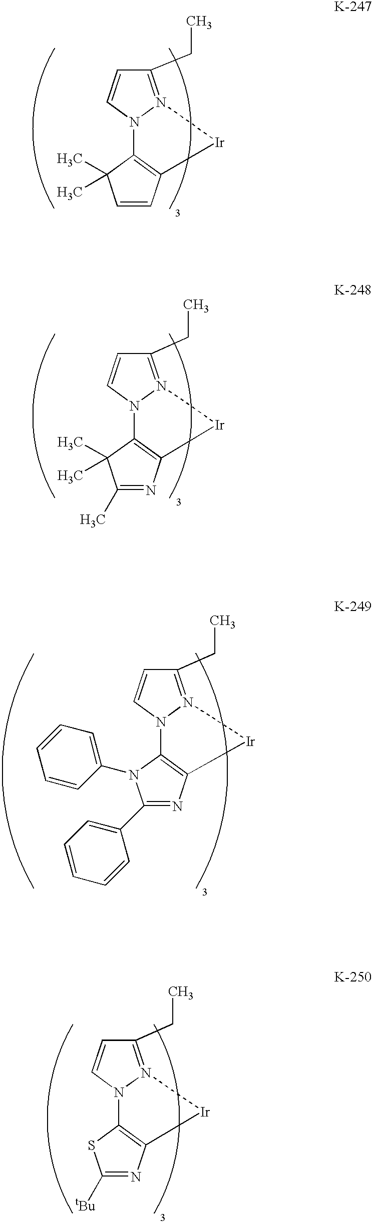

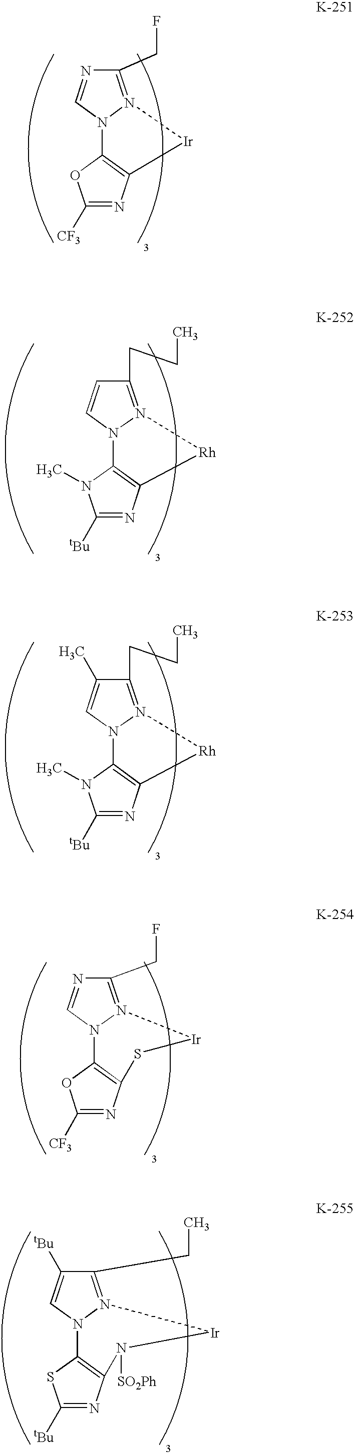

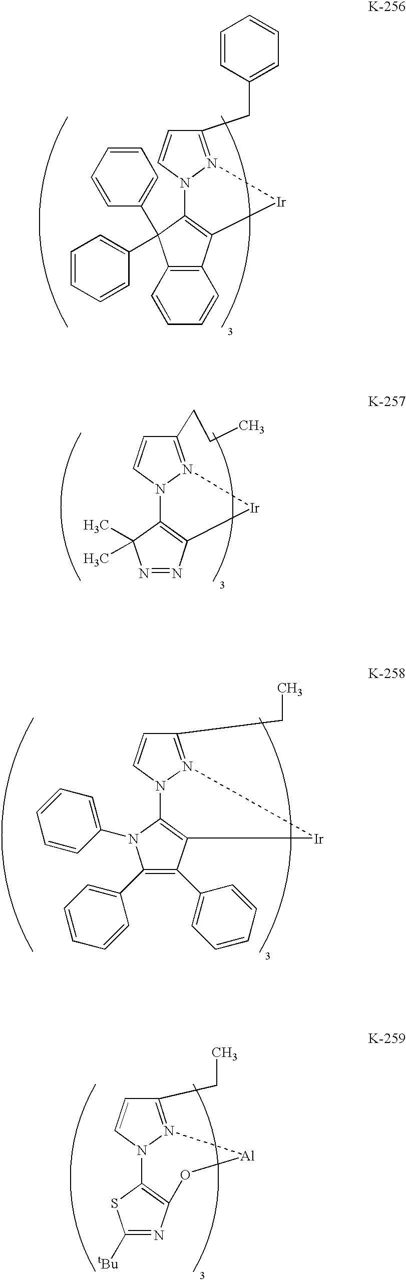

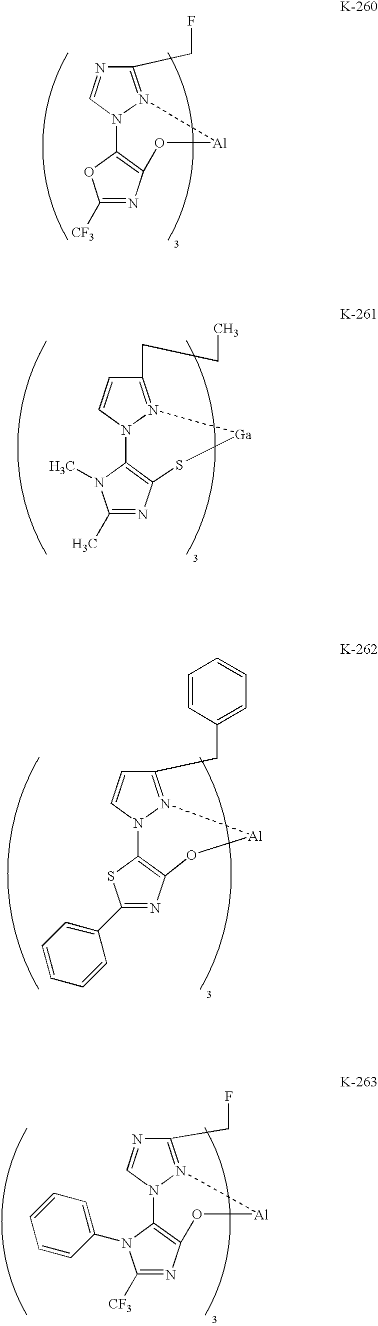

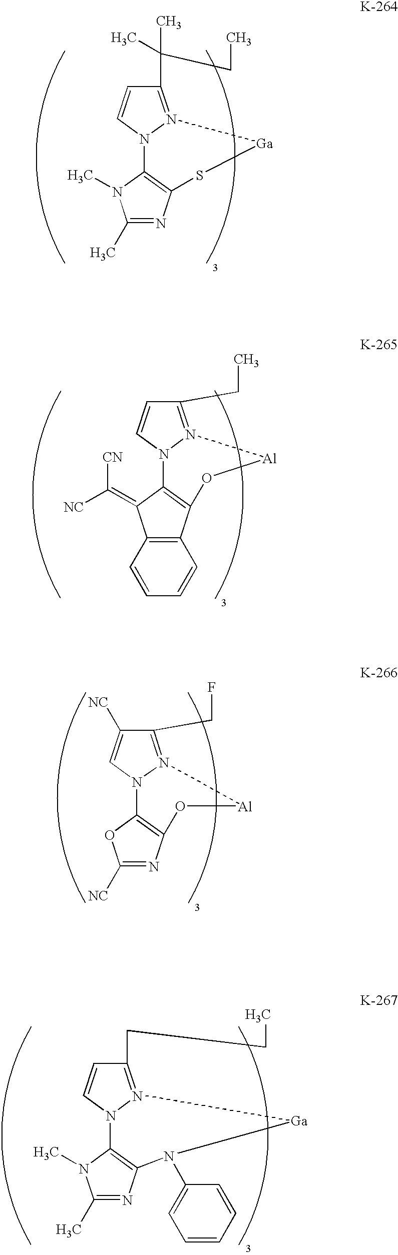

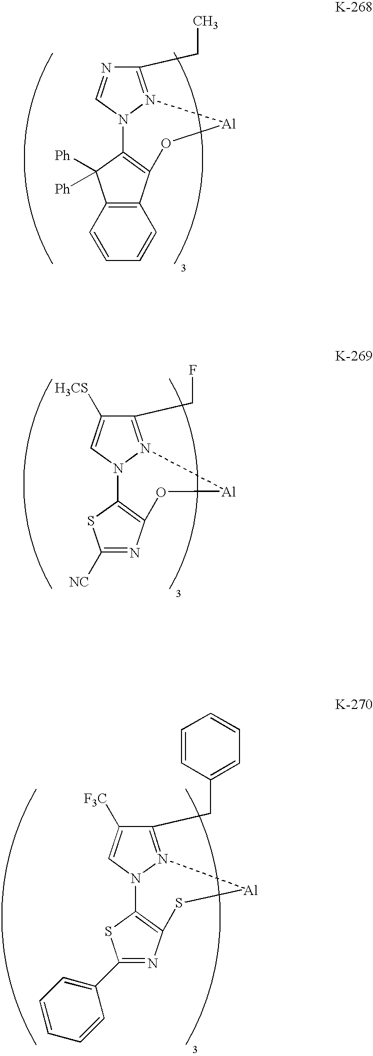

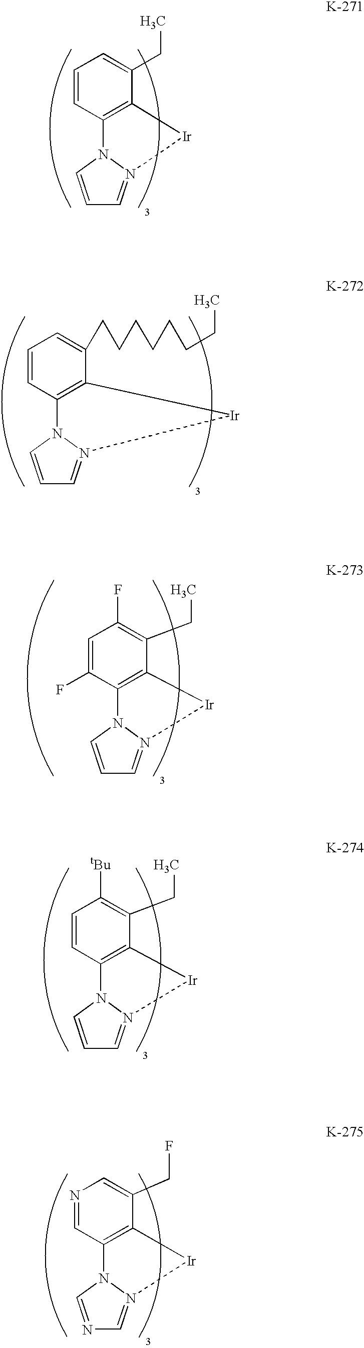

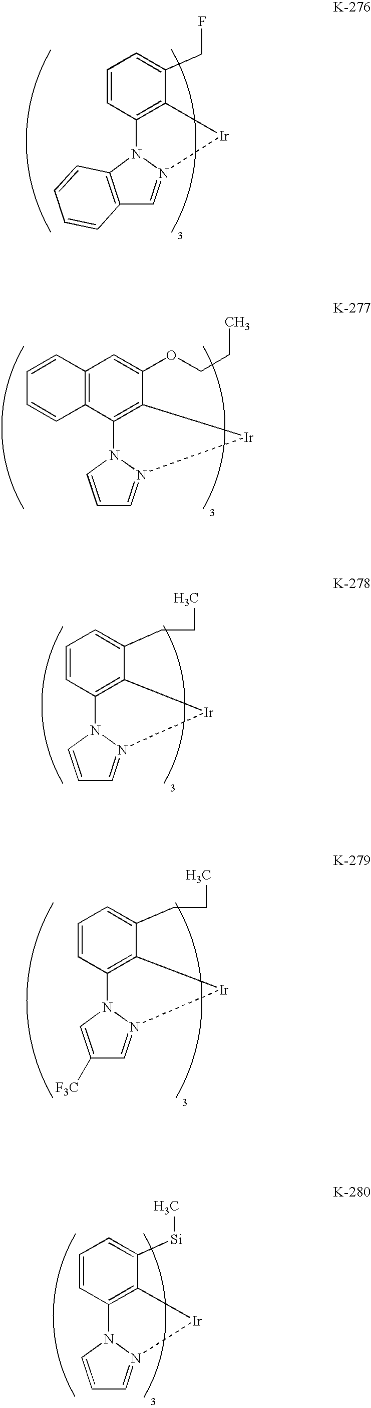

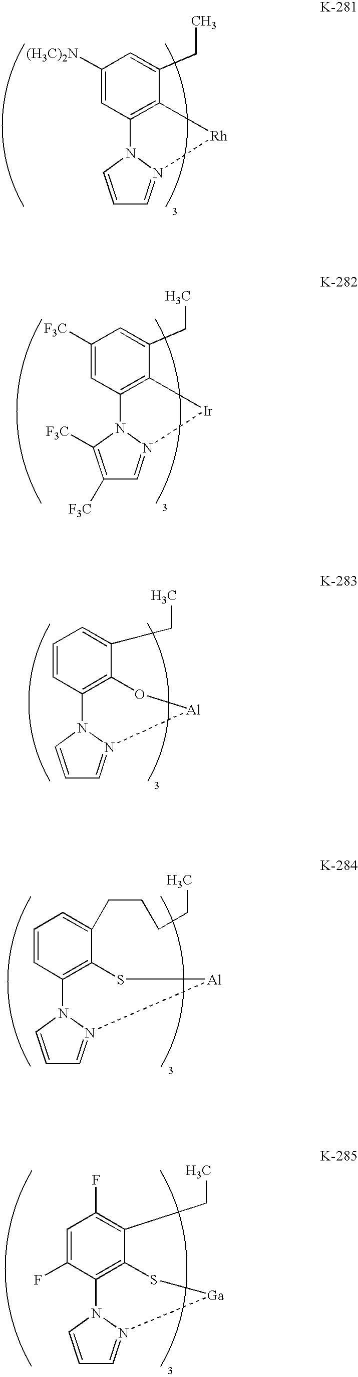

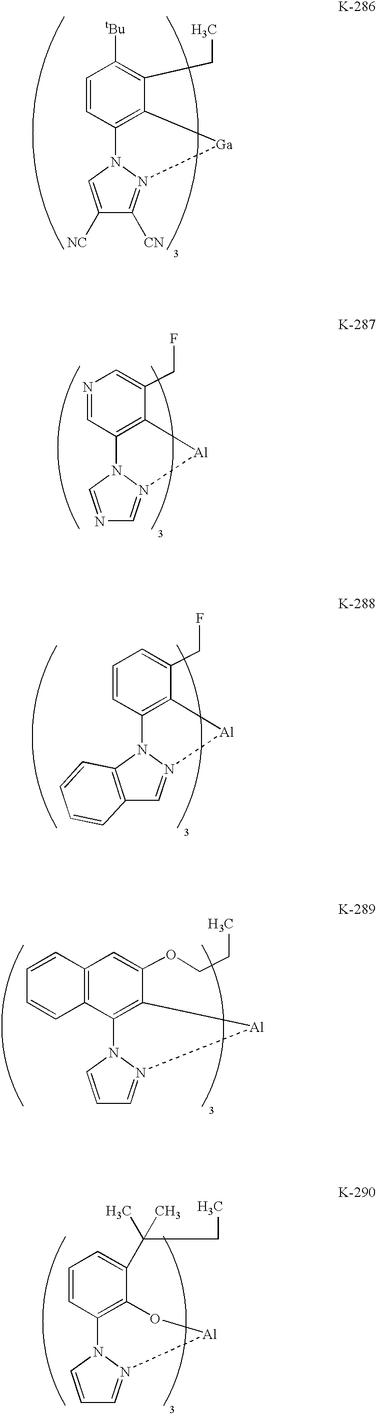

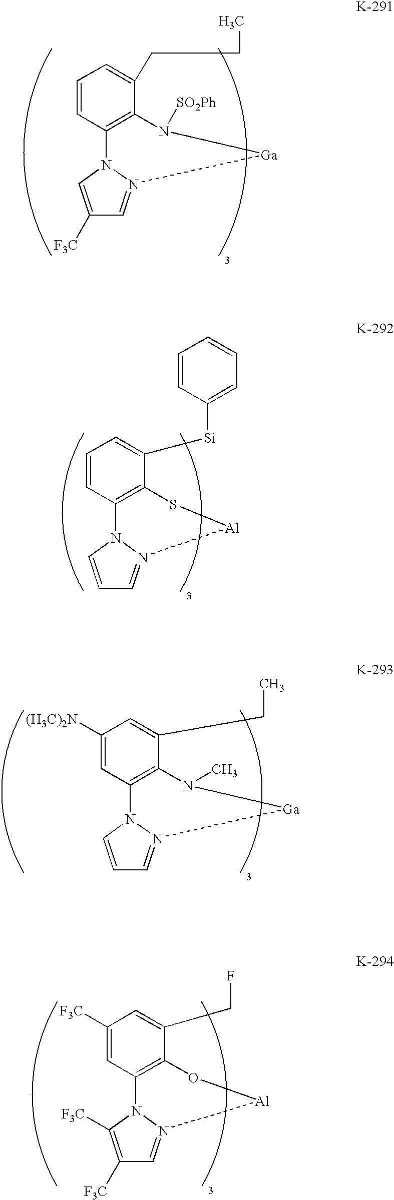

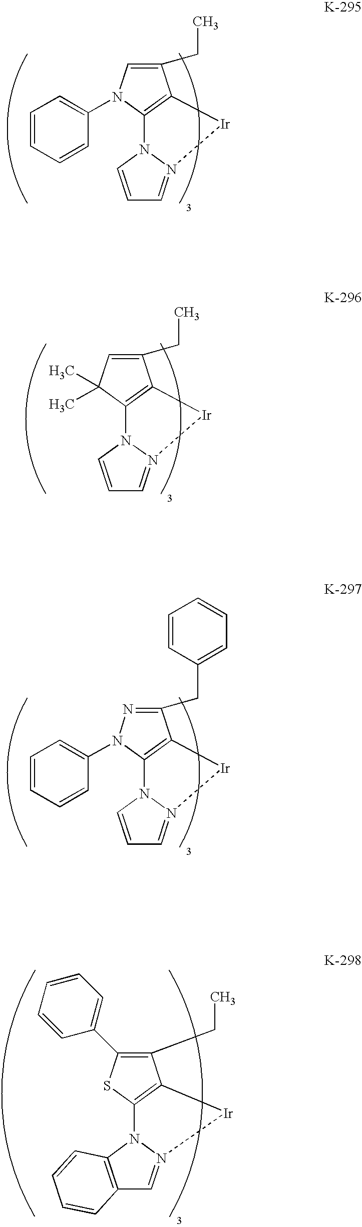

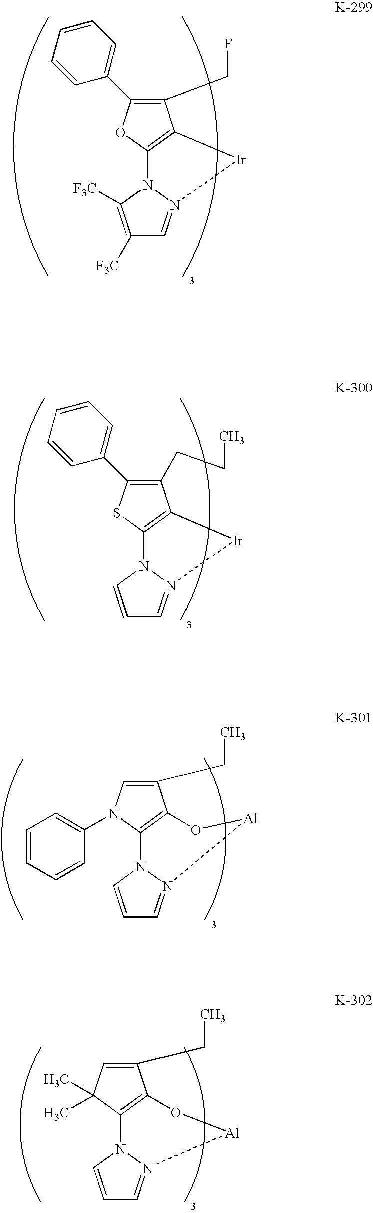

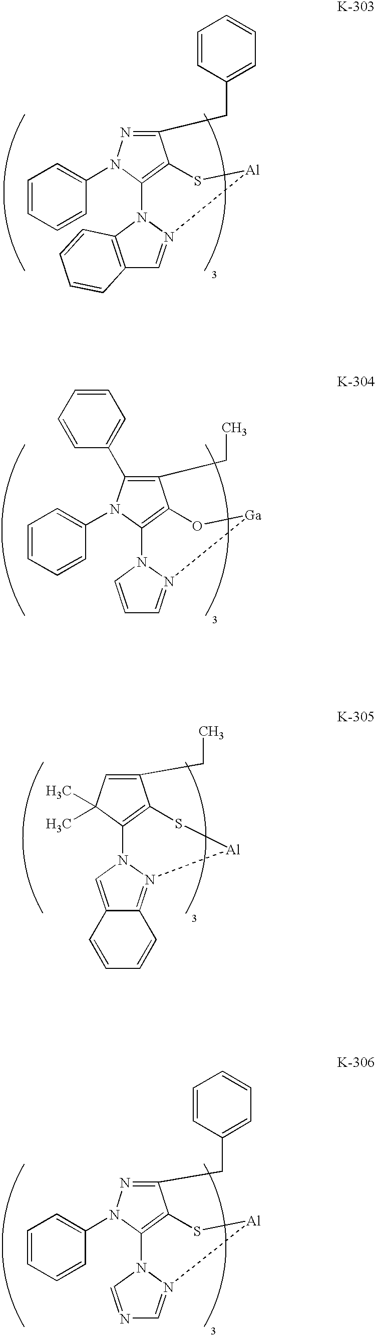

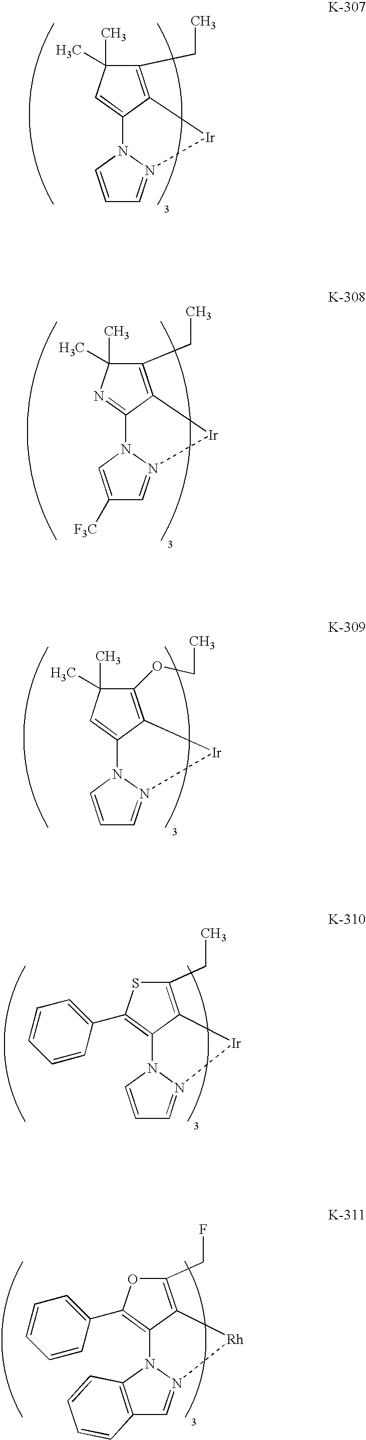

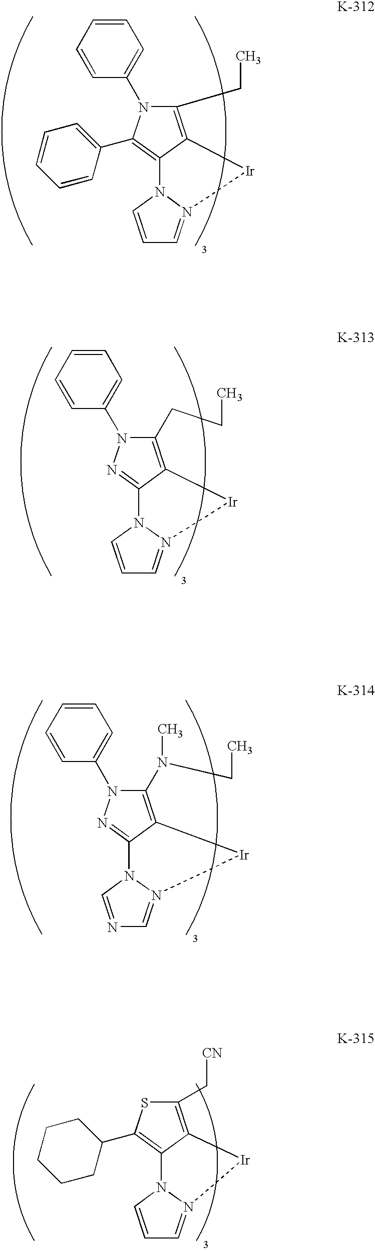

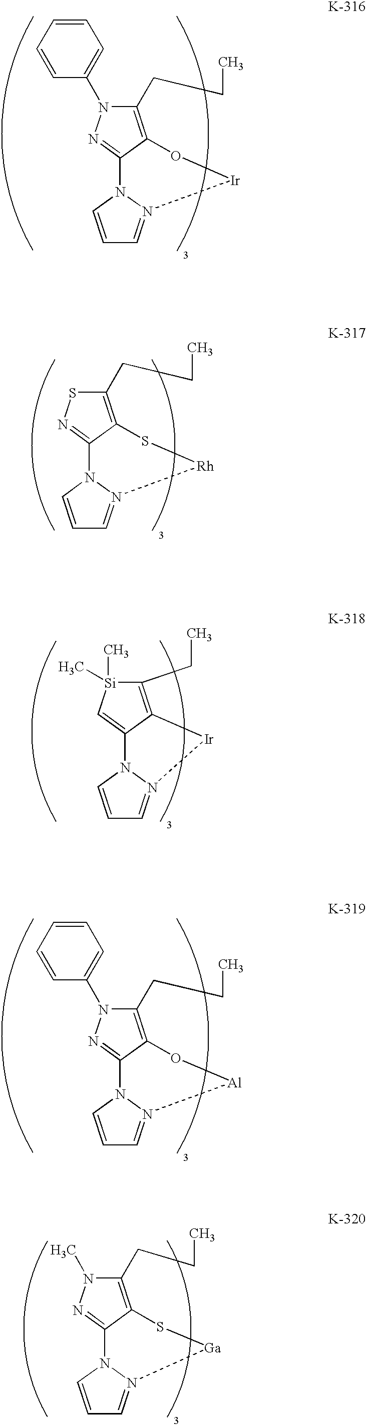

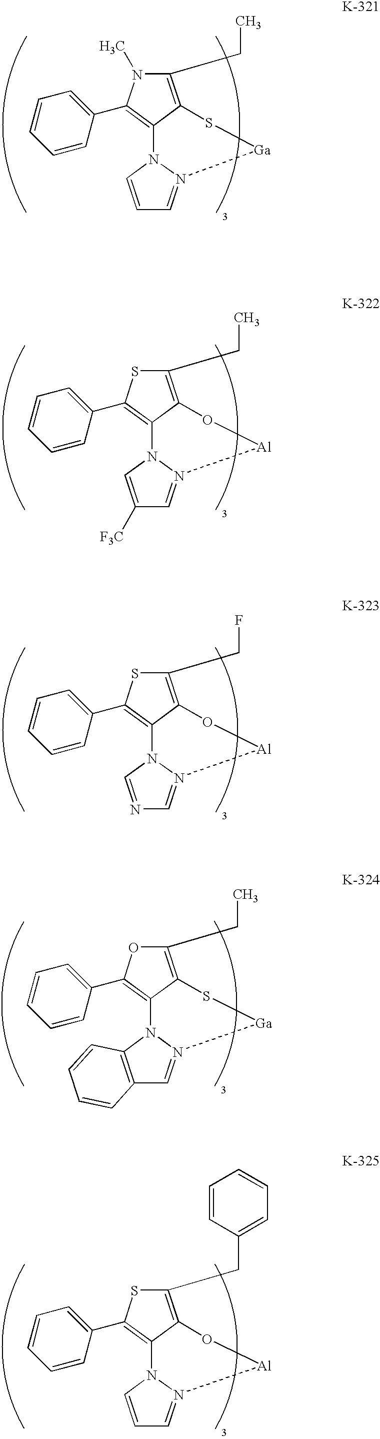

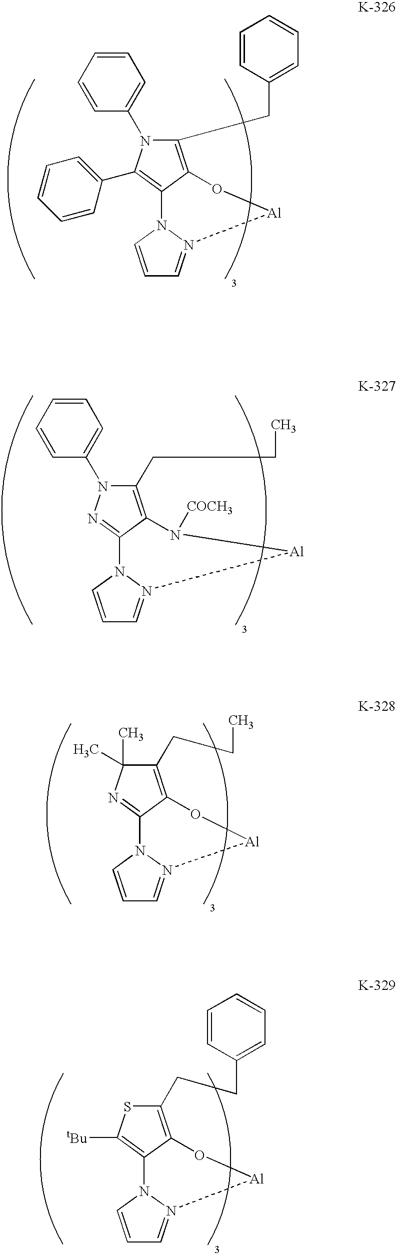

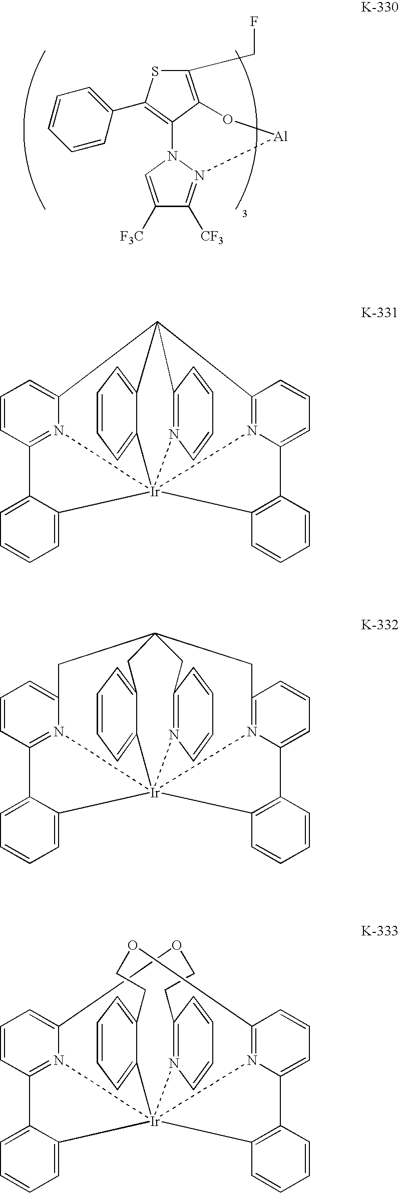

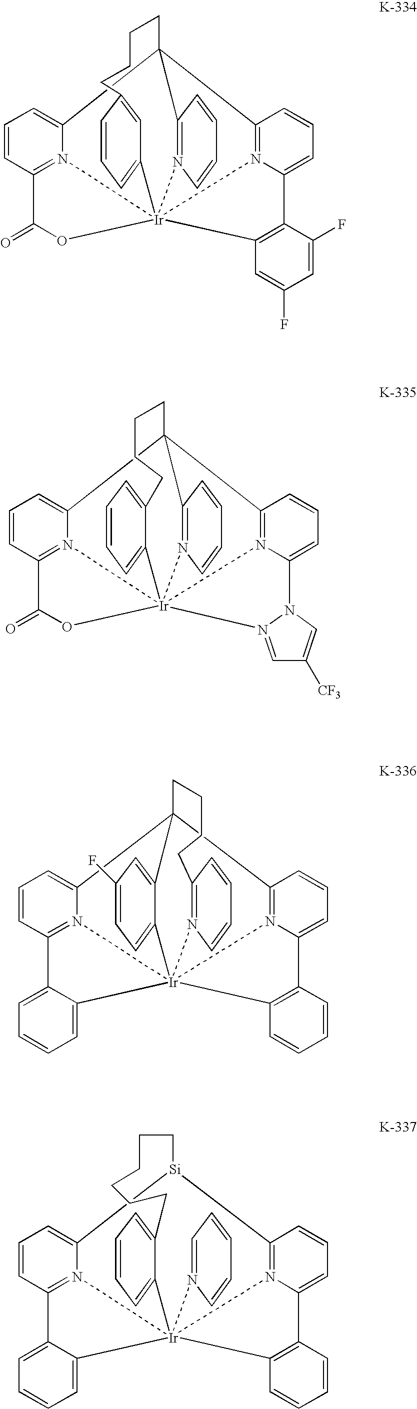

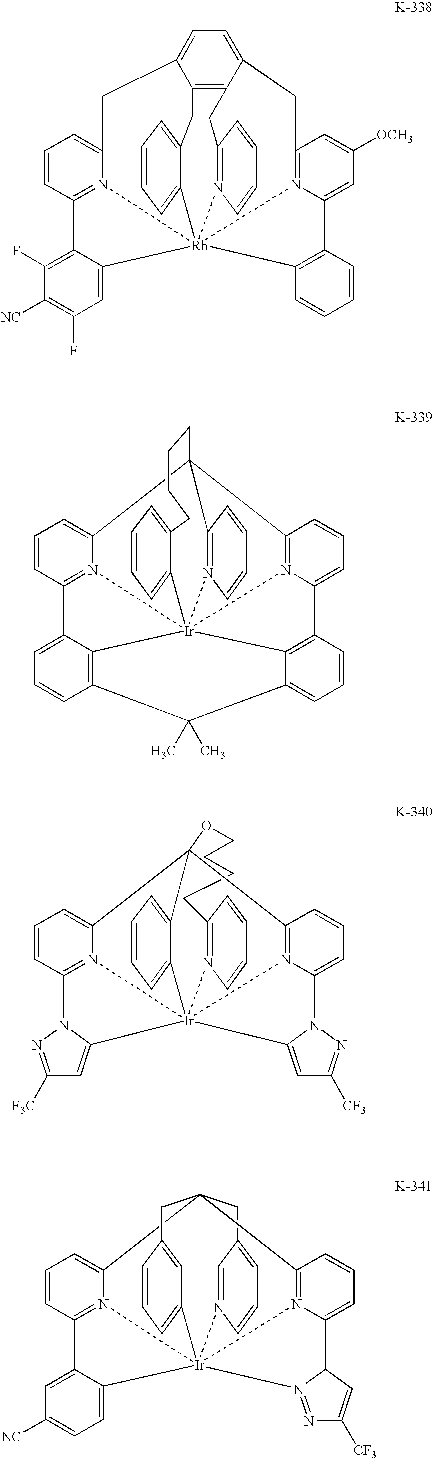

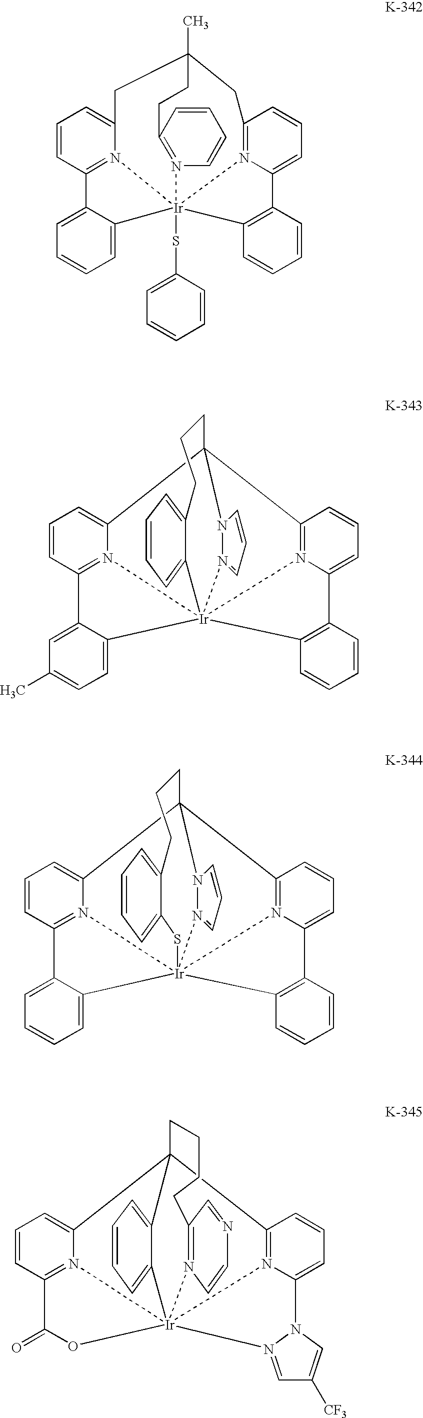

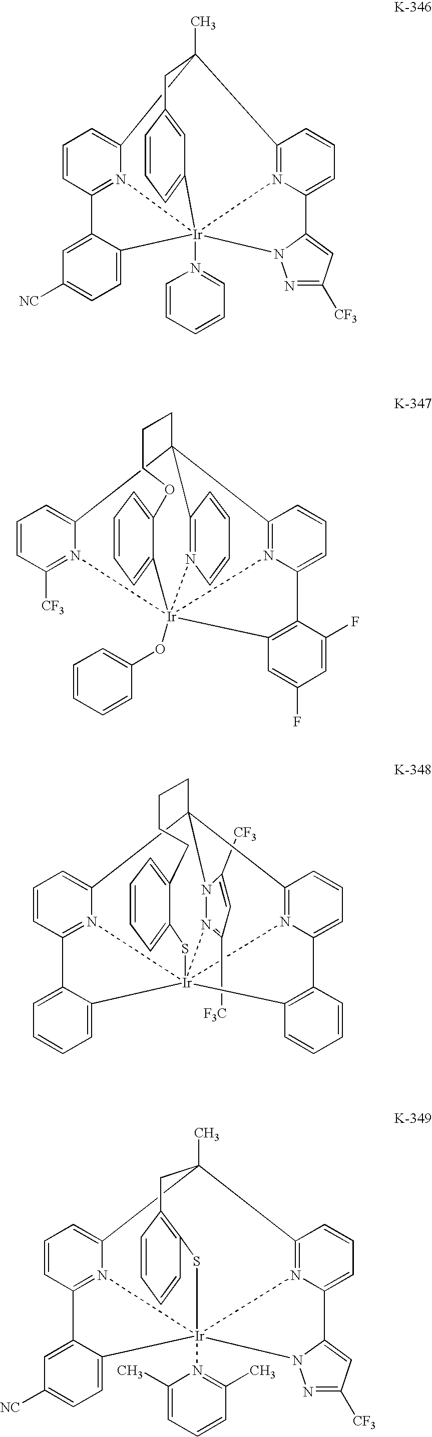

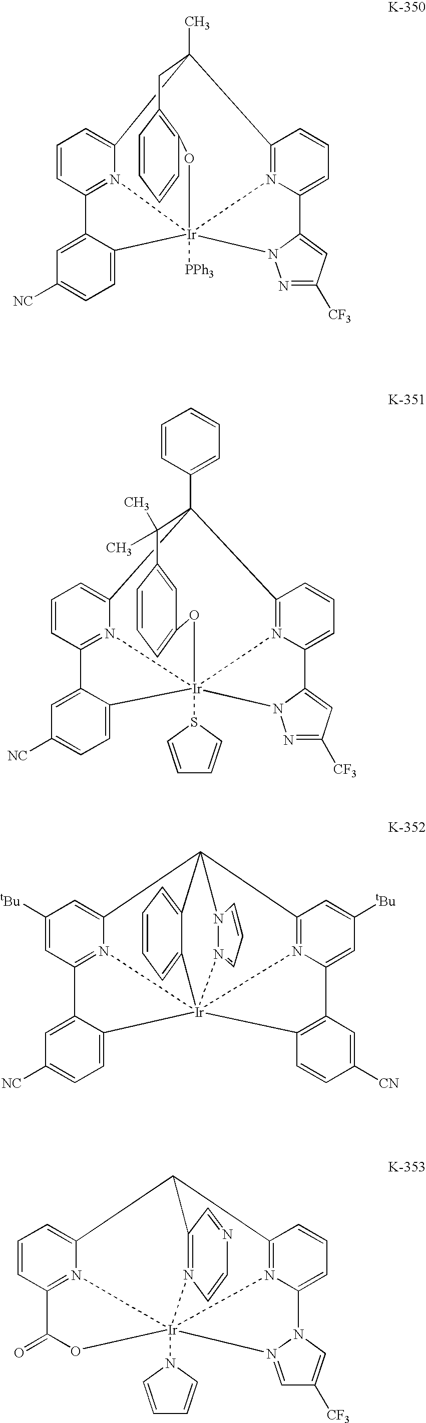

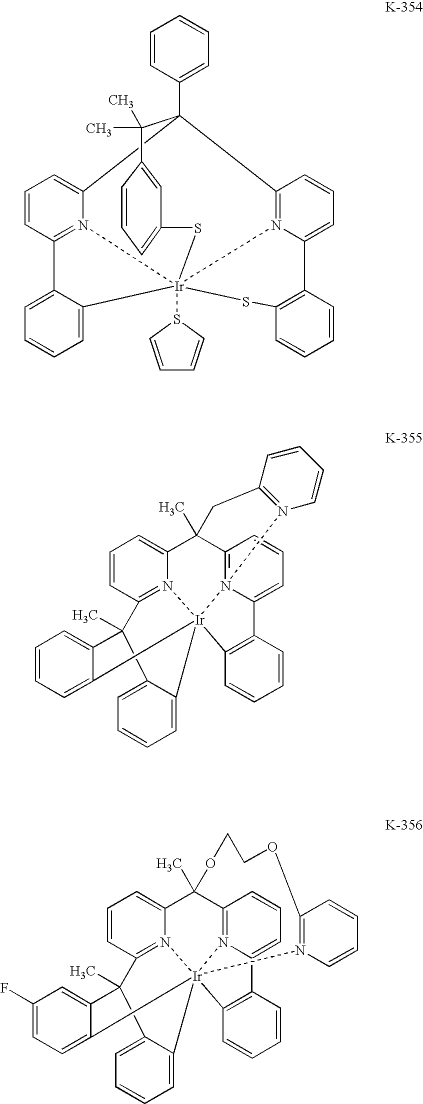

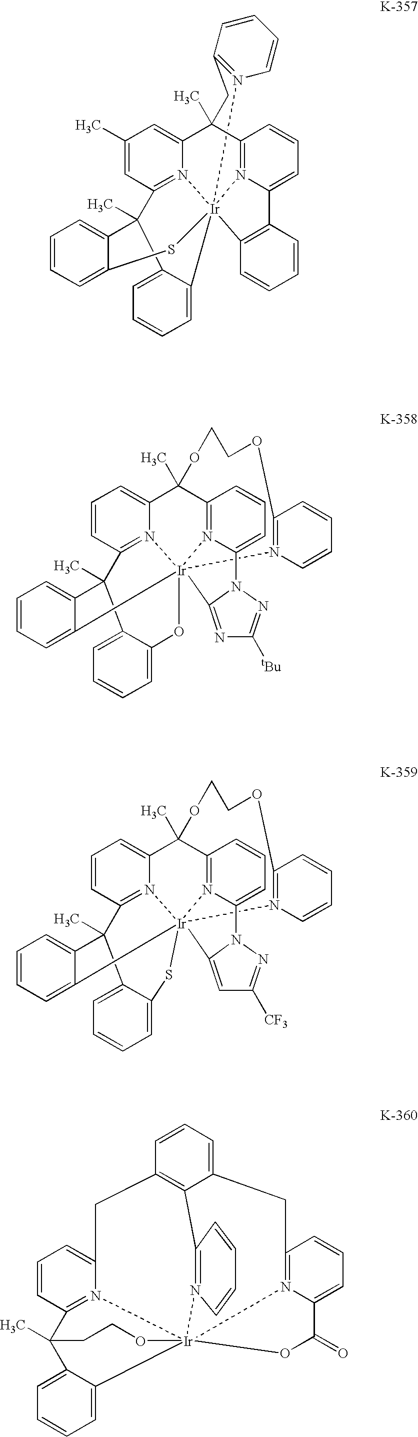

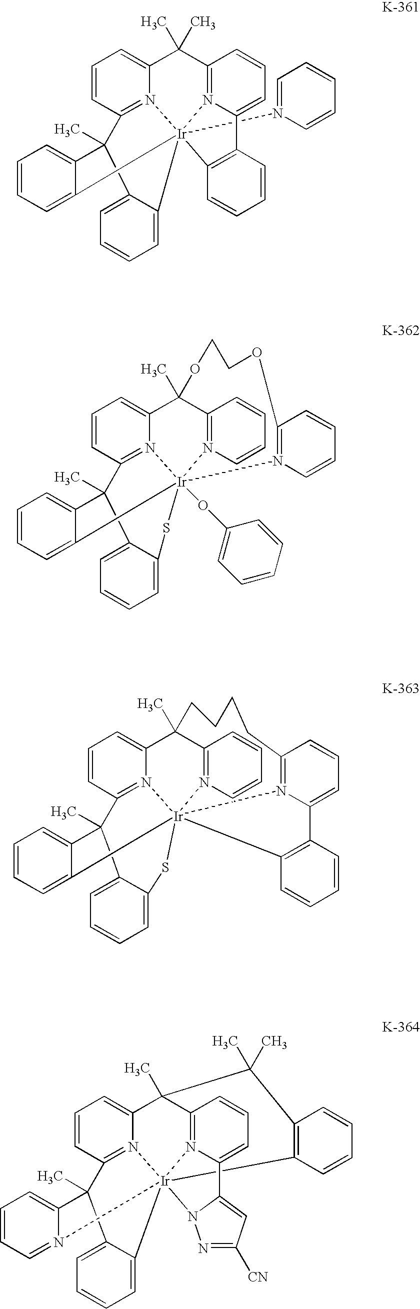

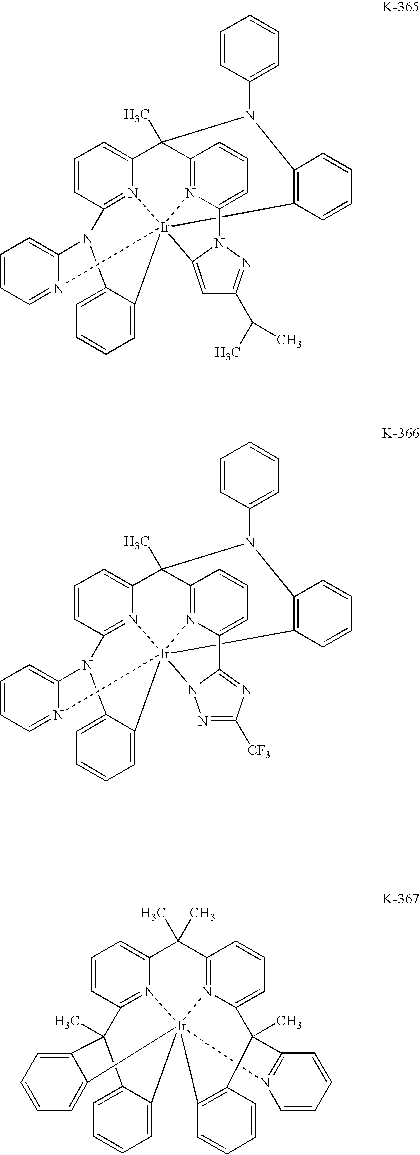

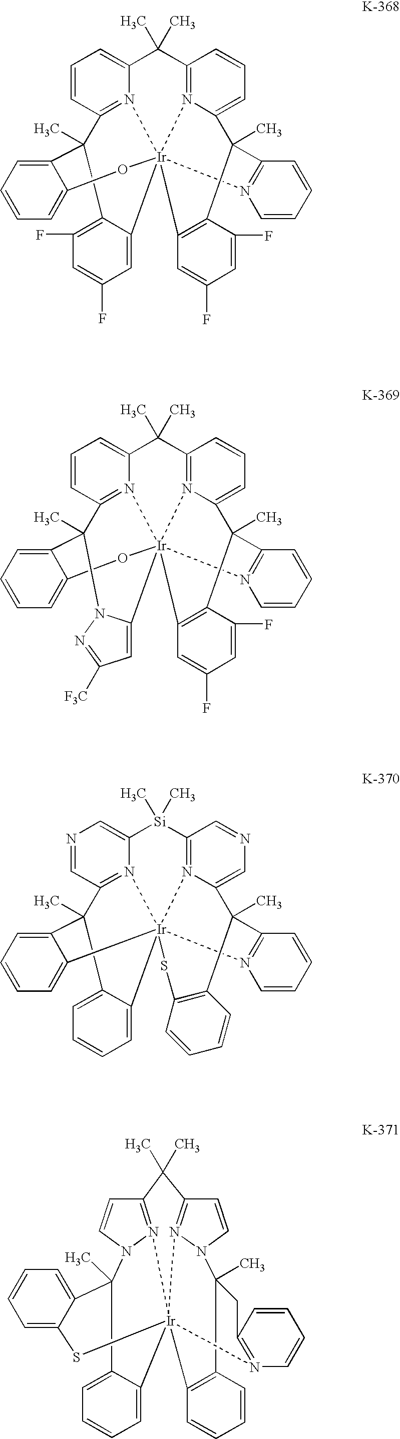

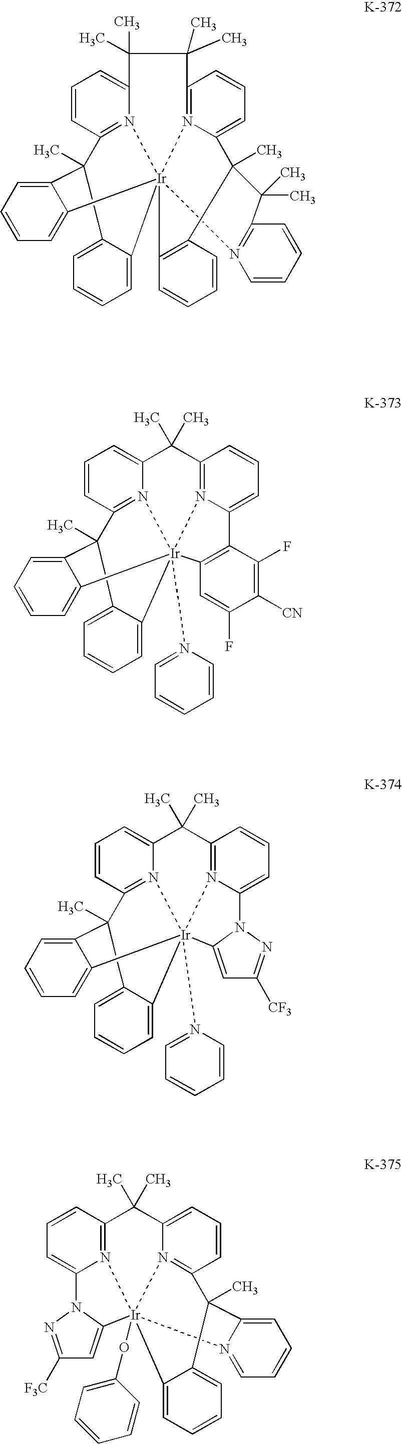

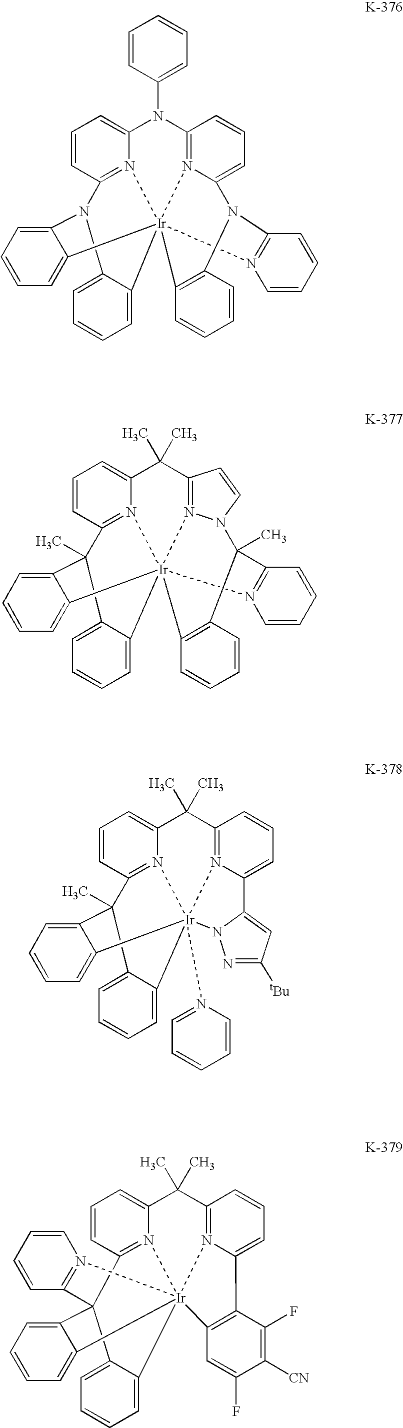

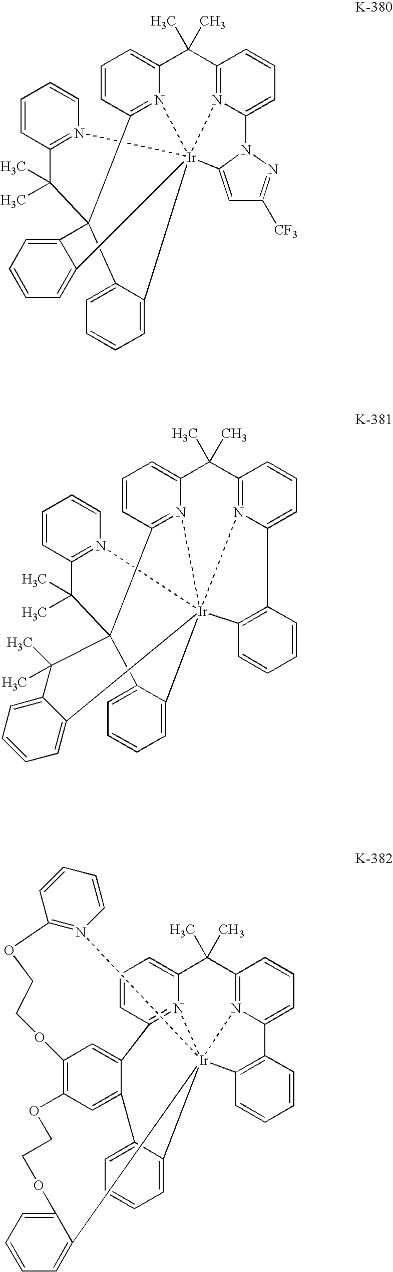

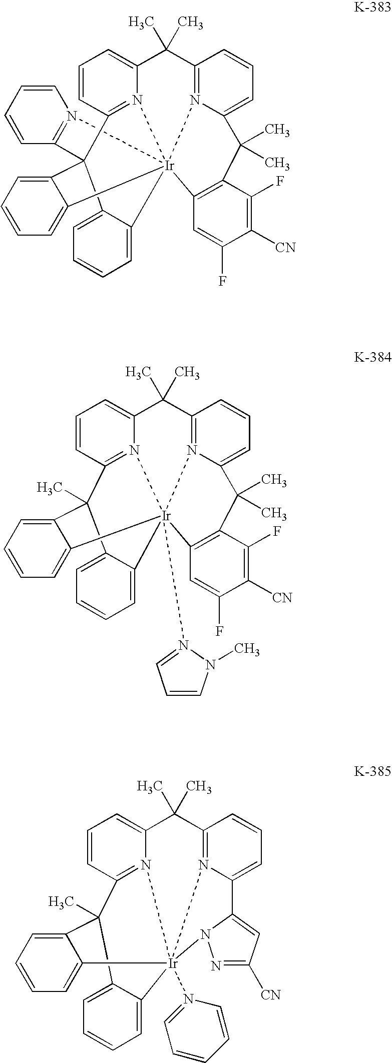

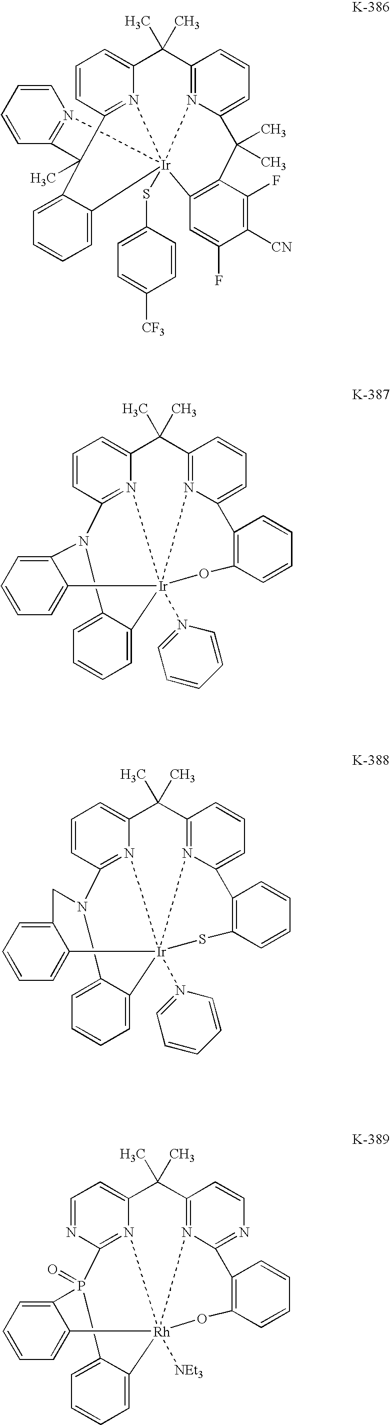

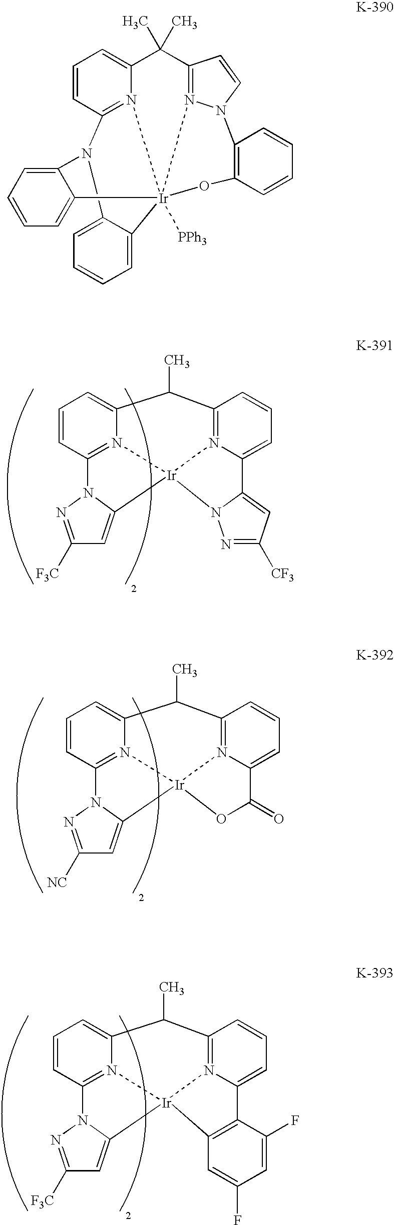

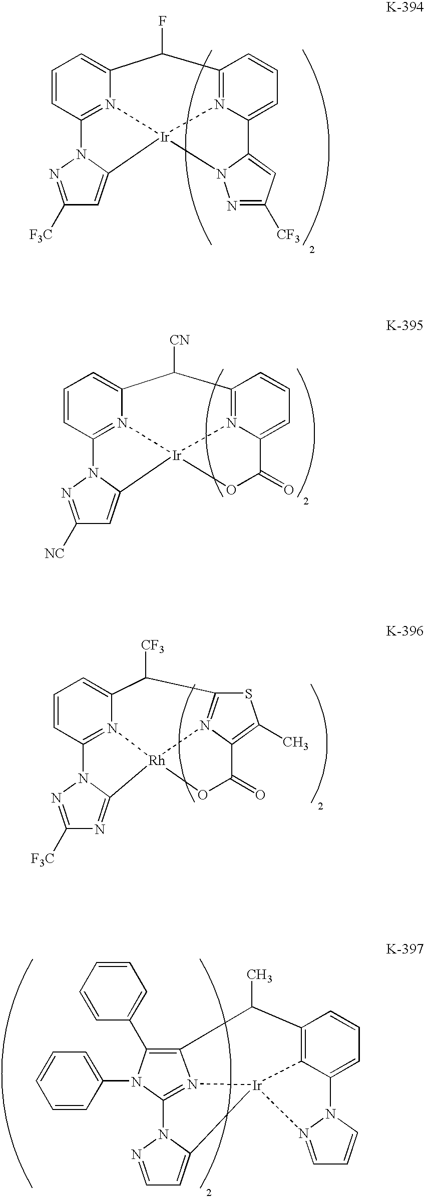

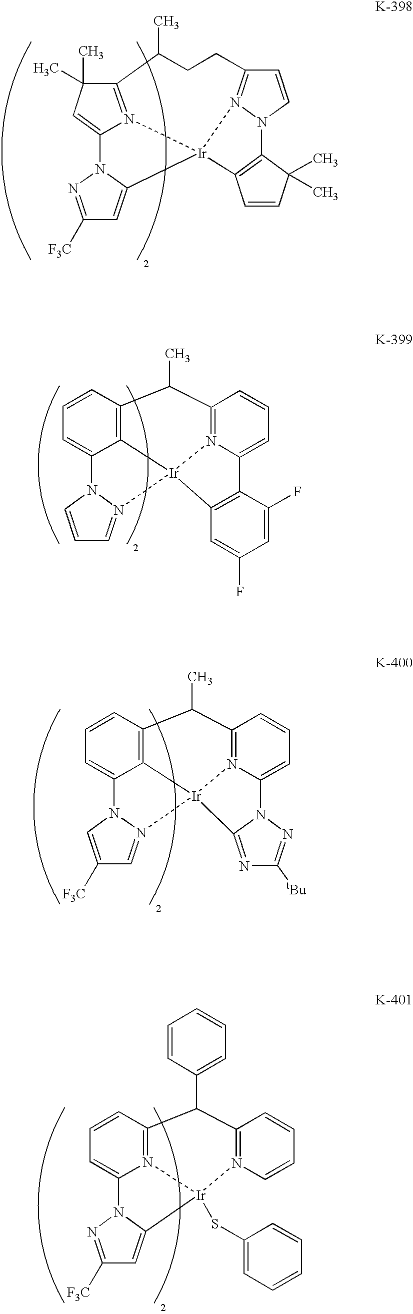

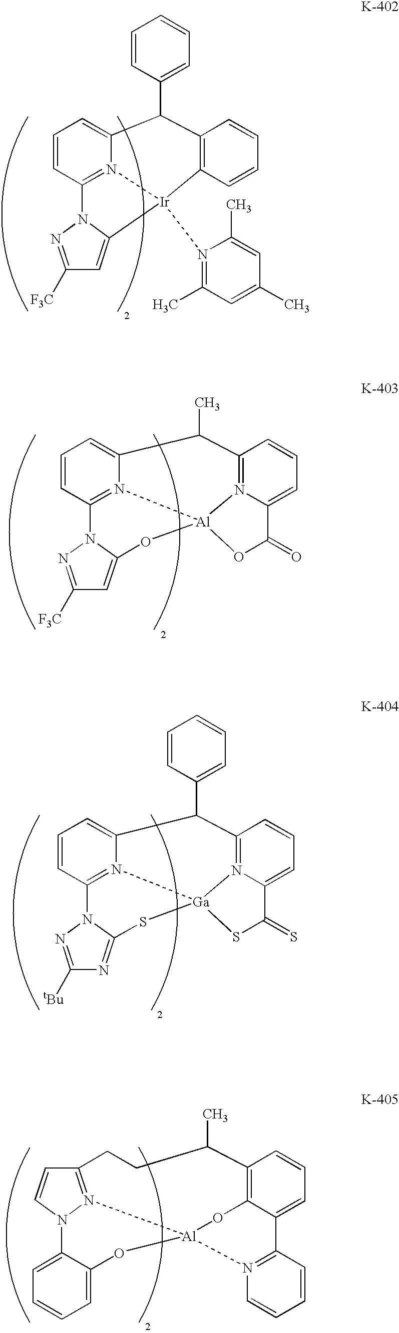

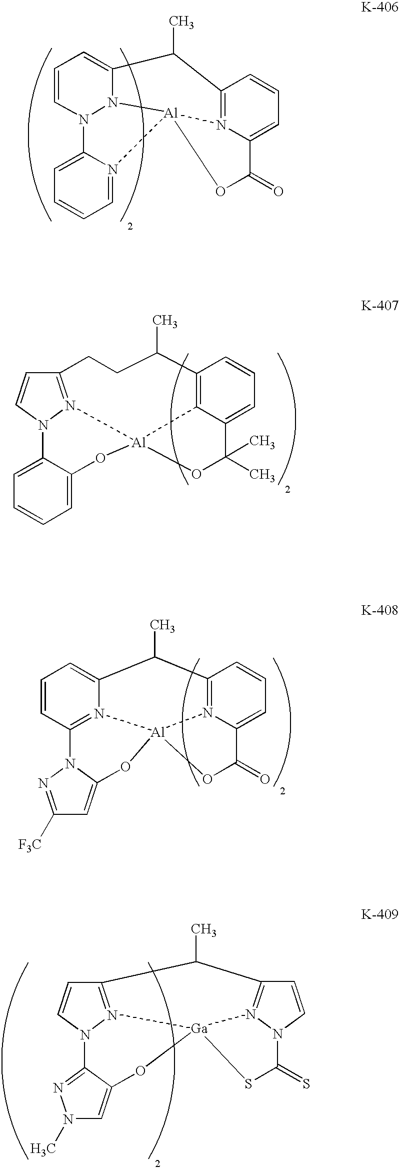

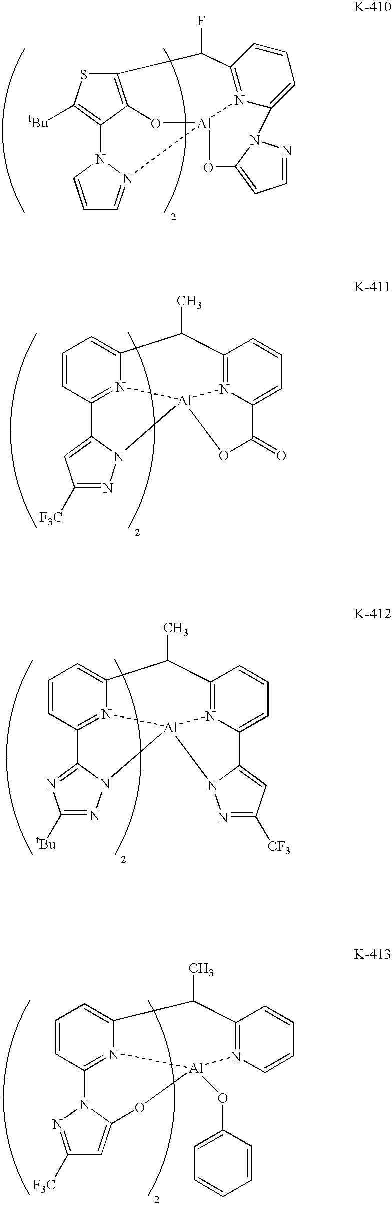

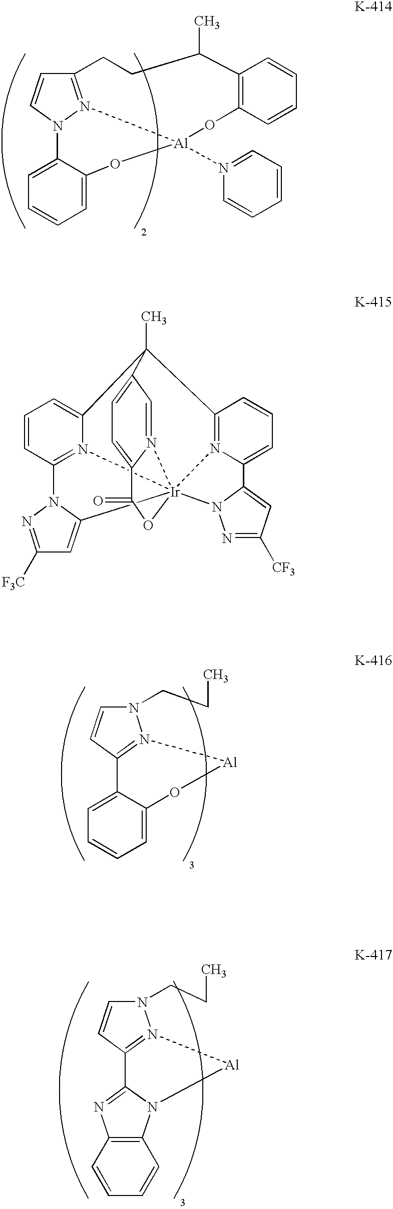

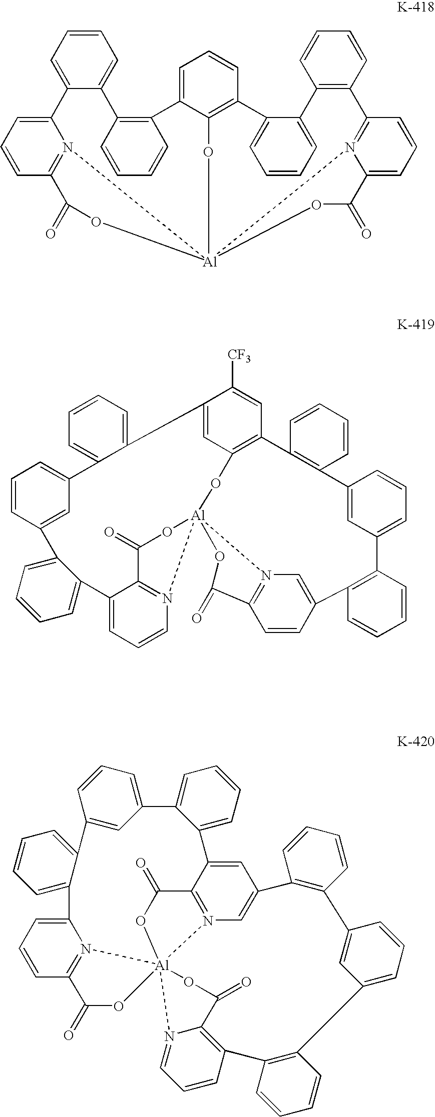

The complex of the invention may be synthesized using, for example, the method described in Journal of Chemical Society, 5008, (1952) or the synthetic methods as will be described below.

For example, the ligand or its dissociated species and a metal compound may be obtained by treating under heating or at ambient temperature without heating (heating measures using a microwave as well as usual heating means are effective) or in the presence of a solvent (e.g., a halogen-based solvent, alcohol-based solvent, ether-based solvent, ester-based solvent, ketone-based solvent, nitrile-based solvent, amide-based solvent, sulfone-based solvent, sulfoxide-based solvent and water) or in the presence of no solvent and in the presence of a base (e.g., various inorganic or organic bases, for example, sodium methoxide, t-butoxy potassium, triethylamine and potassium carbonate) or in the presence of no base.

The reaction time required when the complex of the invention is synthesized is preferably 1 minute or more and 5 days or less, more preferably 5 minutes or more and 3 days or less and still more preferably 10 minutes or more and 1 day or less, though it differs depending on the activity of the reaction and there is no particular limitation is imposed on it.

The reaction temperature when the complex of the invention is synthesized is preferably 0° C. or higher and 300° C. or lower, more preferably 5° C. or higher and 250° C. or lower and still more preferably 10° C. or higher and 200° C. or lower, though it differs depending on the activity of the reaction and there is no particular limitation is imposed on it.

The complex of the invention may be synthesized by adding the ligand constituting the partial structure of the complex to be intended in an amount of 0.1 equivalents to 20 equivalents, more preferably 0.3 equivalents to 10 equivalents and still more preferably 0.5 equivalents to 6 equivalents based on the metal compound. Examples of the metal compound include metal halide compounds (e.g., platinum chloride), metal acetates (e.g., palladium acetate), metal acetylacetonates (e.g., europium acetylacetonate) or hydrates of these compounds.

Next, typical methods of synthesizing the complex of the invention will be explained taking the synthesis of a complex with a hexadentate ligand as an example.

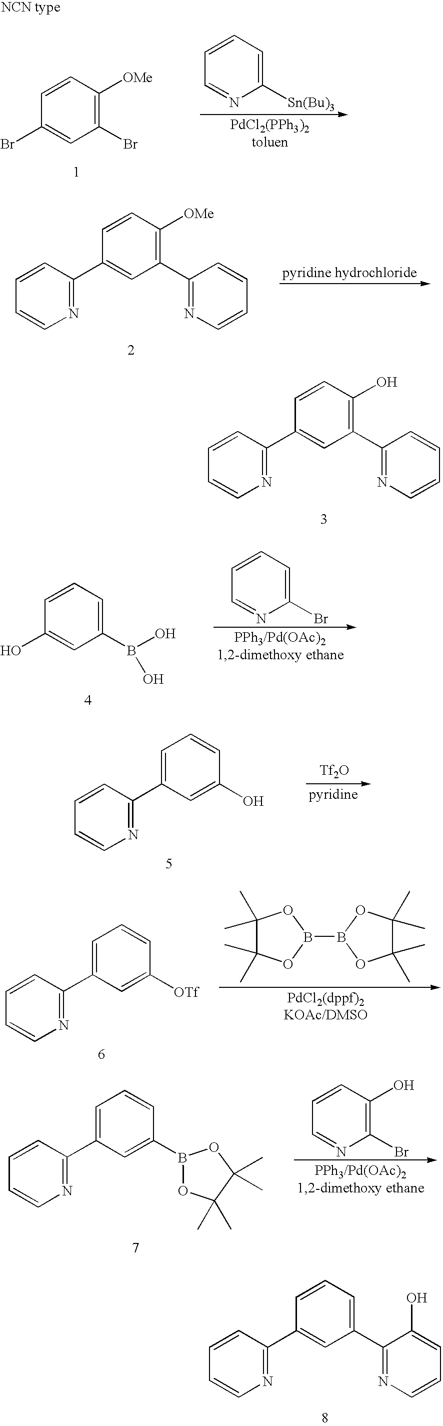

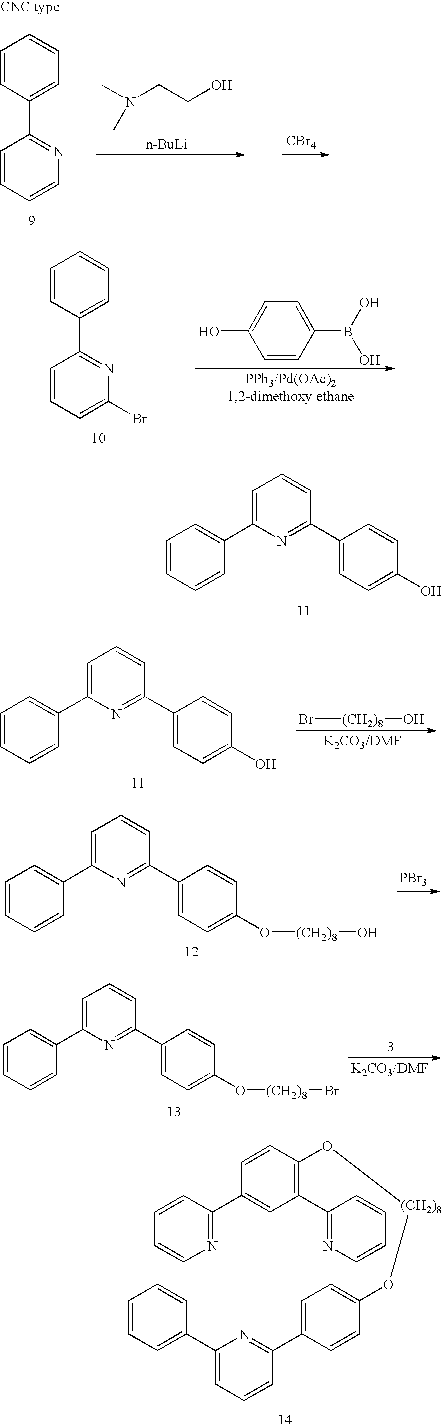

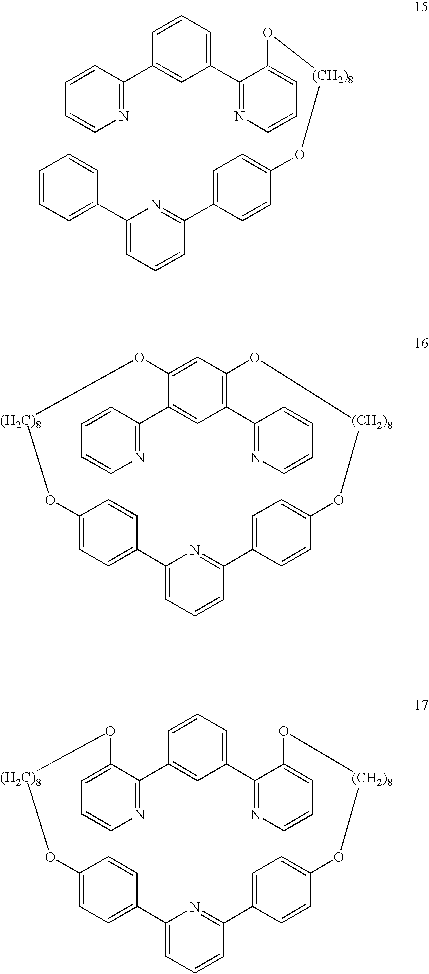

The above hexadentate ligand (compounds 14 to 17 in the above scheme) may be synthesized by combining a tridentate ligand with another tridentate ligand.

For example, a 1,3-bis-(2-pyridyl)benzene derivative (3) having connecting groups on a benzene ring may be synthesized in the following manner: using a 1,3-dibromobenzene derivative (1) and 2-(trialkylstannyl)pyridine as starting materials, a Stille coupling reaction is carried out and a methyl group is removed (using the method as described in Journal of Organic Chemistry, 741, 11, (1946) or a method of heating in a pyridine hydrochloride).

A 1,3-bis(2-pyridyl)benzene derivative (8) having connecting groups on a pyridine ring may be synthesized in the following manner: using 3-hydroxyphenylboronic acid as starting material, a Suzuki coupling reaction between the boronic acid and 2-bromopyridine is run, and the reaction mixture is then reacted with trifluoromethanesulfonic acid anhydride in the presence of a base to convert a hydroxyl group into a triflate (6), which is then coupling-reacted (according to the method described in Journal of Organic Chemistry, 60, 7508 (1995)) with bispinacolborane to obtain a 3-(2-pyridyl)phenylboronic acid derivative (7), followed by running a Suzuki coupling reaction between the acid derivative (7) with 2-bromo-3-hydroxypyridine.

A 2,6-biphenylpyridine derivative (11) having connecting parts on a benzene ring may be synthesized in the following manner: 2-phenylpyridine (9) is treated using dimethylaminoethanol/n-butyl lithium to substitute the a -position with a lithio group and then reacted with carbon tetrabromide to make 2-bromo-6-phenylpyridine (10), which is then blended with 4-hydroxyphenylboronic acid to run a Suzuki coupling reaction.

Tridentate ligands, which differ in the type and number of substituent and in the substitution position of the substituent may be synthesized by using the above method.

A hexadentate ligand (14) may be synthesized in the following manner: the tridentate ligand (11) is reacted with halo-alcohols (e.g., 8-bromooctanol) in the presence of base (e.g., potassium carbonate, sodium carbonate, pyridine or triethylamilne) to make a compound (12), the hydroxyl group of which is then brominated by phosphorous tribromide and the brominated compound (12) is coupling-reacted (ether bond introducing reaction in the presence of a base) with the tridentate ligand (3).

Hexadentate ligands (15 to 17) in which two tridentate ligands are combined with each other at two positions may be synthesized by using corresponding tridentate ligands as starting materials according to the same method.

(Luminescent Device)

Next, the luminescent device containing the complex of the invention will be explained.

The luminescent device of the invention is a device in which at least one organic compound layer containing a luminescent layer between a pair of electrodes, namely, a anode and a cathode and may also be provided with, in addition to the luminescent layer, organic compound layers such as a hole injection layer, a hole transport layer, an electron injection layer and an electron transport layer, a protective layer and the like, wherein each of these layers may have other functions. At least one of the aforementioned organic compound layers contains the aforementioned complex of the invention. Various materials may be used in the formation of each layer.

The complexes of the invention may be used either independently or in combinations of two or more.

The luminescent device of the invention preferably uses the metal complex of the invention as the charge transport material and preferably has a structure in which the metal complex is contained in the hole injection layer and/or the hole transport layer.

When the complex is contained in the hole injection layer and/or the hole transport layer, the effects such as a reduction in drive voltage, an improvement in durability and an improvement in luminous efficiency tend to be produced with ease.

Also, a structure in which the complex is contained in the electron injection layer and/or the electron transport layer is preferred.

When the complex is contained in the electron injection layer and/or the electron transport layer, the effects such as a reduction in drive voltage, an improvement in durability and an improvement in luminous efficiency tend to be produced with ease.

The luminescent device of the invention may use usual luminescent systems, driving methods and utilization forms except that it is a device utilizing the complex of the invention.

A structure in which the complex of the invention is used as the luminescent material, hole injection material or hole transport material, or electron injection material or electron transport material is preferable. When the complex of the invention is used as the luminescent material, no particular limitation is imposed on the emission wavelength and the type of emission may be ultraviolet emission, infrared emission, fluorescence emission or phosphorescence emission.

The luminescent device of the invention can be improved in light-extraction efficiency by various known measures. For example, the shape of the surface of the substrate is processed (for example, a fine grained pattern is formed), the refractive index of the substrate, ITO layer and organic layer is controlled and the film thickness of the substrate, ITO layer and organic layer is controlled to improve the light-extraction efficiency, whereby the external quantum efficiency can be improved.

The external quantum efficiency of the luminescent device of the invention is preferably 5% or more, more preferably 10% or more and still more preferably 13% or more.

As the value of the external quantum efficiency, the maximum value of the external quantum efficiency when the device is driven at 20° C. or the value of the external quantum efficiency at an intensity of about 100 to 300 cd/m² (preferably 200 to 300 cd/m²) may be used when the device is driven at 20° C. may be used.

The value of the external quantum efficiency in the invention is expressed by the maximum value of the external quantum efficiency when the device is driven at 20° C.

In the invention, constant d.c. voltage is applied to the EL device by using a Source Measure Unit 2400 model manufactured by Toyo Technica to emit light and the luminescence of the light is measured using a luminance meter (trade name: BM-8, manufactured by Topcon, whereby the external quantum efficiency at an intensity of 200 cd/m² can be calculated.

Specifically, the external quantum efficiency of the device is calculated from the results obtained by measuring the luminance, emission spectrum and current density and a spectral luminous efficiency curve. Namely, using the current density, the number of electrons to be input can be calculated. Then, the luminance is converted into the number of photons by integral calculation by using the emission spectrum and the spectral luminous efficiency curve (spectrum). From the above results, the external quantum efficiency (%) is given by the equation “(Number of emitted photons/Number of electrons input to the device)×100”.

The emission spectrum may be measured using a Multi-channel Analyzer PMA-11 manufactured by Hamamatsu Photonics K.K.

The internal quantum efficiency of the luminescent device of the invention is preferably 30% or more, more preferably 50% or more and still more preferably 70% or more. The internal quantum efficiency of the device is given by the equation “Internal quantum efficiency=External quantum efficiency/light-extraction efficiency”.

Although the light-extraction efficiency of a usual organic EL device is about 20%, it is possible to raise the light-extraction efficiency to 20% or more, for example, by modifying the shape of the substrate, the shape of the electrode, the film thickness of the organic layer, the film thickness of the inorganic layer, the refractive index of the organic layer and the refractive index of the inorganic layer.

The luminescent device of the invention may be a so-called top-emission system in which emitted light is extracted from the positive electrode side (described in, for example, JP-A Nos. 2003-208109, 2003-248441, 2003-257651 and 2003-282261).

Also, the driving durability of the luminescent device of the invention may be, for example, evaluated in the following manner: d.c. voltage is applied to the organic EL device by using a Source Measure Unit 2400 model manufactured by Toyo Technica to emit light and the luminescence of the light is measured using a luminance meter (trade name: BM-8, manufactured by Topcon to find the time (half-value period of luminance) required for the initial luminance to be decreased by half.

The organic electroluminescent device of the invention may contain a blue fluorescent light emitting compound. Also, a blue fluorescent light emitting device containing the blue fluorescent light emitting material according to the invention and luminescent devices other than the blue light emitting device are used at the same time to manufacture a multicolor luminescent device or full-color luminescent device.

The luminescent device of the invention may use a host material. In this case, the host material is preferably contained in the luminescent layer.

Examples of the host material, adding to the materials of the present invention, include arylamine derivatives (e.g., triphenylamine derivatives and benzidine derivatives), aromatic hydrocarbon compounds (e.g., triphenylbenzene derivatives, triphenylene derivatives, phenanthrene derivatives, naphthalene derivatives and tetraphenylene derivatives), aromatic nitrogen-containing heterocyclic compounds (e.g., pyridine derivatives, pyrazine derivatives, pyrimidine derivatives, triazine derivatives, pyrazole derivatives, imidazole derivatives, oxazole derivatives and pyrrole derivatives) and metal complexes other than the complexes in the present invention (zinc complexes, aluminum complexes and gallium complexes).

The luminescent device of the invention preferably uses a layer containing a compound having an ionization potential of 5.9 eV or more (more preferably 6.0 eV or more) and more preferably uses an electron transport layer having an ionization potential of 5.9 eV or more between a negative electrode and a luminescent layer.

As a method of forming the organic layer of the luminescent element containing the compound of the invention, a method using resistance heating deposition, method using electron beams, sputtering method, molecular lamination method or coating methods (e.g., a spray coating method, dip coating method, impregnation method, roll coating method, gravure coating method, reverse coating method, roll brash method, air knife coating method, curtain coating method, spin coating method, flow coating method, bar coating method, micro-gravure coating method, air doctor coating method, blade coating method, squeeze coating method, transfer roll coating method, kiss coating method, cast coating method, extrusion coating method, wire bar coating method and screen coating method), ink jet method, printing method and transfer method are preferable, though the method used in the invention is not limited to these methods. Among these methods, a method using resistance heating deposition, coating method and transfer method are preferable from characteristic and productional points of view. Any one of the aforementioned formation methods is used to form the organic compound layer containing the complex of the invention on the substrate without any particular limitation on the thickness of the organic compound layer. The thickness of the organic compound layer is preferably 10 nm or more and more preferably 50 nm to 5 μm.

<Base Material>

The base material used in the luminescent device of the invention may be, though not particularly limited to, inorganic materials such as zirconia stabilized yttrium and glass, polyesters such as polyethylene terephthalate, polybutylene terephthalate and polyethylene naphthalate and high-molecular weight materials such as polyethylene, polycarbonate, polyether sulfone, polyarylate, allyldiglycol carbonate, polyimide, polycycloolefin, norbornene resins, poly(chlorotrifluoroethylene), Teflon (trademark) and polytetrafluoroethylene/polyethylene copolymer.

<Anode>

The positive electrode serves to supply holes to, for example, the hole injection layer, the hole transport layer and the luminescent layer. As the material of the anode, a metal, alloy, metal oxide, electroconductive compound or mixture of these materials may be used and a material having a work function of 4 eV or more is preferable.

Specific examples of the anode material include conductive metal oxides such as tin oxide, zinc oxide, indium oxide and indium tin oxide (ITO), metals such as gold, silver, chromium and nickel, mixtures or laminates of these metals and electroconductive metal oxides, inorganic conductive materials such as copper iodide and copper sulfide, organic electroconductive materials such as polyaniline, polythiophene and polypyrrole and laminates of these materials and ITO. Among these materials, electroconductive metal oxides are preferable and, particularly, ITO is preferable from the viewpoint of productivity, high electroconductivity and transparency. The film thickness of the anode is usually in a range from preferably 10 nm to 5 ~In, more preferably 50 nm to 1 μm and still more preferably 100 nm to 500 nm though it may be properly selected according to the material to be used.

As the anode, those manufactured by forming a layer on, for example, soda lime glass, no-alkali glass or transparent resin substrate is usually used. As to the type of material when glass is used, it is preferable to use no-alkali glass to decrease the amount of ions eluted from glass. Also, when soda lime glass is used, it is preferable to use one barrier-coated with silica or the like. The thickness of the substrate is usually 0.2 mm or more and preferably 0.7 mm or more when glass is used though no particular limitation is imposed on it insofar as it is thick enough to keep mechanical strength.

Various methods are used corresponding to the type of material in the production of the anode. In the case of, for example, ITO, an electron beam method, sputtering method, resistance heating deposition method, chemical reaction method (e.g., a sol-gel method) or method in which a dispersion of indium tin oxide is applied is used to form a film.

If the anode is washed or treated using other treatments, the driving voltage of the device can be reduced and luminous efficiency can be improved. In the case of, for example, ITO, UV-ozone treatment, plasma treatment or the like is effective.

<Cathode>

The cathode serves to supply electrons to, for example, the electron injection layer, the electron transport layer and the luminescent layer. The material of the cathode is selected in consideration of adhesion to the electron injection layer, electron transport layer and luminescent layer, which are adjacent thereto, ionization potential and stability. As the material of the cathode, metals, alloys, metal halides, metal oxides, electroconductive compounds or mixtures of these materials may be used. Specific examples of the electrode material include alkali metals (e.g., Li, Na and K) and their fluorides or oxides, alkali earth metals (e.g., Mg and Ca) and their fluorides or oxides, gold, silver, lead, aluminum, sodium/potassium alloys or their mixture metals, lithium/aluminum alloys or their mixture metals, magnesium/silver alloys and their mixture metals and rare earth metals such as indium and ytterbium. The cathode material is preferably materials having a work function of 4 eV or less and more preferably aluminum, lithium/aluminum alloys or their mixture metals, magnesium/silver alloys or their mixture alloys. The cathode may take not only a monolayer structure constituted of the above compound or mixture but also a laminate structure containing the above compound or mixture. For example, a laminate structure of aluminum/lithium fluoride or aluminum/lithium oxide is preferable. The film thickness of the cathode is usually preferably 10 nm to 5 μm, more preferably 50 nm to 1 μm and still more preferably 100 nm to 1 μm though it may be properly selected according to the material to be used.

An electron beam method, sputtering method, resistance heating deposition method, coating method or transfer method is used to manufacture the negative electrode. In the production of the cathode, a single metal may be deposited or two or more components may be deposited simultaneously. Moreover, plural metals may be deposited simultaneously to form an alloy electrode or an alloy prepared in advance may be deposited.

Each sheet resistance of the anode and cathode is preferably lower and is preferably several hundreds Ω/cm² or less.

<Organic Layer>

The organic compound layer of the luminescent device of the invention contains at least the metal complex having a ligand with five or more coordination atoms. In this case, the metal complex may be contained either in one layer or in plural layers.

The content of the metal complex in the organic compound layer is preferably 1 to 100% by weight, more preferably 10 to 70% by weight and particularly preferably 20 to 50% by weight on the total weight of the solid from the viewpoint of dropping driving voltage and improving durability and luminous efficiency, though there is no particular limitation to it.

<Luminescent Layer>

Any material may be used as the material of the luminescent layer insofar as it can form a layer having the function of injecting holes from the anode or the hole injection layer and the hole transport layer and also injecting electrons from the cathode or the electron injection layer and electron transport layer, the function of transporting the injected charges and the function of supplying a field where these holes and electrons are recombined to emit light in the presence of an electric field. Examples of the material of the luminescent layer include, besides the metal complex having a ligand with five or more coordination atoms according to the invention, benzoxazole, benzoimidazole, benzothiazole, styrylbenzene, polyphenyl, diphenylbutadiene, tetraphenylbutadiene, naphthalimide, cumarin, perylene, perinone, oxadiazole, aldazine, pyralizine, cyclopentadiene, bisstyrylanthracene, quinacridone, pyrrolopyridine, thiadiazolopyridine, cyclopentadiene, styrylamine, aromatic dimethylidene or various metal complexes typified by metal complexes and rare earth complexes of 8-quinolinol, polymer compounds such as polythiophene, polyphenylene and polyphenylenevinylene, organic silane, iridium trisphenylpyridine complexes and transition metal complexes typified by platinum polphyrin complexes and derivatives of these compounds.

The luminescent layer preferably contains at least one metal complex having a ligand with five or more coordination atoms and other luminescent compounds from the viewpoint of an improvement in durability and luminous efficiency. The other luminescent compounds may be selected from the aforementioned other compounds and known luminescent compounds according to the need.

Examples of the known luminescent compound are preferably fluorescent light emitting compounds, phosphorescent light emitting compounds and the aforementioned host materials. Among these materials, phosphorescent light emitting compounds are preferable from the viewpoint of luminous efficiency.

The aforementioned phosphorescent light emitting compound is, though not particularly limited to, preferably transition metal complexes, more preferably an iridium complex, platinum complex, rhenium complex, ruthenium complex, palladium complex, rhodium complex and rare earth complexes and still more preferably an iridium complex and platinum complex.

Also, phosphorescent light emitting compounds as described in patent documents such as JP-A Nos. 2002-235076, 2002-170684, 2003-123982 and 2003-133074, U.S. Pat. No. 6,303,238 B1, U.S. Pat. No. 6,097,147, WO 00/57676, WO 00/70655, WO 01/08230, WO 01/39234 A2, WO 01/41512 A1, WO 02/02714 A2, WO 02/15645 A1, WO 02/44189 A1, JP-A No. 2001-247859, Japanese Patent Application No. 2000-33561, JP-A No. 2002-117978, EP1211257, JP-A Nos. 2002-26495, 2002-234894, 2001-247859, 2001-298470, 2002-173674, 2002-203678 and 2002-203679 and Japanese Patent Application No. 2003-157066 may be preferably used.

Examples of the fluorescent light emitting compound include benzoxazole, benzoimidazole, benzothiazole, styrylbenzene, polyphenyl, diphenylbutadiene, tetraphenylbutadiene, naphthalimide, cumarin, pyran, perinone, oxadiazole, aldazine, pyralizine, cyclopentadiene, bisstyrylanthracene, quinacridone, pyrrolopyridine, thiadiazolopyridine, cyclopentadiene, styrylamine, aromatic dimethylidene compounds, condensed polycyclic aromatic compounds (anthracene, phenanthroline, pyrene, perylene, rubrene and pentacene), various metal complexes typified by metal complexes of 8-quinolinol and rare earth complexes, pyromethene complexes, polymer compounds such as polythiophene, polyphenylene and polyphenylenevinylene, organic silane and derivatives of these compounds.

As the above host materials in the luminescent layer, two or more host materials are preferably contained though only one host material may be contained.

The host material is preferably a complex and the complex is, adding to the complexes in the present invention, preferably a metal complex having a ligand with at least one nitrogen atom, oxygen atom or sulfur atom coordinated with the metal. The metal ion in the metal complex is preferably a beryllium ion, magnesium ion, aluminum ion, gallium ion, zinc ion, indium ion or tin ion, more preferably a beryllium ion, aluminum ion, gallium ion or zinc ion and still more preferably an aluminum ion, gallium ion or zinc ion though no particular limitation is imposed on it.

As the ligand contained in the metal complex, there are various known ligands. Examples of the ligands include ligands described in, for example, H. Yersin, “Photochemistry and Photophysics of Coordination Compounds” (Springer-Verlag) (1987) and YAMAMOTO Akio, “Organic Metal Chemistry—Fundamental and Application—”, (Shokabo) (1982).

The above ligand is preferably nitrogen-containing heterocyclic ligands (having preferably 1 to 30 carbon atoms, more preferably 2 to 20 carbon atoms and particularly preferably 3 to 15 carbon atoms, these ligands may be ligands with one coordination atom or ligands with two or more coordination atoms and preferably ligands with two coordination atoms. Examples of the ligand with two coordination atoms include pyridine ligands, bipyridyl ligands, quinolinol ligands, hydroxyphenylazole ligands (hydroxyphenylbenzimidazole ligands, hydroxyphenylbenzoxazole ligands and hydroxyphenylimidazole ligands), alkoxy ligands (having preferably 1 to 30 carbon atoms, more preferably 1 to 20 carbon atoms and particularly preferably 1 to 10 carbon atoms, for example, methoxy, ethoxy, butoxy and 2-ethylhexyloxy), aryloxy ligands (having preferably 6 to 30 carbon atoms, more preferably 6 to 20 carbon atoms and particularly preferably 6 to 12 carbon atoms, for example, phenyloxy, 1-naphthyloxy, 2-naphthyloxy, 2,4,6-trimethylphenyloxy and 4-biphenyloxy), heteroaryloxy ligands (having preferably 1 to 30 carbon atoms, more preferably 1 to 20 carbon atoms and particularly preferably 1 to 12 carbon atoms, for example, pyridyloxy, pyrazyloxy, pyrimidyloxy and quinolyloxy), alkylthio ligands (having preferably 1 to 30 carbon atoms, more preferably 1 to 20 carbon atoms and particularly preferably 1 to 12 carbon atoms, for example, methylthio and ethylthio), arylthio ligands (having preferably 6 to 30 carbon atoms, more preferably 6 to 20 carbon atoms and particularly preferably 6 to 12 carbon atoms, for example, phenylthio), heteroarylthio ligands (having preferably 1 to 30 carbon atoms, more preferably 1 to 20 carbon atoms and particularly preferably 1 to 12 carbon atoms, for example, pyridylthio, 2-benzimizolylthio, 2-benzoxazolylthio and 2-benzthiazolylthio) and siloxy ligands (having preferably 1 to 30 carbon atoms, more preferably 3 to 25 carbon atoms and particularly preferably 6 to 20 carbon atoms, for example, a triphenylsiloxy group, triethoxysiloxy group and triisopropylsiloxy group), more preferably nitrogen-containing heterocyclic ligands, aryloxy ligands, heteroaryloxy groups and siloxy ligands and still more preferably nitrogen-containing heterocyclic ligands, aryloxy ligands and siloxy ligands and still more preferably nitrogen-containing heterocyclic ligands, aryloxy ligands and siloxy ligands.

Specific examples of such a metal ligand may include the following materials.

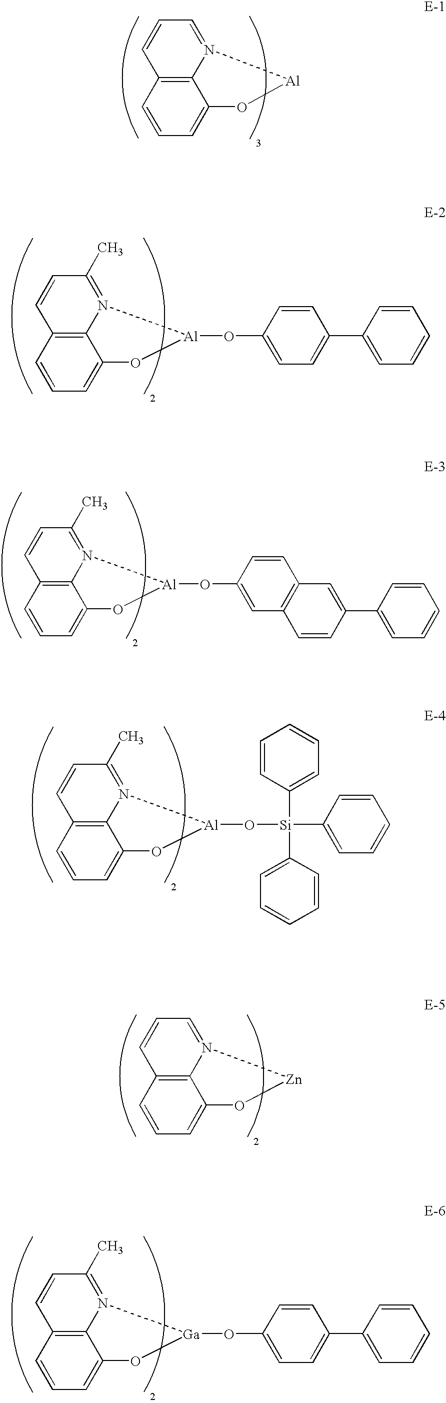

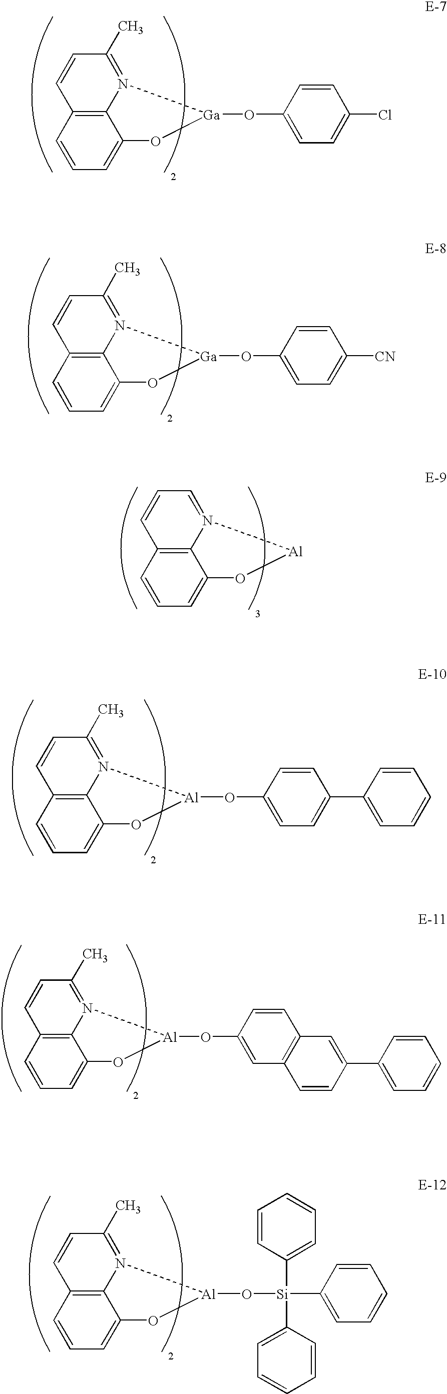

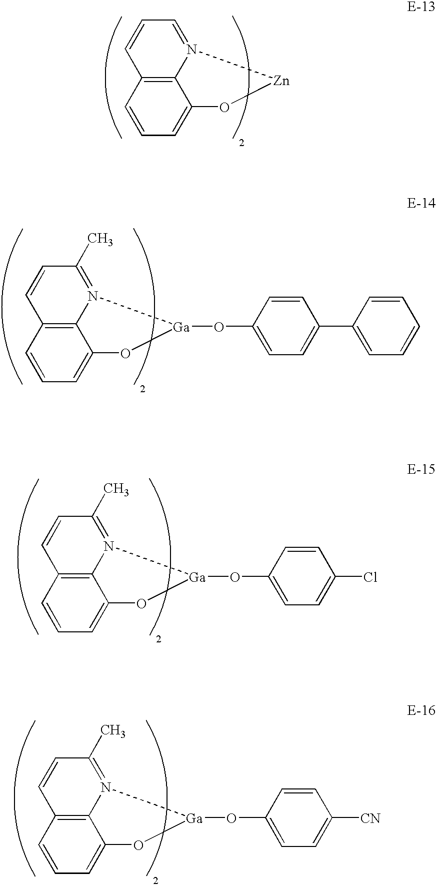

Besides the above compounds, metal complexes given as the exemplified compounds (H2 to H34) described in JP-A No. 2002-305083, exemplified compounds (1-1 to 1-67) described in JP-A No. 2004-221062 and the exemplified compounds (H-1 to H-51) described in JP-A No. 2004-221068 may also be preferably used.

The content of the metal complex having a ligand with five or more coordination atoms in the luminescent layer is preferably 0.01 to 50% by mass, more preferably 0.1 to 20% by mass and particularly preferably 1 to 10% by mass based on the total weight of the solid from the viewpoint of luminous efficiency and durability.

The content of the host material in the luminous layer is preferably 10 to 80% by mass, more preferably 20 to 70% by mass and particularly preferably 30 to 60% by mass based on the total weight of the solid from the viewpoint of driving voltage, luminous efficiency and durability.

The film thickness of the luminescent layer is usually 1 nm to 5 μm, more preferably 5 nm to 1 μm and still more preferably 10 nm to 500 nm although no particular limitation is imposed on it.

As the method of forming the luminescent layer, a method such as a method using resistance heating deposition, method using an electron beam, sputtering method, molecular lamination method, coating method, ink jet method, printing method, LB method or transfer method is used. Among these methods, a method using resistance heating deposition or coating method is preferable.

The luminescent layer may be formed of either a single compound or plural compounds. Also, the luminescent layer may be formed either singly or in plural, wherein these plural layers may emit different color lights from each other to emit, for example, white color light. A single layer may emit white color light. When plural luminescent layers are formed, each layer may be formed of either a single compound or plural compounds.

(Hole Injection Layer and Hole Transport Layer)

Any material may be used for the hole injection layer and the hole transport layer insofar as it has any one of the function of injecting holes from the anode, the function of transporting holes and the function of erecting a barrier against electrons injected from the cathode. Specific examples of these materials include, adding to the complexes in the present invention, carbazole, triazole, oxazole, oxadiazole, imidazole, polyarylalkane, pyrazoline, pyrazolone, phenylenediamine, arylamine, amino substituted calcon, styrylanthracene, fluorenone, hydrazone, stilbene, silazane, aromatic tertiary amine compounds, styrylamine compounds, aromatic dimethylidene-based compounds, polphyrin -based compounds, polysilane-based compounds, poly(N-vinylcarbazole), aniline-based copolymers, thiophene oligomers, conductive high-molecular oligomers such as polythiophene, organic silane, carbon film, metal complexes represented by the formula (1) according to the invention and derivatives of these compounds. The film thickness of the hole injecting layer is preferably in a range from 1 nm to 5 μm, more preferably 1 nm to 100 nm and still more preferably 1 nm to 10 nm though no particular limitation is imposed on it. The film thickness of the hole transport layer is preferably in a range from 1 nm to 5 μm, more preferably 5 nm to 1 μm and still more preferably 10 nm to 500 nm though no particular limitation is imposed on it. The hole injection layer and the hole transport layer may respectively have either a monolayer structure composed of one or two or more of the aforementioned materials or a multilayer structure composed of plural layers having the same or different compositions.

As the method of forming the hole injection layer and the hole transport layer, a vacuum deposition method, LB method, method in which the above hole injection or transport materials are dissolved or dispersed in a solvent to form a coating solution which is then applied, ink jet method, printing method or transfer method is used. In the coating method, the hole injecting or transport materials may be dissolved or dispersed together with a resin component. Examples of the resin component include polyvinyl chloride, polycarbonate, polystyrene, polymethylmethacrylate, polybutylmethacrylate, polyester, polysulfone, polyphenylene oxide, polybutadiene, poly(N-vinylcarbazole), hydrocarbon resins, ketone resins, phenoxy resins, polyamide, ethyl cellulose, vinyl acetate, ABS resins, polyurethane, melamine resins, unsaturated polyester resins, alkyd resins, epoxy resins and silicon resins.

The content of the metal complex having a ligand with five or more coordination atoms in the hole injection layer and/or the hole transport layer is preferably 10 to 80% by mass, more preferably 20 to 60% by mass and particularly preferably 30 to 50% by mass based on the total weight of the solid from the viewpoint of driving voltage, durability and luminous efficiency.

(Electron Injection Layer and Electron Transport Layer)

Any material may be used for the electron injection layer and the electron transport layer insofar as it has any one of the function of injecting electrons from the cathode, the function of transporting electrons and the function of forming a barrier against holes injected from the anode. Specific examples of these materials, adding to the complexes in the present invention, include triazole, oxazole, oxadiazole, imidazole, fluorenone, anthraquinodimethane, anthrone, diphenylquinone, thiopyran dioxide, carbodiimide, fluorenylidenemethane, distyrylpyrazine, aromatic cyclic tetracarboxylic acid anhydride such as naphthalene and perylene, phthalocyanine, metal complexes of 8-quinolinol, metal phthalocyanine, various metal complexes typified by metal complexes having benzoxazole or benzothiazole as a ligand, organic silane, metal complexes represented by the formula (1) according to the invention and derivatives of these compounds. Each film thickness of the electron injecting layer and the electron transport layer is preferably in a range from 1 nm to 5 μm, more preferably 5 nm to 1 μm and still more preferably 10 nm to 500 nm though no particular limitation is imposed on it. The electron injecting layer and the electron transport layer may respectively have either a monolayer structure composed of one or two or more of the aforementioned materials or a multilayer structure composed of plural layers having the same or different compositions.

As the method of forming the electron injection layer and the electron transport layer, a vacuum deposition method, LB method, method in which the above electron injecting or transport materials are dissolved or dispersed in a solvent to form a coating solution which is then applied, ink jet method, printing method or transfer method is used. In the coating method, the hole injecting or transport materials are dissolved or dispersed together with a resin component. As the resin component, those exemplified in the case of the hole injection or transport layer may be applied.

The content of the metal complex having a ligand with five or more coordination atoms in the electron injecting layer and/or the electron transport layer is preferably 10 to 80% by mass, more preferably 20 to 60% by mass and particularly preferably 30 to 50% by mass based on the total weight of the solid from the viewpoint of driving voltage, durability and luminous efficiency.

<Protective Layer>

Any material may be used as the material of the protective layer insofar as it has the function of inhibiting the intrusion of materials, such as moisture and oxygen, which deteriorate the device, into the device. Specific examples of the material of the protective layer include metals such as In, Sn, Pb, Au, Cu, Ag, Al, Ti and Ni, metal oxides such as MgO, SiO, SiO₂, A₂O₃, GeO, NiO, CaO, BaO, Fe₂O₃, Y₂O₃ and TiO₂, metal fluorides such as MgF₂, LiF, AlF₃ and CaF₂, nitrides such as SiNₓ and SiOₓN_{y}, polyethylene, polypropylene, polymethylmethacrylate, polyimide, polyurea, polytetrafluoroethylene, polychlorotrifluoroethylene, polydichlorodifluoroethylene, copolymers of chlorotrifluoroethylene and dichlorodifluoroethylene, copolymers obtained by copolymerizing tetrafluoroethylene with a monomer mixture containing at least one comonomer, fluorine-containing copolymers having a cyclic structure on a copolymer chain, water absorptive materials having an absorption coefficient of 1% or more and moisture-proof materials having an absorption coefficient of 0.1% or less.

No particular limitation is imposed on the method of forming the protective layer and for example, a vacuum deposition method, sputtering method, reactive sputtering method, MBE (molecular beam epitaxy) method, cluster ion beam method, ion plating method, plasma polymerization method (high frequency excited ion plating method), plasma CVD method, laser CVD method, thermal CVD method, gas source CVD method, coating method, printing method and transfer method may be applied.

### EXAMPLES

The invention will be explained by way of examples, which are, however, not intended to limit the scope of the invention.

### Comparative Example 1

As a base material, 0.7-mm-thick glass plate is cut into 2.5 cm by 2.5 cm square and then introduced into a vacuum chamber to form an ITO thin film (thickness: 0.2 μm) as a transparent electrode by a DC magnetron sputter (condition: base material temperature: 100° C. and oxygen pressure: 1×10⁻³ Pa) using an ITO target having a SnO₂ content of 10% by weight, thereby forming an ITO thin film (thickness: 0.2 μm) as a transparent electrode. The surface resistance of the ITO thin film is 10Ω/cm².

Next, the substrate on which the transparent electrode has been formed is placed in a washing container to wash the substrate with IPA and then subjected to UV-ozone treatment for 30 minutes. Then, a poly(ethylenedioxythiphene)•polystyrenesulfonic acid water dispersion (trade name: Baytron P, manufactured by BAYER, solid content: 1.3%) is applied to the surface of the transparent electrode by spin coating and then dried under vacuum at 150° C. for 2 hours to form a hole injecting layer 100 nm in thickness.

Next, polyvinylcarbazole (manufactured by Aldrich Corporation, Mw=63,000) and Ir(ppy)₃ which are materials doubling as a hole transport material and a host material are dissolved in dichloroethane in a weight ratio of 40:1 to prepare a coating solution.

This coating solution is subjected to deoxygenating treatment using a vacuum line. After this deoxygenating treatment, the atmosphere in the vacuum line is fully substituted with nitrogen gas and kept as it is.

The deoxygenated coating solution is applied to the hole injecting layer by a spin coater and dried at room temperature to form a luminescent layer of 50 nm in thickness.

Balq₂ is deposited in a thickness of 10 nm on this luminescent layer at a rate of 0.5 nm/sec and Alq₃ is further deposited thereon in a thickness of 30 nm on the Balq₂ at a rate of 0.5 nm/sec.

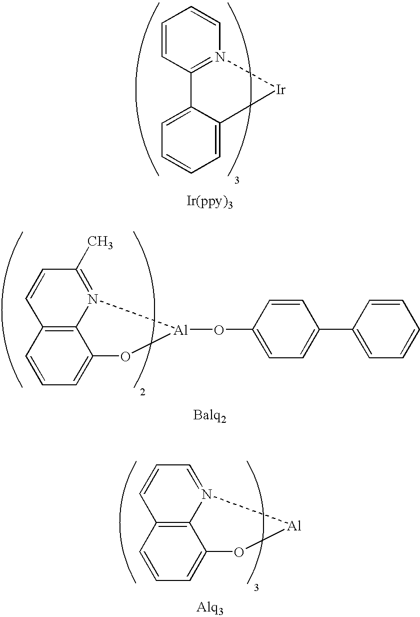

Then, a patterned mask (designed to provide a luminescent area of 2 mm×2 mm) is disposed above the luminescent layer. Lithium fluoride of 1 nm in thickness is deposited at a rate of 0.1 nm/sec and then aluminum of 400 nm in thickness is deposited on the lithium fluoride layer at a rate of 1.2 nm/sec in a depositing apparatus to form a back plate.

An aluminum lead wire is connected to the foregoing transparent electrode (function as a positive electrode) and the foregoing back plate to form a laminate structure.

The laminate structure obtained here is placed in a glove box in which the atmosphere has been substituted with nitrogen gas and sealed in a glass sealing container by using a UV cure adhesive (trade name: XNR 5493, manufactured by Nagase Ciba). Thus, an organic electroluminescent device of Comparative Example 1 is manufactured.

This luminescent device is evaluated using the following method.

d.c. voltage is applied to the organic EL device by using a Source Measure Unit 2400 model manufactured by Toyo Technica to emit light and the luminescence of the light is measured using a luminance meter (trade name: BM-8, manufactured by Topcon. Green light emission (519 nm) is observed and the external quantum efficiency (η₁₀₀₀) at a luminance of 1,000 cd/m² is 6%. The device is allowed to emit light successively at an initial luminance of 1,000 cd/m² to find the time (half-value period of luminance) required for the initial luminance to be decreased to 500 cd/m² and as a result, the time is found to be about 60 hours.

### Comparative Example 2

A luminescent device is manufactured in the same manner as in Comparative Example 1 except that Ir(ppy)3 in the luminescent layer in Comparative Example 1 is altered to the complex R-1 (a ligand with three coordination atoms+a ligand with three coordination atoms) and evaluated in the same method as in Comparative Example 1.

Green light emission is observed and the external quantum efficiency (η₁₀₀₀) at a luminance of 1,000 cd/m² is 6%. The device is allowed to emit light successively at an initial luminance of 1,000 cd/r² to find the time (half-value period of luminance) required for the initial luminance to be decreased to 500 cd/m² and as a result, the time is found to be about 80 hours.

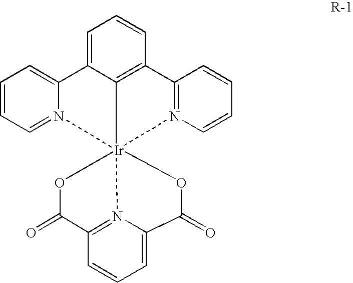

### Example 1

A luminescent device is manufactured in the same manner as in Comparative Example 1 except that Ir(ppy)₃ in the luminescent layer in Comparative Example 1 is altered to the complex K-9 of the invention and evaluated in the same method as in Comparative Example 1.

Green light emission (526 nm) is observed and the external quantum efficiency (η₁₀₀₀) at a luminance of 1,000 cd/m² is 12%. The device is allowed to emit light successively at an initial luminance of 1,000 cd/m² to find the time (half-value period of luminance) required for the initial luminance to be decreased to 500 cd/M² and as a result, the time is found to be about 180 hours.

### Example 2

A luminescent device is manufactured in the same manner as in Comparative Example 1 except that Ir(Ppy)₃ in the luminescent layer in Comparative Example 1 is altered to the complex K-19 of the invention and evaluated in the same method as in Comparative Example 1.

Blue light emission is observed and the external quantum efficiency (η₁₀₀₀) at a luminance of 1,000 cd/m² is 7%. The device is allowed to emit light successively at an initial luminance of 1,000 cd/m² to find the time (half-value period of luminance) required for the initial luminance to be decreased to 500 cd/m² and as a result, the time is found to be about 170 hours.

### Example 3

A luminescent device is manufactured in the same manner as in Comparative Example 1 except that Ir(ppy)₃ in the luminescent layer in Comparative Example 1 is altered to the complex K-43 of the invention and evaluated in the same method as in Comparative Example 1.

Blue light emission is observed and the external quantum efficiency (η₁₀₀₀) at a luminance of 1,000 cd/m² is 5%. The device is allowed to emit light successively at an initial luminance of 1,000 cd/m² to find the time (half-value period of luminance) required for the initial luminance to be decreased to 500 cd/M² and as a result, the time is found to be about 200 hours.

### Example 4

A luminescent device is manufactured in the same manner as in Comparative Example 1 except that Ir(ppy)₃ in the luminescent layer in Comparative Example 1 is altered to the complex K-55 of the invention and evaluated in the same method as in Comparative Example 1.

Blue light emission is observed and the external quantum efficiency (η₁₀₀₀) at a luminance of 1,000 cd/m² is 6%. The device is allowed to emit light successively at an initial luminance of 1,000 cd/m² to find the time (half-value period of luminance) required for the initial luminance to be decreased to 500 cd/m² and as a result, the time is found to be about 210 hours.

### Example 5

A luminescent device is manufactured in the same manner as in Comparative Example 1 except that Ir(ppy)₃ in the luminescent layer in Comparative Example 1 is altered to the complex K-331 of the invention and evaluated in the same method as in Comparative Example 1.

Green light emission is observed and the external quantum efficiency (η₁₀₀₀) at a luminance of 1,000 cd/m² is 10%. The device is allowed to emit light successively at an initial luminance of 1,000 cd/m² to find the time (half-value period of luminance) required for the initial luminance to be decreased to 500 cd/m² and as a result, the time is found to be about 160 hours.

### Example 6

A luminescent device is manufactured in the same manner as in Comparative Example 1 except that Ir(ppy)₃ in the luminescent layer in Comparative Example 1 is altered to the complex K-366 of the invention and evaluated in the same method as in Comparative Example 1.

Blue light emission is observed and the external quantum efficiency (η₁₀₀₀) at a luminance of 1,000 cd/m² is 11%. The device is allowed to emit light successively at an initial luminance of 1,000 cd/m² to find the time (half-value period of luminance) required for the initial luminance to be decreased to 500 cd/m² and as a result, the time is found to be about 180 hours.

The luminescent devices of Example 1 to 6 are found to be superior to those of Comparative Example 1 (a didentate ligand) and Comparative Example 2 (a tridentate ligand+a tridentate ligand) in luminous efficiency and driving durability.

### Comparative Example 3

ITO substrate washed with same method as in Comparative Example 1 is introduced into a vacuum chamber. NPD is deposited in thickness of 50 nm on the ITO substrate, and CBP and Ir(Ppy)₃ with ratio of 10:1 by mass in thickness of 40 nm thereon, and then Balq₂ in thickness of 10 nm thereon, and further Alq₃ in thickness of 30 nm thereon.

Then, a patterned mask (designed to provide a luminescent area of 4 mm×5 mm) is disposed above the organic thin film. Lithium fluoride of 3 nm in thickness is deposited and then aluminum of 60 nm in thickness is deposited on the lithium fluoride layer.

d.c. voltage is applied to the organic EL device. Green light emission (λmax=514 nm) is observed and the external quantum efficiency (η₁₀₀₀) at a luminance of 1,000 cd/m² is 6.4%.

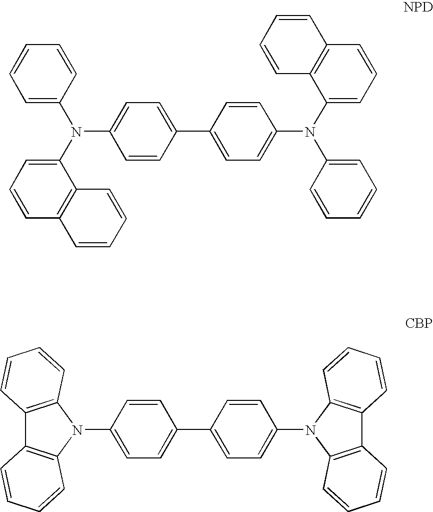

### Example 7

A luminescent device is manufactured in the same manner as in Comparative Example 3 except that NPD in the luminescent layer in Comparative Example 3 is altered to the complex K-31 of the invention and evaluated in the same method as in Comparative Example 3.

Green light emission (λmax=514 nm) is observed and the external quantum efficiency (η₁₀₀₀) at a luminance of 1,000 cd/m² is 8%. The device is allowed to emit light successively at an initial luminance of 1,000 cd/m² to find the time (half-value period of luminance) required for the initial luminance to be decreased to 500 cd/m² and as a result, the time is found to be about three times to that of the device in Comparative Example 3.

The luminescent devices of Example 7, using the complex of the present invention in hole transport layer, is found to be superior to that of Comparative Example 3 in luminous efficiency and driving durability.

### Example 8

A luminescent device is manufactured in the same manner as in Comparative Example 3 except that CBP in the luminescent layer in Comparative Example 3 is altered to the complex K-127 of the invention and evaluated in the same method as in Comparative Example 3.

Green light emission (λmax=511 nm) is observed and the external quantum efficiency (η₁₀₀₀) at a luminance of 1,000 cd/m² is 11%. The device is allowed to emit light successively at an initial luminance of 1,000 cd/m² to find the time (half-value period of luminance) required for the initial luminance to be decreased to 500 cd/m² and as a result, the time is found to be about two times to that of the device in Comparative Example 3.

The luminescent devices of Example 8, using the complex of the present invention as a host material, is found to be superior to that of Comparative Example 3 in luminous efficiency and driving durability.

What is claimed is:

1. An organic electroluminescent device comprising a pair of electrodes and at least one organic layer including a luminescent layer, between the pair of electrodes, wherein at least one metal complex having a ligand with five or more coordination atoms is contained in the organic layer.

2. The organic electroluminescent device of claim 1, wherein said metal complex contains a metal ion selected from the group consisting of a platinum ion, a gold ion, an iridium ion, a rhenium ion, a palladium ion, a rhodium ion, a ruthenium ion, a tungsten ion and a copper ion.

3. The organic electroluminescent device of claim 1, wherein said metal complex contains a metal ion selected from the group consisting of an aluminum ion and a gallium ion.

4. The organic electroluminescent device of claim 1, wherein said metal complex emits phosphorescent light and is contained in the luminescent layer.

5. The organic electroluminescent device of claim 1, wherein said metal complex is a compound represented by the following formula (1): 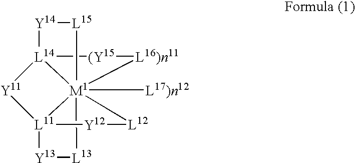
wherein M¹ represents a metal ion; L¹¹, L¹², L¹³, L¹⁴, L¹⁵, L¹⁶ and L¹⁷ each independently represent a coordination group coordinated to M¹; Y¹¹, Y¹², Y¹³, Y¹⁴ and Y¹⁵ each independently represent a single bond or a connecting group; n¹¹ denotes 0 or 1; and n¹² denotes an integer from 0 to 4.

6. The organic electroluminescent device of claim 1, wherein said metal complex is a compound represented by the following formula (3): 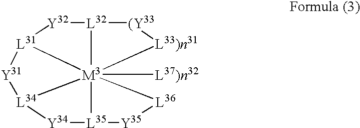
wherein M³ represents a metal ion; L³¹, L³², L³³, L³⁴, L³⁵, L³⁶ and L³⁷ each independently represent a coordination group coordinated to M³; Y³¹, Y³², Y³³, Y³⁴ and Y³⁵ each independently represent a single bond or a connecting group; n³¹ denotes 0 or 1; and n³² denotes an integer from 0 to 4.

7. The organic electroluminescent device of claim 1, wherein said metal complex is a compound represented by the following formula (4): 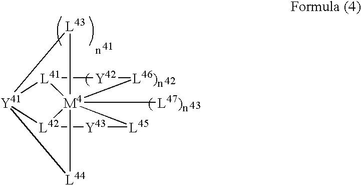
wherein M⁴ represents a metal ion; L⁴¹, L⁴², L⁴³, L⁴⁴, L⁴⁵, L⁴⁶ and L⁴⁷ each independently represent a coordination group coordinated to M⁴; Y⁴¹, Y⁴², Y⁴³ and Y⁴⁴ each independently represent a single bond or a connecting group; n⁴¹ and n⁴² denote 0 or 1, and at least one of n⁴¹ and n⁴² denotes 1; and n⁴³ denotes an integer from 0 to 4.

8. The organic electroluminescent device of claim 1, wherein said metal complex is a compound represented by the following formula (5): 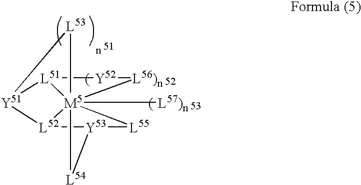
wherein M⁵ represents a metal ion; L⁵¹, L⁵², L⁵³, L⁵⁴, L⁵⁵, L⁵⁶ and L⁵⁷ each independently represent a coordination group coordinated to M⁵; Y⁵¹, Y⁵² and Y⁵³ each independently represent a single bond or a connecting group; n⁵¹ and n⁵² denote 0 or 1, and at least one of n⁵¹ and n⁵² denotes 1; and n⁵³ denotes an integer from 0 to 4.

9. The organic electroluminescent device of claim 1, wherein said metal complex is a compound represented by the following formula (6): 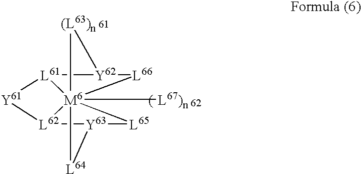
wherein M⁶ represents a metal ion; L⁶¹, L⁶², L⁶³, L⁶⁴, L⁶⁵, L⁶⁶ and L⁶⁷ each independently represent a coordination group coordinated to M⁶; Y⁶¹, Y⁶² and Y⁶³ each independently represent a single bond or a connecting group; n⁶¹ denotes 0 or 1; and n⁶² denotes an integer from 0 to 4.

10. The organic electroluminescent device of claim 1, wherein said metal complex is a compound represented by the following formula (7): 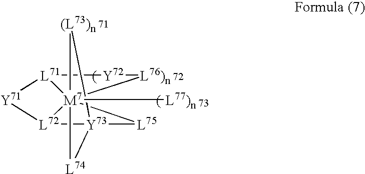
wherein M⁷ represents a metal ion; L⁷¹, L⁷², L⁷³, L⁷⁴, L⁷⁵, L⁷⁶ and L⁷⁷ each independently represent a coordination group coordinated to M⁷; Y⁷¹, Y⁷² and Y⁷³ each independently represent a single bond or a connecting group; n⁷¹ and n⁷² denote 0 or 1, and at least one of n⁷¹ and n⁷² denotes 1; and n⁷³ denotes an integer from 0 to 4.

11. The organic electroluminescent device of claim 1, wherein said metal complex is a compound represented by the following formula (2): 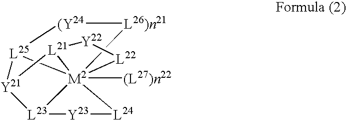
wherein M² represents a metal ion; L²¹, L²², L²³, L²⁴, L²⁵, L²⁶ and L²⁷ each independently represent a coordination group coordinated to M²; Y²¹, Y²², Y²³ and Y²⁴ each independently represent a single bond or a connecting group; n²¹ denotes 0 or 1; and n²² denotes an integer from 0 to 4.

12. The organic electroluminescent device of claim 11, wherein, in formula (2), n²¹ denotes 1, and n²² denotes an integer from 1 to 4.

13. The organic electroluminescent device of claim 11, wherein, in formula (2), at least one of Y²² and Y²³ represent a connecting group other than a single bond.

14. The organic electroluminescent device of claim 11, wherein the compound represented by the formula (2) is selected from the group consisting of the groups represented by the formulae (2-1) to (2-13): 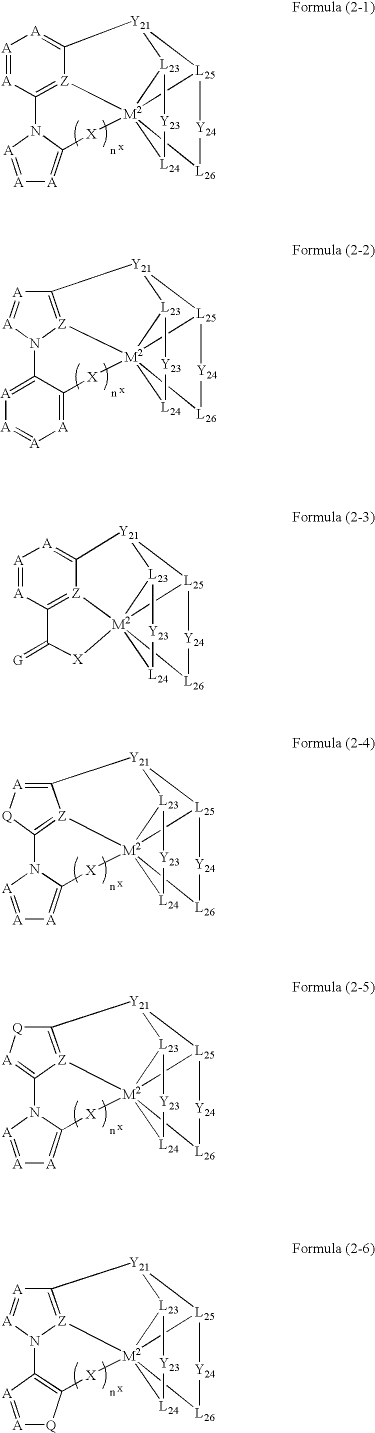 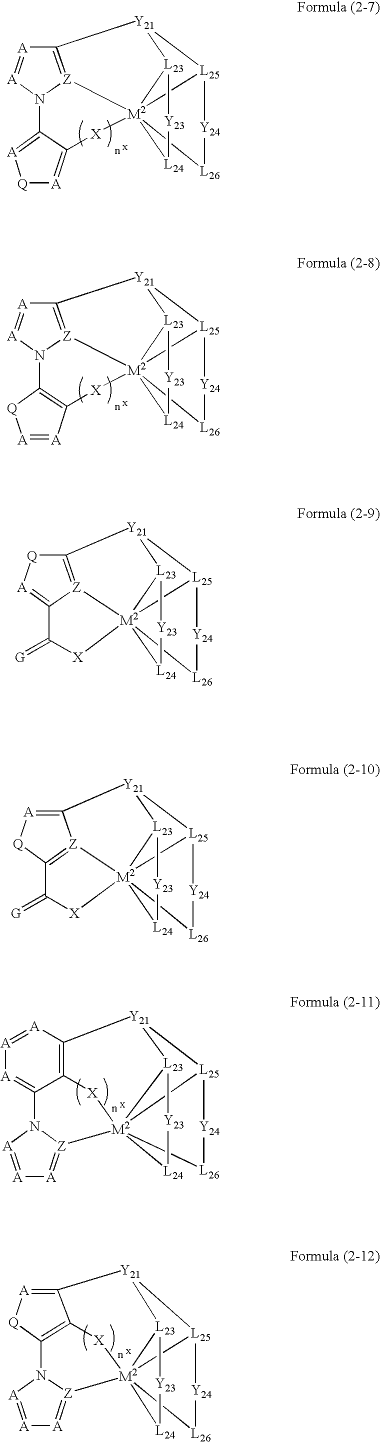 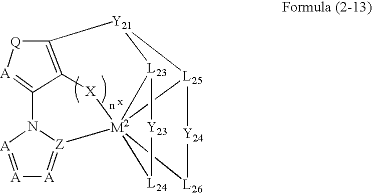
wherein M² represents a metal ion; L₂₃, L₂₄, L₂₅ and L₂₆ each independently represent a coordination group coordinated to M²; Y₂₁, Y₂₃ and Y₂₄ each independently represent a single bond or a connecting group; A represents CR^{A}, N or P; R^{A} represents hydrogen, alkyl group, alkenyl group or alkynyl group; Z represents N or P; X represents O, S or NR^{N1}; R^{N1} represents hydrogen or alkyl group; n^{x} denotes 0 or 1; Q represents O, S, Se, NR^{N2}, CR^{C1} or CR^{C2}; R^{N2} represents hydrogen, alkyl group, aryl group or hetero ring group; and G represents O or S.

15. The organic electroluminescent device of claim 1, wherein said one organic layer has a hole injection layer and/or a hole transport layer, and said metal complex is contained in a hole injection layer and/or a hole transport layer.

16. The organic electroluminescent device of claim 1, wherein said one organic layer has an electron injection layer and/or an electron transport layer, and said metal complex is contained in an electron injection layer and/or an electron transport layer.

17. The organic electroluminescent device of claim 1, wherein the luminescent layer contains a host material and this host material is a complex.

18. The organic electroluminescent device of claim 17, wherein the host material a platinum complex having a ligand with four coordination atoms.

19. The organic electroluminescent device of claim 1, wherein the luminescent layer contains two or more host materials.

20. The organic electroluminescent device of claim 1, wherein the luminescent layer contains at least one metal complex and other luminescent compound.

21. The organic electroluminescent device of claim 1, wherein the luminescent layer contains two or more of the metal complexes.

22. The organic electroluminescent device of claim 1, wherein the metal complex has a lowest excited triplet energy level of 65 to 95 kcal/mol.

23. The organic electroluminescent device of claim 1, wherein the device has a luminescent spectrum with a maximum wavelength of 450 nm or shorter.
